(19) United States
(12) Patent Application Publication
(10) Pub. No.: US 2005/0208439 A1
(43) Pub. Date: Sep. 22, 2005

(54) Photothermographic material and image forming method using same

(75) Inventors: Hajime Nakagawa, Kanagawa (JP); Keiichi Suzuki, Kanagawa (JP); Yoshihisa Tsukada, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/078,524

(22) Filed: Mar. 14, 2005

(30) Foreign Application Priority Data
Mar. 17, 2004 (JP) 2004-076923

(51) Int. Cl. G03C 1/00

(52) U.S. Cl. 430/619

(57) ABSTRACT

A photothermographic material comprising a support, an image-forming layer, a non-photosensitive intermediate layer A, and an outermost layer, wherein the image forming layer, the non-photosensitive intermediate layer A, and the outermost layer are disposed on the support in this order; the image-forming layer comprises a photosensitive silver halide, a non-photosensitive organic silver salt, a reducing agent, a polyhalogen compound, and a binder; the non-photosensitive intermediate layer A comprises a binder in which a hydrophobic polymer constitutes 50% by mass or more of the binder; and the binder in the image-forming layer comprises a copolymer including a monomer represented by formula (M-1) CH₂═CR⁰¹—CR⁰²═CH₂ as a copolymerization component, in formula (M-1), R⁰¹ represents a hydrogen atom, an alkyl group having 1 to 6 carbon atoms, a halogen atom, or a cyano group; and R⁰² represents an alkyl group having 1 to 6 carbon atoms, a halogen atom, or a cyano group.

### CROSS-REFERENCE TO RELATED APPLICATION

This application claims priority under 35 USC 119 from Japanese patent Application No. 2004-76923, the disclosure of which is incorporated by reference herein.

### BACKGROUND OF THE INVENTION

1. Field of the Invention

The present invention relates to a photothermographic material and a method for forming an image on the material.

2. Description of the Related Art

In recent years, reduction in waste liquid has been strongly required in medical fields from the viewpoints of environmental preservation and space saving. Thus, there has been demand for technologies of photothermographic materials for medical diagnosis or photography, which can be efficiently exposed by a laser image setter or a laser imager to form a clear black image with high resolution and sharpness. Such photothermographic materials can provide heat-developing systems to customers, which need no liquid processing chemicals and can form an image easilier with less environmental load.

Though there is similar demand in the fields of common image-forming materials, fine depictions are needed particularly in the fields of medical diagnostic images. The medical diagnostic images are required to have high image quality with excellent sharpness and graininess, and blue-black tone images are preferred from the viewpoint of ease of diagnoses. Various hard copy systems using pigments or dyes, such as ink jet printers and electrophotographies, are distributed as common image-forming systems at present. However, the systems are not satisfactory as output systems for medical images.

Heat image-forming systems using organic silver salts are described in many literatures. Photothermographic materials generally have an image-forming layer, in which a catalytically active amount of a photocatalyst such as a silver halide, a reducing agent, a reducible silver salt such as an organic silver salt, and an optional toning agent for controlling the color tone of silver are dispersed in a binder matrix. When the photothermographic materials are exposed imagewise and then heated to a high temperature (e.g. 80° C. or more), a black-colored image of silver is formed by an oxidation-reduction reaction of the reducing agent with the silver halide or the reducible silver salt, which acts as an oxidizing agent. The oxidation-reduction reaction is accelerated by the catalytic activity of a silver halide latent image generated by the exposure, and thus the black-colored image of silver is formed in the exposed region. Fuji Medical Dry Laser Imager FM-DPL has been marketed as a medical image-forming system using the photothermographic material.

The photothermographic materials include the above components, and the components remain in the materials even after the development. Therefore, the photothermographic materials inherentlly have many problems of storage stability. To solve the problems, change of the image-forming layer composition and addition of a novel compound have been widely studied. Various methods, which include methods of using a silver halide component with a high silver iodide content to improve printout properties (JP-A No. 8-297345, Japanese Patent No. 2785129, etc.), methods of adding a polyhalogen compound to reduce fogging (JP-A No. 2001-312027, etc), and methods of increasing the silver behenate content of the non-photosensitive organic silver salt (JP-A No. 2000-7683, etc.), are studied and achieve certain results.

It is extremely important to examine the components of the image-forming layer to improve the storage stability because the image-forming layer is an essential part for forming an image. The components are mixed in the image-forming layer, whereby the sensitivity tends to be reduced when the storage stability is improved, and the image density tends to be lowered when the fogging is reduced. It is extremely difficult to achieve the incompatible properties, i.e. high storage stability and high sensitivity, or less fogging and high image density.

Thus, the components are balanced and combined in the photothermographic materials such that they can most effectively show their advantages, and it is difficult to improve the storage stability only by changing or adding one component. There have been needs for methods for improving the storage stability without deteriorating the advantages of the components.

Dark heat image storability has recently become a major concern particularly. It has been found that, when a heat-developed image is exposed to relatively high humidity and temperature in the dark, the image density is reduced. The image stability in the unlighted environment is referred to as the dark heat image storability, and this is an important subject in the fields of the heat-developing image-recording materials.

### SUMMARY OF THE INVENTION

Accordingly, an object of the present invention is to provide a photothermographic material with excellent dark heat image storability and a method for forming an image thereon.

The object of the invention has been achieved by the following photothermographic material.

According to a first aspect of the invention, there is provided a photothermographic material comprising a support, an image-forming layer, a non-photosensitive intermediate layer A, and an outermost layer. The image-forming layer, non-photosensitive intermediate layer, A and outermost layer are disposed on at least one surface of the support. The image-forming layer comprises a photosensitive silver halide, a non-photosensitive organic silver salt, a reducing agent, a polyhalogen compound, and a binder. The outermost layer is on the image-forming layer side and is the farthest from the support. The non-photosensitive intermediate layer A is disposed in between the outermost layer and the image-forming layer. The non-photosensitive intermediate layer A includes a binder, and the content of hydrophotic polymers in the total binder in the non-photosensitive intermediate layer A is 50% by mass or higher. The binder in the image-forming layer includes a copolymer including a monomer represented by the following formula (M-1) as a copolymerization component:
CH₂═CR⁰¹—CR⁰²═CH₂ Formula (M-1)
wherein R⁰¹ represents a hydrogen atom, an alkyl group having 1 to 6 carbon atoms, a halogen atom, or a cyano group, and R⁰² represents an alkyl group having 1 to 6 carbon atoms, a halogen atom, or a cyano group.

According to a second aspect of the invention, there is provided a method for forming an image on the photothermographic material comprising exposing the photothermographic material and heat developing the photothermographic material, wherein the photothermographic material is heated for 16 seconds or less in the heat development.

Generally storability of photothermographic materials is improved by changing a component having a direct relation with image formation. For example, the composition or the preparation method of a silver halide component, which acts as a photosensitive site, may be changed. Further, the type of an organic silver salt component, which acts as a silver source, may be changed, or an antifoggant may be added to prevent density increase in an unexposed portion.

However, in the case of changing the type of the silver halide component, also other components such as an organic silver salt, a reducing agent, and an antifoggant have to be changed to ones suitable for the silver halide component, and it is extremely difficult to achieve the best composition.

As a result of research on photothermographic material components other than the silver halide, the organic silver salt, and the reducing agent, the inventors have found that a binder for film formation is largely responsible for the image storability, particularly the dark heat image storability of the photothermographic material. Further, to efficiently shield the image-forming layer from moisture, etc. from outside, thereby preventing the image storability from being adversely affected by environmental changes, it is important that a highly hydrophobic layer be disposed on the side of the image-forming layer which side is opposite to the suport side. Particularly, in view of the dark heat storability, which means the stability of a formed image under high temperature and humidity, it is important that also the binder of the image-forming layer be highly hydrophobic.

As a result of research on the highly hydrophobic binder, the inventors have found that a photothermographic material with remarkably excellent dark heat image storability can be obtained by: using, in the image-forming layer, a copolymer comprising the monomer represented by the formula (M-1) as a copolymerization component and using, in an intermediate layer disposed on the side of the image-forming layer which side is opposite to the support side, a binder having a hydrophobic polymer content of 50% by mass or higher.

The hydrophobic binder is poor in a setting property, and thereby has a disadvantage in the coating properties. The setting property refers to a property that causes a coating liquid to gelate and lose its fluidity at a low temperature. By utilizing the setting property, the fluidity of the coating liquid which was heated and coated on the support can be lost by cooling. Thus, in the case of using the coating liquid having the setting property, the liquid is hardly made uneven by drying air to provide a uniform coating surface. In the invention, to improve the coating surface state and working efficiency, a layer comprising a water-soluble polymer derived from an animal protein (e.g. gelatin) may be disposed on the side of the non-photosensitive intermediate layer A comprising the highly hydrophobic binder which side is opposite to the support side. As a result, the fluidity of the image-forming surface is lost to form a uniform coating surface. In photothermographic materials, swelling by processing liquids does not occur, whereby slight nonuniformity of the coating surface may result in density unevenness and hazes, which are obstacles to the image diagnosis. Thus, the uniformity of the coating surface is one of very important characteristics of the photothermographic materials.

Further, photothermographic materials having a particular composition capable of being rapidly heat-developed are more easily affected by the outside environment. Such a rapid developing composition is characterized by comprising (1) a reducing agent with high activity, (2) a development accelerator, (3) a particular antifoggant, (4) a particular toning agent, etc. The photothermographic material of the invention having the above layer structure can realize excellent image storability even when used as a rapid developing material.

### BRIEF DESCRIPTION OF THE DRAWINGS

FIG. 1 is a schematic structural view showing a heat-developing recording apparatus having a laser recorder.

FIG. 2 is a schematic structural view showing a conveyor device for transporting photothermographic material sheets of the laser recorder and a scan-exposing device of the laser recorder.

### DETAILED DESCRIPTION OF THE INVENTION

The photothermographic material of the present invention comprises a support, an image-forming layer, a non-photosensitive intermediate layer A, and an outermost layer. The image-forming layer, non-photosensitive intermediate layer, A and outermost layer are disposed on at least one surface of the support. The image-forming layer comprises a photosensitive silver halide, a non-photosensitive organic silver salt, a reducing agent, a polyhalogen compound, and a binder. The outermost layer is on the image-forming layer side and is the farthest from the support. The non-photosensitive intermediate layer A is disposed in between the outermost layer and the image-forming layer. The non-photosensitive intermediate layer A includes a binder, and the content of hydrophotic polymers in the total binder in the non-photosensitive intermediate layer A is 50% by mass or higher. The binder in the image-forming layer includes a copolymer including a monomer represented by the following formula (M-1) as a copolymerization component:
CH₂═CR⁰¹—CR⁰²═CH₂ Formula (M-1)
wherein R⁰¹ represents a hydrogen atom, an alkyl group having 1 to 6 carbon atoms, a halogen atom, or a cyano group, and R⁰² represents an alkyl group having 1 to 6 carbon atoms, a halogen atom, or a cyano group.

The layer structure of the photothermographic material of the invention is described first, and components for each layer are described next below.

1. Layer Structure

The photothermographic material of the invention has at least one image-forming layer, and the non-photosensitive intermediate layer A is disposed between the outermost layer and the image-forming layer. The binder included in the non-photosensitive intermediate layer A comprises the hydrophobic polymer in an amount of 50% by mass or more. The binder included in the image-forming layer comprises a polymer prepared by copolymerizing monomers including the monomer represented by the formula (M-1).

Thus, the photothermographic material of the invention has a layer structure comprising essential layers of (1) the image-forming layer, (2) the non-photosensitive intermediate layer A, and (3) the outermost layer, which are disposed in this order from the support. One or more non-photosensitive intermediate layers B may be provided between (2) the non-photosensitive intermediate layer A and (3) the outermost layer. Of couarse, there may be other layers between the above-mentioned layers. In a preferable embodiment, in at least one of the outermost layer and the non-photosensitive intermediate layer B, 50% by mass or more of the binder is a hydrophilic polymer derived from an animal protein. The image-forming layer and the non-photosensitive intermediate layer A may be adjacent to each other.

Generally, the function of the outermost layer is to improve the conveyability and the scratch resistance of the photothermographic material, and to prevent adhesion of the image-forming layer. Thus, the outermost layer often includes an additive such as a matting agent, a slipping agent, and a surfactant in addition to the binder. One surface protective layer or a plurality of surface protective layers may be formed in addition to the outermost layer. Regarding the surface protective layers, JP-A No. 11-65021, Paragraph 0119 to 0120 and JP-A No. 2000-171936 may be referenced, the disclosures of whic are incorporated herein by reference.

The intermediate layers are generally formed as a boundary between the image-forming layer and the outermost layer. Usually, the intermediate layers are mainly composed of the binders, and may include various additives.

Preferred structures (including preferred binders) of the non-photosensitive intermediate layers B and the outermost layer are described below without intention of restricting the scope of the invention.

Hereinafter, the polymer prepared by copolymerizing monomers including the monomer represented by the formula (M) is referred to as “the polymer of the formula (M)”, and the polymer prepared by copolymerizing monomers including the monomer represented by the formula (M-1) is referred to as “the polymer of the formula (M-1)”. Further, a hydrophobic polymer, which is not limited to the polymer of the formula (M), is referred to as “a hydrophobic polymer”, the hydrophilic polymer derived from an animal protein such as gelatin is referred to as “the hydrophilic polymer 1”, and a hydrophilic polymer (such as polyvinyl alcohol (PVA)) which is not derived from animal proteins, is referred to as “a hydrophilic polymer 2”.

TABLE 1

| | Binder | | | | | |
|---|---|---|---|---|---|---|
| | Layer Structure | Layer Structure | Layer Structure | Layer Structure | Layer Structure | Layer Structure |
| | Example 1 | Example 2 | Example 3 | Example 4 | Example 5 | Example 6 |
| Outermost layer | hydrophilic polymer | Hydrophobic | hydrophilic polymer | hydrophilic | Hydrophobic | Hydrophobic |
| | 1 in an amount of | polymer | 1 in an amount of | polymer 1 in an | polymer | polymer/ |
| | 50% by mass or | | 50% by mass or | amount of 50% by | | Hydrophilic |
| | more | | more | mass or more | | polymer 1 |
| Non-photo- | hydrophilic polymer | hydrophilic polymer | hydrophilic polymer | hydrophilic | hydrophilic | hydrophilic |
| sensitive | 2 in an amount of | 2 in an amount of | 2 in an amount of | polymer 1 in an | polymer 1 in an | polymer 1 in an |
| intermediate | 50% by mass or | 50% by mass or | 50% by mass or | amount of 50% by | amount of 50% by | amount of 50% by |
| layer B | more | more | more | mass or more | mass or more | mass or more |
| | | | | hydrophilic | hydrophilic | hydrophilic |
| | | | | polymer 2 in an | polymer 2 in an | polymer 2 in an |
| | | | | amount of 50% by | amount of 50% by | amount of 50% by |
| | | | | mass or more | mass or more | mass or more |
| Non-photo- | hydrophobic | hydrophobic | hydrophobic | hydrophobic | hydrophobic | hydrophobic |
| sensitive | polymer in an | polymer in an | polymer in an | polymer in an | polymer in an | polymer in an |
| intermediate | amount of 50% by | amount of 50% by | amount of 50% by | amount of 50% by | amount of 50% by | amount of 50% by |
| layer A | mass or more | mass or more | mass or more | mass or more | mass or more | mass or more |
| Image-forming | Polymer of formula | Polymer of formula | Polymer of formula | Polymer of | Polymer of | Polymer of |
| layer | (M-1) | (M-1) | (M-1) | formula (M-1) | formula (M-1) | formula (M-1) |

In the invention, a layer including a binder comprising the hydrophilic polymer 1 in an amount of 50% by mass or more is disposed such that the layer is farther from the support than the non-photosensitive intermediate layer A is.

The binder of the outermost layer preferably include the hydrophilic polymer 1 (such as gelatin) in an amount of 50% by mass or more from the viewpoint of the coating property, and preferably include a hydrophobic polymer from the viewpoint of the image storability against tackiness and contamination by fingerprints.

In the outermost layer of Layer Structure Example 3, 4, or 6, the hydrophilic polymer 2 may be used instead of the hydrophilic polymer 1. Particularly, when the non-photosensitive intermediate layer B includes gelatin and the outermost layer includes a hydrophobic polymer, the outermost layer preferably includes the hydrophilic polymer 2 so as to prevent aggregation caused by the contact bewteen the hydrophobic polymer in the outermost layer and the gelatin in the non-photosensitive intermediate layer B.

The binder of the non-photosensitive intermediate layer B preferably includes the hydrophilic polymer 1 in an amount of 50% by mass or more from the viewpoint of the coating property. In order to prevent the aggregation caused by the contact of the gelatin-containing layer with the hydrophobic-polymer-containing layer, the non-photosensitive intermediate layer B is preferably comprised of two layers which are a layer including the hydrophilic polymer 2 such as PVA in an amount of 50% by mass or more and a layer including the hydrophilic polymer 1 in an amount of 50% by mass or more.

(i) When the Content of the Hydrophilic Polymer 1 in the Binder of the Outermost Layer is Lower than 50% by Mass

When the content of the hydrophilic polymer 1 in the binder of the outermost layer is lower than 50% by mass, the effect of the invention is obtained only when the binder in the non-photosensitive intermediate layer B includes the hydrophilic polymer 1 in an amount of 50% by mass or more. In this case, the binder in the outermost layer may be hydrophilic or hydrophobic. When the binder of the outermost layer includes a hydrophilic polymer, the hydrophilic polymer may be the hydrophilic polymer 1 and/or the hydrophilic polymer 2. In view of the setting property, the binder in the outermost layer preferably includes the hydrophilic polymer 1 in an amount of 50% by mass or more or preferably includes includes the hydrophilic polymer 2 mixed with a gelling agent. The outermost layer may include the hydrophobic polymer; the inclusion of the hydrophobic polymer is preferable from the viewpoint of suppression of contamination by fingerprints and tackiness. These hydrophilic polymers and the hydrophobic polymers may be used in combination without particular limitations.

(ii) When the Binder of the Outermost Layer Includes the Hydrophilic Polymer 1 in an Amount of 50% by Mass or More

When the binder of the outermost layer includes the hydrophilic polymer 1 in an amount of 50% by mass or more, the binder in the non-photosensitive intermediate layer B is not particularly restricted, and preferably a binder including the hydrophilic polymer 1 in an amount of 50% by mass or a binder including the hydrophilic polymer 2 in an amount of 50% by mass. The outermost layer usually includes an additive such as a matting agent and a surfactant in view of the conveyability and the scratch resistance, whereby the binder content is restricted. Thus, when the binder of the outermost layer includes the hydrophilic polymer 1 in an amount of 50% by mass or more, the binder of the non-photosensitive intermediate layer B may preferably include the hydrophilic polymer 1 in an amount of 50% by mass or more so as to improve the coating property. In an embodiment, the photothermographic material has at least one layer (which may be a non-photosensitive layer B) which has a proportion of the hydrophilic polymer 1 to the total binder of 50% by mass or higher. In a preferable embodiment, two or more non-photosensitive intermediate layers B are provided between the non-photosensitive intermediate layer A and the outermost layer, and the non-photosensitive intermediate layers B include a first non-photosensitive intermediate layer B whose binder includes the hydrophilic polymer 2 in an amount of 50% by mass or more, and a second intermediate layer B whose binder includes the hydrophilic polymer 1 in an amount of 50% by mass or more, wherein the second intermediate layer B is nearer to the outermost layer than the first intermediate layer B is. The aggregation caused contact of the gelatin-containing layer with the hydrophobic layer can be inhibited by providing the non-photosensitive intermediate layer B whose binder includes the hydrophilic polymer 2 in an amount of 50% by mass or more.

The photothermographic material may comprise other non-photosensitive layers such as: an undercoat layer which may be provided between the image-forming layer and the support; a back layer which may be provided on the side of the support which side is opposite to the image-forming layer side; and a back protective layer which may be provided such that the back protective layer is farther from the support than the back layer is. These layers may each independently have a single- or multi-layered structure.

Further, a layer which functions as an optical filter may be provided to the photothermographic material, generally as the outermost layer or an intermediate layer. An antihalation layer may be provided to the photothermographic material, as the undercoat layer or as the back layer.

The photothermographic material of the invention may be a single-sided material having the image-forming layer on one side of the support, or a double-sided material having the image-forming layers on both sides of the support. In the double-sided material, as long as the layer structure of the invention is formed on one side, the layer structure of the other side is not particularly limited.

When the photothermographic material of the invention is used as a multicolor photothermographic material, the material may comprise an arbitrary combination of two or more layers for each color or may comprise a single layer including all the components as described in U.S. Pat. No. 4,708,928, the disclosure of which is incorporated by reference herein. When a plurality of dyes are used in the multicolor photothermographic material, the respective emulsion layers are separated from each other generally by functional or non-functional barrier layers provided between the respective photosensitive layers as described in U.S. Pat. No. 4,460,681, the disclosure of which is incorporated by reference herein.

2. Components of Each Layer

The non-photosensitive intermediate layer A including the binder including the hydrophobic polymer in an amount of 50% by mass or more is described in detail below. Then, the layer including the hydrophilic polymer 1 in an amount of 50% by mass or more based on the total amount of the binder in the layer (hereinafter referred to as the hydrophilic-polymer-1 containing layer) and the layer including the hydrophilic polymer 2 in an amount of 50% by mass or more based on the total amount of the binder in the layer (hereinafter referred to as the hydrophilic-polymer-2 containing layer), which can be used as the non-photosensitive intermediate layer B or the outermost layer, are described.

(1) Non-Photosensitive Intermediate Layer A

1) Binder

In the invention, the binder in the non-photosensitive intermediate layer A includes the hydrophobic polymer in an amount of 50% by mass or more based on the total amount of the binder in the non-photosensitive intermediate layer A. The proportion of the amount of the hydrophobic polymer to the total amount of the binder is preferably 80 to 100% by mass, more preferably 90 to 100% by mass. When the proportion is lower than 50% by mass, the binder is poor in the property of improving the image storability.

In the invention, the hydrophobic polymer is preferably added to a coating liquid as an aqueous dispersion. The aqueous dispersion may be a dispersion (latex) of fine particles of a water-insoluble hydrophobic polymer in an aqueous solvent, or a dispersion of polymer molecules or polymer micells in an aqueous solvent. The aqueous dispersion is more preferably a latex dispersion. The average particle diameter of the dispersed particles is 1 to 50,000 nm, preferably 5 to 1,000 nm, more preferably 10 to 500 nm, and furthermore preferably 50 to 200 nm. The particle size distribution of the dispersed particles is not particularly limited, and may be a wide distribution or a monodisperse distribution. It is preferable to use two or more kinds of hydrophobic polymer particles each having a monodisperse distribution, so as to control the physical properties of the coating liquid.

The hydrophobic polymer used in the invention is not particularly limited, and preferred examples thereof include acrylic polymers, polyesters, rubbers such as SBR resins, polyurethanes, polyvinyl chlorides, polyvinyl acetates, polyvinylidene chlorides, and polyolefins. The hydrophobic polymer may be a linear, branched or cross-linked polymer, and may be a homopolymer derived form one monomer or a copolymer derived form plural types of monomers. The copolymer may be a random copolymer or a block copolymer. The number-average molecular weight of the hydrophobic polymer is preferably 5,000 to 1,000,000, more preferably 10,000 to 200,000. When the number-average molecular weight is too small, the resultant image-forming layer tends to have insufficient strength. On the other hand, when the number-average molecular weight is too large, the hydrophobic polymer is poor in film-forming properties. Further, cross-linked polymer latexes are particularly preferabe as the hydrophobic polymer.

The glass transition temperature Tg of the hydrophobic polymer is preferably −30 to 70° C., more preferably −10 to 35° C., most preferably 0 to 35° C. When the Tg is lower than −30° C., the hydrophobic polymer is poor in the heat resistance though it is excellent in the film-forming properties. When the Tg is higher than 70° C., the hydrophobic polymer is poor in the film-forming properties though excellent in the heat resistance. Two or more hydrophobic polymers may be used in combination to obtain the preferred Tg. In an embodiment, a plurality of hydrophobic polymers are used which include a hydrophobic polymer having a Tg which is out of the above range, but the weight average Tg of the polymers is within the above range.

The I/O value of the hydrophobic polymer is preferably 0.025 to 0.5, more preferably 0.05 to 0.3. The I/O value is a value obtained by dividing the inorganicity value of a compound by the organicity value of the compound based on the organic conceptual diagram. When the I/O value is lower than 0.025, the hydrophobic polymer is poor in affinity for aqueous solvents, whereby it is difficult to apply the hydrophobic polymer by using an aqueous coating liquid. When the I/O value is higher than 0.5, the resulting film is hydrophilic, and shows poor photographic properties since the photographic properties are affected by the humidity. The I/O value can be obtained by a method described in Yoshio Koda, Yuki Gainen Zu, Kiso to Oyo (Sankyo Shuppan, 1984), the disclosure of which is incorporated by reference herein.

The organic conceptual diagram shows properties of a compound by using a graph having orthogonal coordinates of an organic axis and an inorganic axis. The property of the compound corresponds to a point in the graph. The organicity value of a compound represents the covalent bonding tendency of the compound and the inorganicity value of the compound represents the ionic bonding tendency of the compound, which are to be used for plotting the point for the compound. The inorganicity value is an index of the degree of inorganicity, which is determined based on the influence of a substituent on the boiling point. Using a hydroxyl group as the standard, the inorganicity value of a substituent is determined as follows: since the difference between the boiling point curve of linear alcohol series and the boiling point curve of linear paraffin series is approximately 100° C. around the carbon number of 5, the influence of one hydroxyl group is defined as inorganicity value of 100; and the inorganicity values of other substituents are determined based on the influence of the respective substituents on the boiling point. The inorganicity value of a compound is the sum of the inorganicity value of the substituents on the compound. The organicity value is obtained, using the organicity value of a methylene group as the standard. The organicity value of a compound can be determined based on the number of the carbon atoms of the methylene groups in the molecule. Since the boiling point of a compound on the linear compound series increases by 20° C. on average with addition of one carbon atom within the carbon number range of 5 to 10, the basic value for one carbon atom is defined as 20. The I/O value is calculated using the inorganicity value and the organicity value determined as described above.

The binder of the non-photosensitive intermediate layer A more preferably includes a polymer prepared by copolymerizing monomers including a monomer represented by the following formula (M):
CH₂═CR⁰¹—CR⁰²═CH₂ Formula (M)
wherein R⁰¹ and R⁰² each independently represent a hydrogen atom, an alkyl group having 1 to 6 carbon atoms, a halogen atom, or a cyano group.

The proportion of the polymer prepared by copolymerizing monomers including a monomer represented by the formula (M) to the total amount of the binder in the non-photosensitive intermediate layer A is preferably 80% by mass or higher, more preferably 85 to 100% by mass, further preferably 90 to 100% by mass.

When R⁰¹ or R⁰² represents an alkyl group, the alkyl group preferably has 1 to 4 carbon atoms, more preferably has 1 to 2 carbon atoms. When R⁰¹ or R⁰² represents a halogen atom, the halogen atom is preferably a fluorine atom, a chlorine atom, or a bromine atom, more preferably a chlorine atom.

In a preferable embodiment, R⁰¹ and R⁰² both represent hydrogen atoms. In another preferable embodiment, one of R⁰¹ and R⁰² represents a hydrogen atom and the remainder represents a methyl group or a chlorine atom.

Specific examples of the monomers represented by the formula (M) include 1,3-butadiene, 2-ethyl-1,3butadiene, 2-n-propyl-1,3-butadiene, 2,3-dimethyl-1,3-butadiene, 2-methyl-1,3-butadiene, 2chloro-1,3-butadiene, 1-bromo-1,3-butadiene, 2-fluoro-1,3-butadiene, 2,3-dichloro-1,3-butadiene, and 2-cyano-1,3-butadiene.

The other monomers to be copolymerized with the monomer represented by the formula (M) are not particularly limited, and may be any monomers which can be polymerized by a usual radical or ionic polymerization method.

In an embodiment, the other monomers may be freely selected from the following monomer groups (a) to (j).

Monomer Groups (a) to (j)

(a) Conjugated dienes: 1,3-butadiene, 1,3-pentadiene, 1-phenyl-1,3-butadiene, 1-α-naphthyl-1,3-butadiene, 1-β-naphthyl-1,3-butadiene, 1-bromo-1,3-butadiene, 1-chloro-1,3-butadiene, 1,1,2-trichloro-1,3-butadiene, cyclopentadiene, etc.
(b) Olefins: ethylene, propylene, vinyl chloride, vinylidene chloride, 6-hydroxy-1-hexene, 4-pentenoic acid, methyl 8-nonenate, vinylsulfonic acid, trimethylvinylsilane, trimethoxyvinylsilane, 1,4-divinylcyclohexane, 1,2,5-trivinylcyclohexane, etc.
(c) α,β-Unsaturated carboxylic acids and salts thereof: acrylic acid, methacrylic acid, itaconic acid, maleic acid, sodium acrylate, ammonium methacrylate, potassium itaconate, etc.
(d) α,β-Unsaturated carboxylic acid esters: alkyl acrylates such as methyl acrylate, ethyl acrylate, butyl acrylate, cyclohexyl acrylate, 2-ethylhexyl acrylate, and dodecyl acrylate; substituted alkyl acrylates such as 2-chloroethyl acrylate, benzyl acrylate, and 2-cyanoethyl acrylate; alkyl methacrylates such as methyl methacrylate, butyl methacrylate, 2-ethylhexyl methacrylate, and dodecyl methacrylate; substituted alkyl methacrylates such as 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylates (mole number of added polyoxypropylene=2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, aryl methacrylate, and 2-isocyanatoethyl methacrylate; derivatives of unsaturated dicarboxylic acids such as monobutyl maleate, dimethyl maleate, monomethyl itaconate, and dibutyl itaconate; multifunctional esters such as ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, and 1,2,4-cyclohexane tetramethacrylate; etc.
(e) β-Unsaturated carboxylic amides: acrylamide, methacrylamide, N-methylacrylamide, N,N-dimethylacrylamide, N-methyl-N-hydroxyethylmethacrylamide, N-tert-butylacrylamide, N-tert-octylmethacrylamide, N-cyclohexylacrylamide, N-phenylacrylamide, N-(2-acetoacetoxyethyl)acrylamide, N-acryloylmorpholine, diacetone acrylamide, itaconic diamide, N-methylmaleimide, 2-acrylamide-methylpropane sulfonic acid, methylenebisacrylamide, dimethacryloylpiperazine, etc.
(f) Unsaturated nitriles: acrylonitrile, methacrylonitrile, etc.
(g) Styrene and derivatives thereof: styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene, 1,4-divinylbenzene, etc.
(h) Vinyl ethers: methyl vinyl ether, butyl vinyl ether, methoxyethyl vinyl ether, etc.
(i) Vinyl esters: vinyl acetate, vinyl propionate, vinyl benzoate, vinyl salicylate, vinyl chloroacetate, etc.
(j) Other polymerizable monomers: N-vinylimidazole, 4-vinylpyridine, N-vinylpyrrolidone, 2-vinyloxazoline, 2 isopropenyloxazoline, divinylsulfone, etc.

The monomer represented by the formula (M) is copolymerized preferably with a monomer or monomers selected from styrene, acrylic acid, and an acrylic acid ester. In a preferable embodiment, the monomer represented by the formula (M) is copolymerized with monomers including styrene and acrylic acid, and the obtained hydrophobic copolymer can form a stable aqueous dispersion.

The copolymerization ratio of the monomer represented by the formula (M) to other monomers is not particularly restricted. In the copolymer, the ratio of the amount of the monomer represented by the formula (M) to the total amount of the monomers is preferably 10 to 70% by mass, more preferably 15 to 65% by mass, further preferably 20 to 60% by mass.

Specific examples of the hydrophobic polymer are described below. In the examples, the polymers are represented by the starting monomers, the numerals in parentheses represent the copolymerization ratios (% by mass) of the monomers, and the molecular weights are number-average molecular weights. Since the polymers including multifunctional monomers form cross-linked structures, the concept of molecular weight cannot be applied; such polymers are referred to as “cross-linked polymers” and description of the molecular weight is omitted. Each Tg represents the glass-transition temperature.
LP-1; Latex of -MMA(55)-EA(42)MAA(3)- (Tg 39° C., I/O value 0.636)
LP-2; Latex of -MMA(47)-EA(50)MAA(3)- (Tg 29° C., I/O value 0.636)
LP-3; Latex of -MMA(17)-EA(80)MAA(3)- (Tg −4° C., I/O value 0.636)
LP-4; Latex of -EA(97)MAA(3)- (Tg −20° C., I/O value 0.636)
LP-5; Latex of -EA(97)-AA(3)- (Tg −21° C., I/O value 0.648)
LP-6; Latex of -EA(90)-AA(10)- (Tg −15° C., I/O value 0.761)
LP-7; Latex of -MMA(50)-2EHA(35)-St(10)-AA(5)- (Tg 34° C., I/O value 0.461)
LP-8; Latex of -MMA(30)-2EHA(55)-St(10)-AA(5)- (Tg 3° C., I/O value 0.398)
LP-9; Latex of -MMA(10)-2EHA(75)-St(10)-AA(5)- (Tg −23° C., I/O value 0.339)
LP-10; Latex of -MMA(60)-BA(36)-AA(4)- (Tg 29° C., I/O value 0.581)
LP-11; Latex of -MMA(40)-BA(56)-AA(4)- (Tg −2° C., I/O value 0.545)
LP-12; Latex of -MMA(25)-BA(71)-AA(4)- (Tg −22° C., I/O value 0.519)
LP-13; Latex of -MMA(42)-BA(56)-AA(2)- (Molecular weight 540,000, Tg −4° C., I/O value 0.530)
LP-14; Latex of -St(40)-BA(55)-AA(5)- (Tg −2° C., I/O value 0.319)
LP-15; Latex of -St(25)-BA(70)-AA(5)- (Tg −21° C., I/O value 0.377)
LP-16; Latex of -MMA(58)-St(8)-BA(32)-AA(2)-(Tg 34° C., I/O value 0.515)
LP-17; Latex of -MMA(50)-St(8)-BA(35)-HEMA(5)-AA(2)- (Tg 27° C., I/O value 0.542)
LP-18; Latex of -MMA(42)-St(8)-BA(43)-HEMA(5)-AA(2)- (Tg 14° C., I/O value 0.528)
LP-19; Latex of -MMA(24)-St(8)-BA(61)-HEMA(5)-AA(2)- (Tg −12° C., I/O value 0.498)
LP-20; Latex of -MMA(48)-St(8)-BA(27)-HEMA(15)-AA(2)- (Tg 39° C., I/O value 0.619)
LP-21; Latex of -EA(96)-AA(4)- (Tg −21° C., I/O value 0.664)
LP-22; Latex of -EA(46)MA(50)-AA(4)- (Tg −4° C., I/O value 0.739)
LP-23; Latex of -EA(80)-HEMA(16)-AA(4)- (Tg −9° C., I/O value 0.775)
LP-24; Latex of EA(86)-HEMA(10)-AA(4)- (Tg −13° C., I/O value 0.733)
LP-25; Latex of -St(45)-Bu(52)MAA(3)- (Tg −26° C., I/O value 0.990)
LP-26; Latex of -St(55)-Bu(42)MAA(3)- (Tg −9° C., I/O value 0.105)
LP-27; Latex of -St(60)-Bu(37)MAA(3)- (Tg 1° C., I/O value 0.109)
LP-28; Latex of -St(68)-Bu(29)MAA(3)- (Tg 17° C., I/O value 0.114)
LP-29; Latex of -St(75)-Bu(22)MAA(3)- (Tg 34° C., I/O value 0.119)
LP-30; Latex of -St(40)-BA(58)-AA(2)- (Tg −8.1° C., I/O value 0.293)
LP-31; Latex of -St(40)-BA(58)MAA(2)- (Tg −7.1° C., I/O value 0.287)
LP-32; Latex of -St(57.2)-BA(27.7)MMA(8.7)HMA(4.8)-AA(1.6)- (Tg 37.8° C., I/O value 0.269)
LP-33; Latex of -St(49.6)-BA(40)MMA(4)-HEMA(4.8)-AA(1.6)- (Tg 16.7° C., I/O value 0.289)
LP-34; Latex of -St(80)-2EHA(18)-AA(2)-(Tg 59.7° C., I/O value 0.148)
LP-35; Latex of -St(70)-2EHA(28)-AA(2)- (Tg 40.9° C., I/O value 0.164)
LP-36; Latex of -St(10)-2EHA(38)MMA(50)-AA(2)- (Tg 25.6° C., I/O value 0.427)
LP-37; Latex of -St(10)-2EHA(58)MMA(30)-AA(2)- (Tg −3.9° C., I/O value 0.365)
LP-38; Latex of -St(10)-2EHA(78)MMA(10)-AA(2)- (Tg −28.1° C., I/O value 0.308)
LP-39; Latex of -St(20)-2EHA(68)MMA(10)-AA(2)- (Tg −16.8° C., I/O value 0.285)
LP-40; Latex of -St(30)-2EHA(58)MMA(10)-AA(2)- (Tg −4.4° C., I/O value 0.263)
LP-41; Latex of -MMA(45)-BA(52)₄A(3)- (Tg 4° C., I/O value 0.560)
LP-42; Latex of -St(62)-Bu(35)MAA(3)- (Cross-linked polymer, Tg 5° C.)
LP-43; Latex of -St(68)-Bu(29)-AA(3)- (Cross-linked polymer, Tg 17° C.)
LP-44; Latex of -St(71)-Bu(26)-AA(3)- (Cross-linked polymer, Tg 24° C.)
LP-45; Latex of -St(70)-Bu(27)-IA(3)- (Cross-linked polymer, Tg 23° C.)
LP-46; Latex of -St(75)-Bu(24)-AA(1)- (Cross-linked polymer, Tg 29° C.)
LP-47; Latex of -St(60)-Bu(35)DVB(3)MAA(2)- (Cross-linked polymer, Tg 6° C.)
LP-48; Latex of -St(70)-Bu(25)DVB(2)-AA(3)- (Cross-linked polymer, Tg 26° C.)
LP-49; Latex of -St(70.5)-Bu(26.5)-AA(3)- (Cross-linked polymer, Tg 23° C.)
LP-50; Latex of -St(69.5)-Bu(27.5)-AA(3)- (Cross-linked polymer, Tg 20.5° C.)
LP-51; Latex of -St(61.3)-Isoprene(35.5)-AA(3)- (Cross-linked polymer, Tg 17° C.)
LP-52; Latex of -St(67)-Isoprene(28)-Bu(2)-AA(3)- (Cross-linked polymer, Tg 27° C.)

The abbreviations in the above examples are as follows.
MMA; Methyl methacrylate
EA; Ethyl acrylate
MA; Methyl acrylate
MAA; Methacrylic acid
2EHA; 2-Ethylhexyl acrylate
HEMA; Hydroxyethyl methacrylate
St; Styrene
Bu; Butadiene
AA; Acrylic acid
DVB; Divinylbenzene
IA; Itaconic acid

Commercially-available aqueous dispersions of hydrophobic polymers may be used in the invention, and examples thereof include acrylic polymers such as CEBIAN A-4635, 4718, and 4601 (available from Daicel Chemical Industries, Ltd.) and Nipol LX811, 814, 821, 820, and 857 (available from Nippon Zeon Co., Ltd.); polyesters such as FINETEX ES650, 611, 675, and 850 (available from Dainippon Ink and Chemicals, Inc.) and WD-size and WMS (available from Eastman Chemical Co.); polyurethanes such as HYDRAN AP10, 20, 30, and 40 (available from Dainippon Ink and Chemicals, Inc.); rubbers such as LACSTAR 7310K, 3307B, 4700H, and 7132C (available from Dainippon Ink and Chemicals, Inc.) and Nipol LX416, 410, 438C, and 2507 (available from Nippon Zeon Co., Ltd.); polyvinyl chlorides such as G351 and G576 (available from Nippon Zeon Co., Ltd.); polyvinylidene chlorides such as L502 and L513 (available from Asahi Kasei Kogyo K. K.); and polyolefins such as CHEMIPEARL S120 and SA100 (available from Mitsui Chemicals, Inc.).

Preferable examples of styrene-butadiene copolymer latexes include LP-42 to LP-50 described above, LACSTAR-3307B and 7132C (available from Dainippon Ink and Chemicals, Inc.), and Nipol LX416 (available from Nippon Zeon Co., Ltd.).

Examples of styrene-isoprene copolymer latexes usable in the invention include LP-51 and LP-52 described above.

Only a single kind of an aqueous dispersion of a hydrophobic polymer may be used, or two or more kinds of aqueous dispersions may be used, in accordance with the necessity.

Further, hydrophilic polymers such as gelatin, polyvinyl alcohol, methylcellulose, hydroxypropylcellulose, and carboxymethylcellulose may be added to the non-photosensitive intermediate layer A if necessary.

The mass ratio of the hydrophobic polymer to the entire coating liquid for the non-photosensitive intermediate layer A is preferably 5 to 50% by mass, more preferably 10 to 40% by mass.

The amount of the applied hydrophobic polymer in the non-photosensitive intermediate layer A is preferably 0.1 to 10 g/m², more preferably 0.3 to 7 g/m², most preferably 0.5 to 5 g/m².

2) Film-Forming Aid

A film-forming aid may be added to the aqueous dispersion of the hydrophobic polymer so as to control its minimum film-forming temperature. The film-forming aid is also referred to as a primary plasticizer, and comprises an organic compound (usually an organic solvent) which lowers the minimum film-forming temperature of the polymer latex, and is described, for example, in Soichi Muroi, Gosei Ratekkusu no Kagaku (Kobunshi Kanko Kai, 1970), the disclosure of which is incorporated herein by reference. Preferred film-forming aids are shown below without intention of restricting the scope of the invention.
Z-1: Benzyl alcohol
Z-2: 2,2,4-trimethylpentanediol-1,3-monoisobutyrate
Z-3: 2-Dimethylaminoethanol
Z-4: Diethylene glycol
   3) Thickener

In a preferable embodiment, a thickener is added to the coating liquid for forming the non-photosensitive intermediate layer A. The addition of the thickener enables formation of a hydrophobic layer having a uniform thickness. Examples of the thickener include alkaline metal salts of polyvinyl alcohol, alkaline metal salts of hydroxyethylcellulose, and alkaline metal salts of carboxymethylcellulose. The thickener is preferably thixotropic in view of handling, and thus hydroxyethylcellulose, sodium hydroxymethylcarboxylate, and carboxymethyl-hydroxyethylcellulose are preferable.

The viscosity of the coating liquid including the thickener at 40° C. is preferably 1 to 200 mPa·s, more preferably 10 to 100 mPa·s, furthermore preferably 15 to 60 mPa·s.

4) Other Additives

The non-photosensitive intermediate layer A may further include various additives in addition to the binder. Examples of the additives include surfactants, pH-adjusting agents, antiseptic agents, and antimolds.

5) Position

The position of the non-photosensitive intermediate layer A is not particularly limited as long as the non-photosensitive intermediate layer A is provided such that the image-forming layer is located in between the support and the non-photosensitive intermediate layer A. The non-photosensitive intermediate layer A is preferably adjacent to the image-forming layer.

(2) Hydrophilic-Polymer-1 Containing Layer

1) Binder

In the invention, the hydrophilic-polymer-1 containing layer is the layer including the hydrophilic polymer 1 in an amount of 50% by mass or more based on the total amount of the binder in the layer. The proportion of the hydrophilic polymer 1 to the entire binder in the layer is preferably 50 to 100% by mass, more preferably 60 to 100% by mass, regardless of whether the layer is provided as the outermost layer or as the non-photosensitive intermediate layer B. When the proportion is lower than 50% by mass, the coating liquid is poor in the setting property at the coating and drying, thereby often resulting in uneven coating surface.

In the invention, the hydrophilic polymer 1 (the hydrophilic polymer derived from an animal protein) is a natural or chemically modified, water-soluble polymer such as glue, casein, gelatin, or albumen.

The hydrophilic polymer 1 is preferably a gelatin. Gelatins may be classified to acid-processed gelatins and alkali-processed gelatins such as lime-treated gelatins according to the synthesis methods; gelatins of both classes are usable in the invention. The gelatin used as the hydrophilic polymer 1 preferably has a molecular weight of 10,000 to 1,000,000. The hydrophilic polymer 1 may be a modified gelatin such as a phthalated gelatin, which is prepared by modifying the amino or carboxyl group of a gelatin. Examples of the gelatins include inert gelatins such as Nitta Gelatin 750, and phthalated gelatins such as Nitta Gelatin 801.

An aqueous gelatin solution is converted to a sol when heated to a temperature of 30° C. or higher, and is converted to a gel and loses its fluidity when cooled to a temperature which is lower than 30° C. Since the sol-gel transformation is caused reversibly depending on the temperature, the aqueous gelatin solution of the coating liquid has a setting property, whereby it loses the fluidity when cooled to a temperature which is lower than 30° C.

The hydrophilic polymer 1 may be used in combination with the hydrophilic polymer 2 (which is not derived from an animal protein) and/or the hydrophobic polymer. When the hydrophilic-polymer-1 containing layer is the outermost layer, the binder preferably includes the hydrophobic polymer in addition. In this case, the ratio of the amount of the hydrophilic polymer 1 to the amount of the hydrophobic polymer is preferably in the range of 50/50 to 99/1, more preferably in the range of 50/50 to 80/20.

The content of the hydrophilic polymer 1 in the coating liquid for the hydrophilic-polymer-1 containing layer is 1 to 20% by mass, preferably 2 to 12% by mass, regardless of whether the layer is the outermost layer or the non-photosensitive intermediate layer B.

2) Crosslinking Agent

The hydrophilic-polymer-1 containing layer preferably includes a crosslinking agent. Addition of the crosslinking agent heightens the hydrophobicity and waterproofness of the layer, thereby providing the photothermographic material with excellent properties.

The crosslinking agent is not particularly limited and may have a plurality of groups which can react with an amino group and/or a carboxyl group. Some examples of the crosslinking agents are described in T. H. James, The Theory of the Photographic Process, Fourth Edition, Page 77 to 87 (Macmillan Publishing Co., Inc., 1977), the disclosure of which is incorporated herein by reference. The crosslinking agent is preferably an inorganic crosslinking agent such as chromium alum or an organic crosslinking agent, more preferably an organic crosslinking agent.

A hydrophobic-polymer containing layer such as the non-photosensitive intermediate layer A may include a crosslinking agent. In this case, the crosslinking agent is not particularly limited and may have a plurality of groups capable of reacting with a carboxyl group.

Examples of the organic crosslinking agent include carboxylic acid derivatives, carbamic acid derivatives, sulfonic ester compounds, sulfonyl compounds, epoxy compounds, aziridine compounds, isocyanate compounds, carbodiimide compounds, and oxazoline compounds. More preferred among them are epoxy compounds, isocyanate compounds, carbodiimide compounds, and oxazoline compounds. Only a single crosslinking agent may be used, or two or more crosslinking agents may be used.

Specific examples of the crosslinking agents are described below without intention of restricting the scope of the invention.

(Carbodiimide Compound)

The carbodimide compounds which function as the crosslinking agents are preferably water-soluble or water-dispersible, and specific examples thereof include polycarbodiimides derived from isophorone diisocyanate described in JP-A No. 59-187029 and JP-B No. 5-27450, carbodiimide compounds derived from tetramethylxylylene diisocyanate described in JP-A No. 7-330849, multi-branched carbodiimide compounds described in JP-A No. 10-30024, and carbodiimide compounds derived from dicyclohexylmethane diisocyanate described in JP-A No. 2000-7642. The disclosures of the above patent documents are incorporated by reference herein.

(Oxazoline Compound)

The oxazoline compounds which function as the crosslinking agents are preferably water-soluble or water-dispersible, and specific examples thereof include oxazoline compounds described in JP-A No. 2001-215653, the disclosure of which is incorporated by reference herein.

(Isocyanate Compound)

Isocyanate compounds can react with water. Therefore, the isocyanate compounds which function as the crosslinking agents are preferably water-dispersible, particularly preferably self-emulsifiable, from the viewpoint of pot life. Specific examples thereof include water-dispersible isocyanate compounds described in JP-A Nos. 7-304841, 8-277315, 10-45866, 9-71720, 9-328654, 9-104814, 2000-194045, 2000-194237, and 2003-64149, the disclosures of which are incorporated herein by reference.

(Epoxy Compound)

The epoxy compounds which function as the crosslinking agents are preferably water-soluble or water-dispersible, and specific examples thereof include water-dispersible epoxy compounds described in JP-A Nos. 6-329877 and 7-309954, the disclosures of which are incorporated herein by reference.

More specific examples of the crosslinking agents usable in the invention are described below without intention of restricting the scope of the invention.

(Epoxy Compound)

Trade Name:

DIC FINE EM-60 (Dainippon Ink and Chemicals, Inc.)
   (Isocyanate Compound)
   Trade Names:
DURANATE WB40-100 (Asahi Kasei Corporation)
DURANATE WB40-80D (Asahi Kasei Corporation)
DURANATE WT20-100 (Asahi Kasei Corporation)
DURANATE WT30-100 (Asahi Kasei Corporation)
CR-60N (Dainippon Ink and Chemicals, Inc.)
   (Carbodiimide Compound)
   Trade Names:
CARBODILITE V-02 (Nisshinbo Industries, Inc.)
CARBODILITE V-02-L2 (Nisshinbo Industries, Inc.)
CARBODILITE V-04 (Nisshinbo Industries, Inc.)
CARBODILITE V-06 (Nisshinbo Industries, Inc.)
CARBODILITE E-01 (Nisshinbo Industries, Inc.)
CARBODILITE E-02 (Nisshinbo Industries, Inc.)
   (Oxazoline Compound)
   Trade Names:
EPOCROS K-1010E (Nippon Shokubai Co., Ltd.)
EPOCROS K-1020E (Nippon Shokubai Co., Ltd.)
EPOCROS K-1030E (Nippon Shokubai Co., Ltd.)
EPOCROS K-2010E (Nippon Shokubai Co., Ltd.)
EPOCROS K-2020E (Nippon Shokubai Co., Ltd.)
EPOCROS K-2030E (Nippon Shokubai Co., Ltd.)
EPOCROS WS-500 (Nippon Shokubai Co., Ltd.)
EPOCROS WS-700 (Nippon Shokubai Co., Ltd.)

The crosslinking agent used in the invention may be mixed with the binder solution before added to the coating liquid. As an alternative, the crosslinking agent may be added in the end of the preparation of the coating liquid, or immediately before the coating.

The amount of the crosslinking agent is preferably 0.5 to 200 parts by mass, more preferably 2 to 100 parts by mass, furthermore preferably 3 to 50 parts by mass, per 100 parts by mass of the binder in the layer including the crosslinking agent.

3) Other Additives

The hydrophilic-polymer-1 containing layer may further include a surfactant, a pH-adjusting agent, an antiseptic agent, an antimold, a dye, a pigment, a color tone controlling agent, etc.

4) Position

The hydrophilic-polymer-1 containing layer may be in any position. The hydrophilic-polymer-1 containing layer is preferably provided such that the image-forming layer is located in between the support and the hydrophilic-polymer-1 containing layer. In an embodiment, the hydrophilic-polymer-1 containing layer is preferably provided such that the non-photosensitive intermediate layer A is located in between the support and the hydrophilic-polymer-1 containing layer. In view of the setting property, the hydrophilic-polymer-1 containing layer is preferably provided as the outermost layer. In view of the waterproofness and prevention of contamination by fingerprints, the hydrophilic-polymer-1 containing layer is preferably disposed in between the outermost layer and the non-photosensitive intermediate layer A.

(3) Hydrophilic-Polymer-2 Containing Layer

1) Binder

In the invention, the hydrophilic-polymer-2 containing layer is the layer including the hydrophilic polymer 2 in an amount of 50% by mass or more based on the total amount of the binder in the layer. The proportion of the amount of the hydrophilic polymer 2 to the total amount of the binder in the hydrophilic-polymer-2 containing layer is preferably 50 to 100% by mass, more preferably 60 to 100% by mass, regardless of whether the layer is provided as the outermost layer or as the non-photosensitive intermediate layer B. When the hydrophilic-polymer-2 containing layer is provided between the gelatin-containing layer and the non-photosensitive intermediate layer A and the proportion of the hydrophilic polymer 2, which is not from an animal protein, is lower than 50% by mass, the binder is poor in the property of preventing the aggregation.

The hydrophilic polymer 2, which is not derived from an animal protein, is a natural polymer other than the animal proteins (a polysaccharide, a microbial polymer, an animal polymer, etc.; for example a gelatin), a semisynthetic polymer (a cellulose-based polymer, a starch-based polymer, alginic-acid-based polymer, etc.), or a synthetic polymer (a vinyl-based polymer, etc.). Examples of the hydrophilic polymer 2 include synthetic polymers such as polyvinyl alcohols, and natural or semisynthetic polymers derived from plant cellulose, to be hereinafter described. The hydrophilic polymer 2 is preferably a polyvinyl alcohol or an acrylic acid-vinyl alcohol copolymer.

The hydrophilic polymer 2, which is not derived from an animal protein, does not have a setting property. However, when the hydrophilic polymer 2 is used in combination with a gelling agent, the setting property can be imparted and coatability is improved.

The hydrophilic polymer 2 is preferably a polyvinyl alcohol (PVA). Specific examples of the polyvinyl alcohols include polyvinyl alcohols having various saponification degrees, polymerization degrees, and neutralization degrees, modified polyvinyl alcohols, and copolymers with other monomers, which will be described below.

The specific examples of the polyvinyl alcohols include completely saponified polyvinyl alcohols such as PVA-105 [polyvinyl alcohol (PVA) content 94.0% by mass or higher, saponification degree 98.5±0.5 mol %, sodium acetate content 1.5% by mass or lower, volatile content 5.0% by mass or lower, viscosity (4% by mass, 20° C.) 5.6±0.4 CPS], PVA-110 [PVA content 94.0% by mass, saponification degree 98.5±0.5 mol %, sodium acetate content 1.5% by mass, volatile content 5.0% by mass, viscosity (4% by mass, 20° C.) 11.0±0.8 CPS], PVA-117 [PVA content 94.0% by mass, saponification degree 98.5±0.5 mol %, sodium acetate content 1.0% by mass, volatile content 5.0% by mass, viscosity (4% by mass, 20° C.) 28.0±3.0 CPS], PVA-117H [PVA content 93.5% by mass, saponification degree 99.6±0.3 mol %, sodium acetate content 1.85% by mass, volatile content 5.0% by mass, viscosity (4% by mass, 20° C.) 29.0±3.0 CPS], PVA-120 [PVA content 94.0% by mass, saponification degree 98.5±0.5 mol %, sodium acetate content 1.0% by mass, volatile content 5.0% by mass, viscosity (4% by mass, 20° C.) 39.5±4.5 CPS], PVA-124 [PVA content 94.0% by mass, saponification degree 98.5±0.5 mol %, sodium acetate content 1.0% by mass, volatile content 5.0% by mass, viscosity (4% by mass, 20° C.) 60.0±6.0 CPS], PVA-124H [PVA content 93.5% by mass, saponification degree 99.6±0.3 mol %, sodium acetate content 1.85% by mass, volatile content 5.0% by mass, viscosity (4% by mass, 20° C.) 61.0±6.0 CPS], PVA-CS [PVA content 94.0% by mass, saponification degree 97.5±0.5 mol %, sodium acetate content 1.0% by mass, volatile content 5.0% by mass, viscosity (4% by mass, 20° C.) 27.5±3.0 CPS], PVA-CST [PVA content 94.0% by mass, saponification degree 96.0±0.5 mol %, sodium acetate content 1.0% by mass, volatile content 5.0% by mass, viscosity (4% by mass, 20° C.) 27.0±3.0 CPS], and PVA-HC [PVA content 90.0% by mass, saponification degree 99.85 mol % or more, sodium acetate content 2.5% by mass, volatile content 8.5% by mass, viscosity (4% by mass, 20° C.) 25.0±3.5 CPS] (trade names, available from Kuraray Co., Ltd.).

The specific examples of the polyvinyl alcohols further include partially saponified polyvinyl alcohols such as PVA-203 [PVA content 94.0% by mass, saponification degree 88.0±1.5 mol %, sodium acetate content 1.0% by mass, volatile content 5.0% by mass, viscosity (4% by mass, 20° C.) 3.4±0.2 CPS], PVA-204 [PVA content 94.0% by mass, saponification degree 88.0±1.5 mol %, sodium acetate content 1.0% by mass, volatile content 5.0% by mass, viscosity (4% by mass, 20° C.) 3.9±0.3 CPS], PVA-205 [PVA content 94.0% by mass, saponification degree 88.0±1.5 mol %, sodium acetate content 1.0% by mass, volatile content 5.0% by mass, viscosity (4% by mass, 20° C.) 5.0±0.4 CPS], PVA-210 [PVA content 94.0% by mass, saponification degree 88.0±1.0 mol %, sodium acetate content 1.0% by mass, volatile content 5.0% by mass, viscosity (4% by mass, 20° C.) 9.0±1.0 CPS], PVA-217 [PVA content 94.0% by mass, saponification degree 88.0±1.0 mol %, sodium acetate content 1.0% by mass, volatile content 5.0% by mass, viscosity (4% by mass, 20° C.) 22.5±2.0 CPS], PVA-220 [PVA content 94.0% by mass, saponification degree 88.0±1.0 mol %, sodium acetate content 1.0% by mass, volatile content 5.0% by mass, viscosity (4% by mass, 20° C.) 30.0±3.0 CPS], PVA-224 [PVA content 94.0% by mass, saponification degree 88.0±1.5 mol %, sodium acetate content 1.0% by mass, volatile content 5.0% by mass, viscosity (4% by mass, 20° C.) 44.0±4.0 CPS], PVA-228 [PVA content 94.0% by mass, saponification degree 88.0±1.5 mol %, sodium acetate content 1.0% by mass, volatile content 5.0% by mass, viscosity (4% by mass, 20° C.) 65.0±5.0 CPS], PVA-235 [PVA content 94.0% by mass, saponification degree 88.0±1.5 mol %, sodium acetate content 1.0% by mass, volatile content 5.0% by mass, viscosity (4% by mass, 20° C.) 95.0±15.0 CPS], PVA-217EE [PVA content 94.0% by mass, saponification degree 88.0±1.0 mol %, sodium acetate content 1.0% by mass, volatile content 5.0% by mass, viscosity (4% by mass, 20° C.) 23.0±3.0 CPS], PVA-217E [PVA content 94.0% by mass, saponification degree 88.0±1.0 mol %, sodium acetate content 1.0% by mass, volatile content 5.0% by mass, viscosity (4% by mass, 20° C.) 23.0±3.0 CPS], PVA-220E [PVA content 94.0% by mass, saponification degree 88.0±1.0 mol %, sodium acetate content 1.0% by mass, volatile content 5.0% by mass, viscosity (4% by mass, 20° C.) 31.0±4.0 CPS], PVA-224E [PVA content 94.0% by mass, saponification degree 88.0±1.0 mol %, sodium acetate content 1.0% by mass, volatile content 5.0% by mass, viscosity (4% by mass, 20° C.) 45.0±5.0 CPS], PVA403 [PVA content 94.0% by mass, saponification degree 80.0±1.5 mol %, sodium acetate content 1.0% by mass, volatile content 5.0% by mass, viscosity (4% by mass, 20° C.) 3.1±0.3 CPS], PVA405 [PVA content 94.0% by mass, saponification degree 81.5±1.5 mol %, sodium acetate content 1.0% by mass, volatile content 5.0% by mass, viscosity (4% by mass, 20° C.) 4.8±0.4 CPS], PVA420 [PVA content 94.0% by mass, saponification degree 79.5±1.5 mol %, sodium acetate content 1.0% by mass, volatile content 5.0% by mass], PVA-613 [PVA content 94.0% by mass, saponification degree 93.5±1.0 mol %, sodium acetate content 1.0% by mass, volatile content 5.0% by mass, viscosity (4% by mass, 20° C.) 16.5±2.0 CPS], and L-8 [PVA content 96.0% by mass, saponification degree 71.0±1.5 mol %, sodium acetate content 1.0% by mass (ash content), volatile content 3.0% by mass, viscosity (4% by mass, 20° C.) 5.4±0.4 CPS] (trade names, available from Kuraray Co., Ltd.).

The values in the above specific examples are measured according to JIS K-6726-1977, the disclosure of which is incorporated by reference herein.

The modified polyvinyl alcohol used as the hydrophilic polymer 2 may be a cation-modified, anion-modified, SH-compound-modified, alkylthio-compound-modified, or silanol-modified polyvinyl alcohol. The modified polyvinyl alcohols described in Koichi Nagano, et al., Poval, Kobunshi Kanko Kai may be used in the invention, the disclosures of which is incorporated herein by reference.

Specific examples of the modified polyvinyl alcohols (modified PVAs) include C polymers such as C-118, C-318, C-318-2A, and C-506 (trade names, available from Kuraray Co., Ltd.), HL polymers such as HL-12E and HL-1203 (trade names, available from Kuraray Co., Ltd.), HM polymers such as HM-03 and HM-NO₃ (trade names, available from Kuraray Co., Ltd.), K polymers such as KL-118, KL-318, KL-506, KM-118T, and KM-618 (trade names, available from Kuraray Co., Ltd.), M polymers such as M-115 (trade name, available from Kuraray Co., Ltd.), MP polymers such as MP-102, MP-202, and MP-203 (trade names, available from Kuraray Co., Ltd.), MPK polymers such as MPK-1, MPK-2, MPK-3, MPK4, MPK-5, and MPK-6 (trade names, available from Kuraray Co., Ltd.), R polymers such as R-1130, R-2105, and R-2130 (trade names, available from Kuraray Co., Ltd.), V polymers such as V-2250 (trade name, available from Kuraray Co., Ltd.), etc.

The viscosity of the aqueous solution of the polyvinyl alcohol can be adjusted or stabilized by adding trace of a solvent or inorganic salt, which is described in detail in Koichi Nagano, et al., Poval, Kobunshi Kanko Kai, Page 144 to 154. The disclosure of this literature is incorporated by reference herein in its entirety. As a typical example, it is preferable to add boric acid to the polyvinyl alcohol so as to improve the coating surface state. The mass ratio of the boric acid to the polyvinyl alcohol is preferably 0.01% by mass to 40% by mass.

The crystallinity of the polyvinyl alcohol can be increased by a heat treatment, thereby improving the waterproofness, as described in the above reference Poval. The waterproofness of the polyvinyl alcohol can be improved by being heated at the coating and drying or after the drying, whereby the polyvinyl alcohol is particularly preferred in the invention among water-soluble polymers.

In order to further improve the waterproofness, a waterproofing agent such as those described in the above reference Poval, Page 256 to 261 is preferably added to the polyvinyl alcohol. Examples of the waterproofing agents include aldehydes; methylol compounds such as N-methylol urea and N-methylol melamine; activated vinyl compounds such as divinylsulfone and derivatives thereof; bis(β-hydroxyethylsulfone); epoxy compounds such as epichlorohydrin and derivatives thereof; polyvalent carboxylic acids such as dicarboxylic acids and polycarboxylic acids including polyacrylic acids, methyl vinyl ether-maleic acid copolymers, and isobutylene-maleic anhydride copolymers; diisocyanates; and inorganic crosslinking agents such as compounds of Cu, B, Al, Ti, Zr, Sn, V, Cr, etc.

In the invention, the waterproofing agent is preferably an inorganic crosslinking agent, more preferably boric acid or a derivative thereof, particularly preferably boric acid. Specific examples of the boric acid derivatives are shown below.

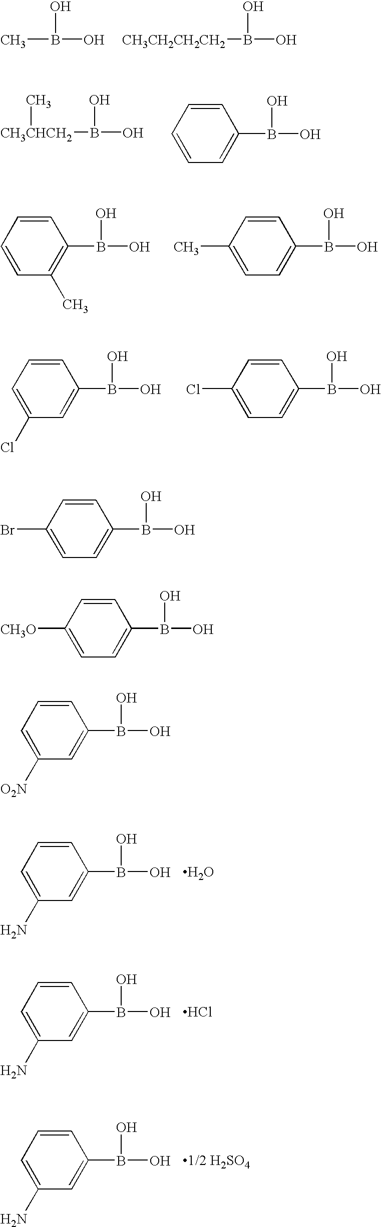

The mass ratio of the waterproofing agent to the polyvinyl alcohol is preferably adjusted within the range of 0.01 to 40% by mass.

Specific examples of the hydrophilic polymer 2 include, in addition to the polyvinyl alcohols, the following polymers: plant polysaccharides such as gum arabics, κ-caffageenans, ι-carrageenans, λ-carrageenans, guar gums (e.g. SUPERCOL manufactured by Squalon), locust bean gums, pectins, tragacanths, corn starches (e.g. PURITY-21 manufactured by National Starch & Chemical Co.), and phosphorylated starches (e.g. NATIONAL 78-1898 manufactured by National Starch & Chemical Co.);
microbial polysaccharides such as xanthan gums (e.g. KELTROL T manufactured by Kelco) and dextrins (e.g. NADEX 360 manufactured by National Starch & Chemical Co.); animal polysaccharides such as sodium chondroitin sulfates (e.g. CROMOIST CS manufactured by Croda);
cellulose-based polymers such as ethylcelluloses (e.g. CELLOFAS WLD manufactured by I.C.I.), carboxymethylcelluloses (e.g. CMC manufactured by Daicel), hydroxyethylcelluloses (e.g. HEC manufactured by Daicel), hydroxypropylcelluloses (e.g. KLUCEL manufactured by Aqualon), methylcelluloses (e.g. VISCONTRAN manufactured by Henkel), nitrocelluloses (e.g. Isopropyl Wet manufactured by Hercules), and cationated celluloses (e.g. CRODACEL QM manufactured by Croda);
alginic acid-based compounds such as sodium alginates (e.g. KELTONE manufactured by Kelco) and propylene glycol alginates; and other polymers such as cationated guar gums (e.g. HI-CARE 1000 manufactured by Alcolac) and sodium hyaluronates (e.g. HYALURE manufactured by Lifecare Biomedial).

The specific examples of the hydrophilic polymer 2 further include agars, furcellerans, guar gums, karaya gums, larch gums, guar seed gums, psyllium seed gums, quince seed gums, tamarind gums, gellan gums, and tara gums. Among them, polymers which are highly water-soluble are preferable. The hydrophilic polymer 2 is preferably such a polymer that the aqueous solution thereof undergoes sol-gel transformation by temperature change between 5 to 95° C. within 24 hours.

Further, the hydrophilic polymer 2 may be a synthetic polymer, and specific examples thereof include acrylic polymers such as sodium polyacrylate, polyacrylic acid copolymers, polyacrylamide, and polyacrylamide copolymers; vinyl polymers such as polyvinylpyrrolidone and polyvinylpyrrolidone copolymers; and other synthetic polymers such as polyethylene glycol, polypropylene glycol, polyvinyl ether, polyethyleneimine, polystyrene sulfonate and copolymers thereof, polyvinyl sulfonate and copolymers thereof, polyacrylic acids and copolymers thereof, maleic acid copolymers, maleic monoester copolymers, and acryloylmethylpropanesulfonic acid polymers and copolymers thereof.

Further, polymers with high water absorbability described in U.S. Pat. No. 4,960,681, JP-A No. 62-245260 (the disclosures of which are incorporated herein by reference), etc. may be used as the hydrophilic polymer 2. Examples of the polymers with high water absorbability include homopolymers of vinyl monomers having a —COOM or —SO₃M group (in which M is a hydrogen or alkaline metal atom) such as sodium methacrylate, ammonium methacrylate, and Sumika Gel L-5H available from Sumitomo Chemical Co., Ltd, and copolymers of such vinyl monomers with other vinyl monomers.

Preferred water-soluble polymer among them is SUMIKA GEL L-5H available from Sumitomo Chemical Co., Ltd.

The amount of the hydrophilic polymer 2 to be applied is preferably 0.1 to 10 g/m², more preferably 0.3 to 3 g/m², per 1 m² of the support.

The content of the hydrophilic polymer 2 in the coating liquid is not particularly limited and is preferably controlled such that a viscosity suitable for simultaneous multilayer coating can be obtained. The content is generally 5 to 20% by mass, more preferably 7 to 15% by mass, still more preferably 8 to 13% by mass.

The hydrophilic polymer 2 may be used in combination with a polymer dispersible in an aqueous solvent.

Preferred examples of the polymers dispersible in an aqueous solvent include synthetic resins, polymers, and copolymers, and other film-forming media, such as cellulose acetates, cellulose acetate butyrates, polymethylmethacrylic acids, polyvinyl chlorides, polymethacrylic acids, styrene-maleic anhydride copolymers, styrene-acrylonitrile copolymers, styrene-butadiene copolymers, polyvinyl acetals (e.g. polyvinyl formals, polyvinyl butyrals, etc.), polyesters, polyurethanes, phenoxy resins, polyvinylidene chlorides, polyepoxides, polycarbonates, polyvinyl acetates, polyolefins, cellulose esters, and polyamides.

The hydrophilic polymer 2 may be used in combination with a latex, and preferred examples thereof include the latexes usable in the non-photosensitive intermediate layer A, latexes of polyacrylates, polyurethanes, polymethacrylates, and copolymers thereof.

Specific examples of the latexes which can be used in combination with the hydrophilic polymer 2 include the following latexes.
LP-1; Latex of -MMA(70)-EA(27)-MAA(3)- (Molecular weight 37,000, Tg 61° C.)
LP-2; Latex of -MMA(70)-2EHA(20)-St(5)-AA(5)- (Molecular weight 40,000, Tg 59° C.)
LP-3; Latex of -VC(50)MMA(20)-EA(20)-AN(5)-AA(5)- (Molecular weight 80,000)
LP-4; Latex of -VDC(85)MMA(5)-EA(5)MAA(5)- (Molecular weight 67,000)
LP-5; Latex of -Et(90)MAA(10)- (Molecular weight 12,000)
LP-6; Latex of MMA(42)-BA(56)-AA(2)- (Molecular weight 540,000, Tg 4° C.)
LP-7; Latex of MMA(63)-EA(35)-AA(2)- (Molecular weight 33,000, Tg 47° C.)
LP-8; Latex of -St(70.5)-Bu(26.5)-AA(3)- (Cross kinked polymer, Tg 23° C.)
LP-9; Latex of -St(69.5)-Bu(27.5)-AA(3)- (Cross-linked polymer, Tg 20.5° C.)
LP-10; Latex of -St(70)-2EHA(27)-AA(3)- (Molecular weight 130,000, Tg 43° C.)

The abbreviations in the above examples are as follows.
MMA; Methyl methacrylate
EA; Ethyl acrylate
MAA; Methacrylic acid
2EHA; 2-Ethylhexyl acrylate
St; Styrene
Bu; Butadiene
AA; Acrylic acid
DVB; Divinylbenzene
VC; Vinyl chloride
AN; Acrylonitrile
VDC; Vinylidene chloride
Et; Ethylene
IA; Itaconic acid

Further, various, commercially available, aqueous resins can be preferably used in the invention as the water-soluble polymer or the polymer latex. The commercially-available, aqueous resins are not particularly limited, and examples thereof include water-dispersible or water-soluble acrylic resins such as ACRYSET (trade name, available from Nippon Shokubai Co., Ltd.) and AROLON (trade name, available from Nippon Shokubai Co., Ltd.); aqueous polyurethanes such as HYDRAN (trade name, available from Dainippon Ink and Chemicals, Inc.), VONDIC (trade name, available from Dainippon Ink and Chemicals, Inc.), POIZE (trade name, available from Kao Corporation), SUPERFLEX (trade name, available from Daichi Kogyo Seiyaku Co., Ltd.), and NEOREZ (trade name, available from Zeneca Limited); aqueous polyesters such as VYLONAL (trade name, available from Toyobo Co., Ltd.) and FINETEX (trade name, available from Dainippon Ink and Chemicals, Inc.); water-dispersible, water-dilutable, or water-soluble alkyd resins such as FORCE (trade name, available from Kansai Paint Co., Ltd.); water-dispersible, water-dilutable, or water-soluble polyolefin resins such as ISOBAM (trade name, available from Kuraray Isoprene Chemical Co. Ltd.), PRIMACOR (trade name, available from The Dow Chemical Company), and HITEC (trade name, available from Toho Chemical Industry Co., Ltd.); water-dispersible epoxy resins such as EPICLON (trade name, available from Dainippon Ink and Chemicals, Inc.); vinyl chloride emulsions; and water-dispersible or water-soluble acrylic resins such as JURYMERs, JUNLONs, RHEOGICs, and ARONVIS (trade names, available from Nihon Junyaku Co., Ltd.).

Specific examples of the commercially-available aqueous resins include water-dispersible or water-soluble acrylic resins such as ACRYSET 19E, ACRYSET 210E, ACRYSET 260E, ACRYSET 288E, and AROLON 453 (Nippon Shokubai Co., Ltd.), CEBIAN A-4635, 4718, and 4601 (Daicel Chemical Industries, Ltd.), and Nipol LX811, 814, 821, 820, and 857 (Nippon Zeon Co., Ltd.); water-dispersible polyurethane resins such as SOFLANATE AE-10 and SOFLANATE AE-40 (Nippon Soflan Kako K.K.), HYDRAN AP-10, 20, 30, and 40, HW-110, HYDRAN HW-131, HYDRAN HW-135, HYDRAN HW-320, ECOS-3000, and VONDIC 2250 and 72070 (Dainippon Ink and Chemicals, Inc.), POIZE 710 and POIZE 720 (available from Kao Corporation), and MELUSI 525, MELUSI 585, MELUSI 414, and MELUSI 455 (Toyo Polymer Co., Ltd.); water-dispersible polyester resins such as VYLONAL MD-1200, VYLONAL MD-1400, and VYLONAL MD-1930 (Toyobo Co., Ltd.), WD-size, WMS, WD3652, and WJL6342 (Eastman Chemical Co.), and FINETEX ES650, 611, 675, and 850 (Dainippon Ink and Chemicals, Inc.); water-soluble, water-dilutable, or water-dispersible polyolefin resins such as ISOBAM-10, ISOBAM-06, and ISOBAM-04 (Kuraray Isoprene Chemical Co. Ltd.), PRIMACOR 5981, PRIMACOR 5983, PRIMACOR 5990, and PRIMACOR 5991 (The Dow Chemical Company), and CHEMIPEARL S120 and SA100 (Mitsui Petrochemical Industries, Ltd.); water-dispersible or water-soluble acrylic resins such as JURYMER AC-103, 10S, AT-510, ET-410, SEK-301, FC-60, SP-50TF, SP002, and AC-70N (Nihon Junyaku Co., Ltd.); water-dispersible gums such as LACSTAR 7310K, 3307B, 4700H, and 7132C (Dainippon Ink and Chemicals, Inc.) and Nipol LX416, 410, 438C, and 2507 (Nippon Zeon Co., Ltd.); water-dispersible polyvinyl chlorides such as G351 and G576 (Nippon Zeon Co., Ltd.); and polyvinylidene chlorides such as L502 and L513 (Asahi Kasei Kogyo K. K.).

2) Coating Liquid

In a preferable embodiment, the hydrophilic-polymer-2 containing layer is gelated by temperature decrease, thereby improving the coatability. Since the fluidity of the applied layer is lost during the gelation, the surface of the image-forming layer is hardly affected by the drying air used in the drying process after the coating, so that the photothermographic material with a uniform coating surface can be obtained. To obtain the coating liquid that can be gelated by temperature decrease, the coating liquid for the hydrophilic-polymer-2 containing layer preferably includes a gelling agent.

It is important that the coating liquid be not in the gel state at the coating. In an embodiment, the coating liquid is fluid at the coating, and gelates to lose its fluidity after the coating but before the drying, thereby improving the handling. At the coating, the viscosity of the coating liquid for the hydrophilic-polymer-2 containing layer is preferably 5 to 200 mPa·s, more preferably 10 to 100 mPa·s.

In the invention, the solvent in the coating liquid is an aqueous solvent. The aqueous solvent is water or a mixed solvent comprised of water and a water-miscible organic solvent in an amount of 70% by mass or less based on the amount of the mixed solvent. Examples of the water-miscible organic solvent include alcohol solvents such as methyl alcohol, ethyl alcohol, and propyl alcohol; cellosolve solvents such as methyl cellosolve, ethyl cellosolve, and butyl cellosolve; ethyl acetate; and dimethylformamide.

It is difficult to measure the viscosity of the gelated liquid after the coating but before the drying. The viscosity is supposedly 200 to 5,000 mPa·s in general, preferably about 500 to 5,000 mPa·s.

The gelling temperature, at which the coating liquid gelates, is not particularly limited. The gelling temperature is preferably around room temperature in view of application working efficiency. When the coating liquid having such a gelling temperature is used, the fluidity of the coating liquid can be easily increased by heating, thus enabling easily coating operation; the fluidity can be easily maintained by maintaining the temperature; and the applied liquid can be easily cooled to lose the fluidity. Specifically, the gelling temperature is preferably 0 to 40° C., more preferably 0 to 35° C.

The temperature of the coating liquid at the coating is not particularly limited as long as it is higher than the gelling temperature. Further, the cooling temperature to which the coated liquid is cooled after the coating but before the drying is not particularly limited as long as it is lower than the gelling temperature. However, when the difference between the temperature of the coating liquid and the cooling temperature is small, the liquid often starts to gelate during the coating, resulting in irregular coating. Though the difference can be widened by increasing the temperature of the coating liquid, the solvent in the coating liquid having an excessively high temperature is often vaporized to change the viscosity. Thus, the difference is preferably 5 to 50° C., more preferably 10 to 40° C.

3) Gelling Agent

The gelling agent used in the invention is such a substance that, when it is added to the aqueous solution of the hydrophilic polymer that is not derived from an animal protein or the aqueous latex solution of the hydrophobic polymer and the solution is cooled, the solution is gelated. The gelling agent may be a substance which cause gelation when used in combination with a gelation accelerator. The fluidity of the solution is remarkably reduced by the gelation.

The gelling agent may be a water-soluble polysaccharide, and specific examples thereof include agars, κ-carrageenans, ι-carrageenans, alginic acid, alginate salts, agaroses, furcellerans, gellan gums, glucono delta lactones, azotobacter vinelandii gums, xanthan gums, pectins, guar gums, locust bean gums, tara gums, cassia gums, glucomannans, tragacanth gums, karaya gums, pullulans, arabic gums, arabinogalactans, dextrans, carboxymethylcellulose sodium salt, methylcelluloses, psyllium seed gums, starches, chitins, chitosans, and curdlans.

The agars, carrageenans, gellan gums, etc. can form the gel when they are heated and melted, and then cooled.

More preferred among these gelling agents are K-carrageenans (e.g., K-9F available from Taito Co., Ltd., K-15, K-21 to 24, and 1-3 available from Nitta Gelatin Inc., etc.), ι-carrageenans, and agars, and particularly preferred are κ-carrageenans.

The mass ratio of the gelling agent to the binder polymer is preferably 0.01 to 10.0% by mass, more preferably 0.02 to 5.0% by mass, further preferably 0.05 to 2.0% by mass.

4) Gelation Accelerator

The gelling agent is preferably used in combination with a gelation accelerator. The gelation accelerator used in the invention is such a substance that the gelation accelerator enhance the gelation when brought into contact with a specific gelling agent. A specific combination of the gelling agent and the gelation accelerator enables the gelation accelerator to perform its function. Examples of the combinations of the gelling agent and the gelation accelerator, usable in the invention, include the following ones:
(1) a combination of a gelation accelerator selected from alkaline metal ions such as a potassium ion and alkaline earth metal ions such as a calcium ion and magnesium ion, and a gelling agent selected from carrageenan, alginate salts, gellan gum, azotobacter vinelandii gum, pectin, carboxymethylcellulose sodium salt, etc.;
(2) a combination of a gelation accelerator selected from boron compounds such as boric acid, and a gelling agent selected from guar gum, locust bean gum, tara gum, cassia gum, etc.;
(3) a combination of a gelation accelerator selected from acids and alkalis, and a gelling agent selected from alginate salts, glucomannan, pectin, chitin, chitosan, curdlan, etc.; and
(4) a combination of a gelling agent and a gelation accelerator selected from water-soluble polysaccharides capable of reacting with the gelling agent to form a gel, such as a combination of xanthan gum as a gelling agent and cassia gum as a gelation accelerator, and a combination of carrageenan as a gelling agent and locust bean gum as a gelation accelerator.

Specific examples of the combinations of the gelling agent and the gelation accelerator include the following combinations:
a) combination of κ-carrageenan and potassium;
b) combination of ι-carrageenan and calcium;
c) combination of low methoxyl pectin and calcium;
d) combination of sodium alginate and calcium;
e) combination of gellan gum and calcium;
f) combination of gellan gum and an acid; and
g) combination of locust bean gum and xanthan gum.

A plurality of the combinations may be used simultaneously.

The gelation accelerator and the gelling agent are preferably added to different layers though they may be added to the same layer. In an embodiment, the gelation accelerator is added to a layer which is not in contact with a layer containing the gelling agent. In this embodiment, a layer free from both of the gelling agent and the gelation accelerator is disposed between the layer containing the gelling agent and the layer containing the gelation accelerator.

The mass ratio of the gelation accelerator to the gelling agent is preferably 0.1 to 200% by mass, more preferably 1.0 to 100% by mass.

5) Other Additives

The hydrophilic-polymer-2 containing layer may include appropriate optional additives. Examples of the additives include surfactants, pH-adjusting agents, antiseptic agents, antimolds, dyes, pigments, and color tone controlling agents.

6) Position

The hydrophilic-polymer-2 containing layer may be provided as the outermost layer or an intermediate layer. In a preferable embodiment, the hydrophilic-polymer-2 containing layer is disposed in between the non-photosensitive intermediate layer A including the hydrophobic polymer and the hydrophilic-polymer-1 containing layer, so as to prevent the aggregation of the polymers.

(4) Outermost Layer

The outermost layer used in the invention may be the hydrophilic-polymer-1 containing layer, the hydrophilic-polymer-2 containing layer, or the hydrophobic-polymer containing layer. The outermost layer is directly affected by outside environment when the photothermographic material is transported, stored, or developed. Thus, the outermost layer preferably includes the additives to be described below. The additives may be added to layers other than the outermost layer such as the surface protective layer (which is not the outermost layer), the intermediate layer, the back layer, and the back protective layer.

1) Matting Agent

In the invention, a matting agent is preferably added to improve the conveyability. The matting agent is described in JP-A No. 11-65021, Paragraph 0126 and 0127, the disclosure of which is incorporated herein by reference. The amount of the matting agent to be applied per 1 m² of the photosensitive material is preferably 1 to 400 mg/m², more preferably 5 to 300 mg/m².

The matting agent may be delomorphous or amorphous, and is preferably delomorphous. The matting agent is preferably in a sphere shape.

The volume-weighted average equivalent sphere diameter of the matting agent provided on the emulsion surface is preferably 0.3 to 10 μm, more preferably 0.5 to 7 μm. The variation coefficient of the particle size distribution of the matting agent is preferably 5 to 80%, more preferably 20 to 80%. The variation coefficient is obtained according to the equation:
variation coefficient=(standard deviation of particle diameter)/(average particle diameter)×100.

Further, two or more types of the matting agents having different average particle sizes may be provided on the emulsion surface. In this case, the difference of the average particle sizes between the smallest matting agent and the largest matting agent is preferably 2 to 8 μm, more preferably 2 to 6 μm.

The volume-weighted average equivalent sphere diameter of the matting agent provided on the back surface is preferably 1 to 15 μm, more preferably 3 to 10 μm. The variation coefficient of the particle size distribution of the matting agent is preferably 3 to 50%, more preferably 5 to 30%. Further, two or more types of the matting agents having different average particle sizes may be provided on the back surface. In this case, the difference of the average particle sizes between the smallest matting agent and the largest matting agent is preferably 2 to 14 μm, more preferably 2 to 9 μm.

The mattness of the emulsion surface is not limited as long as star defects are not caused. The Beck smoothness of the surface is preferably 30 to 2,000 seconds, particularly preferably 40 to 1,500 seconds. The Beck smoothness can be easily obtained by Method for testing smoothness of paper and paperboard by Beck tester according to JIS P8119, or TAPPI standard method T479, the disclosures of which are incorporated by reference herein.

The mattness of the back layer is preferably such that the Beck smoothness is 10 to 1,200 seconds. The Beck smoothness is more preferably 20 to 800 seconds, further preferably 40 to 500 seconds.

In the invention, the matting agent is preferably included in a layer or layers selected from the outermost layer, the surface protective layer, and a layer near the outermost layer.

2) Slipping Agent

A slipping agent such as a liquid paraffin, a long-chain fatty acid, a fatty acid amide, or a fatty acid ester is preferably used to improve the handling in the production and the scratch resistance in the heat development. The slipping agent is particularly preferably a liquid paraffin from which low-boiling-point components have been removed, or a branched fatty acid ester having a molecular weight of 1,000 or larger.

Preferred examples of the slipping agents include compounds described in JP-A No. 11-65021, Paragraph 0117, JP-A Nos. 2000-5137, 2004-219794, 2004-219802, and 2004-334077, the disclosures of which are incorporated herein by reference.

The amount of the slipping agent to be used may be 1 to 200 mg/m², preferably 10 to 150 mg/r², more preferably 20 to 100 mg/m².

The slipping agent may be added to a layer or layers selected from the image-forming layer and the non-photosensitive layer. In a preferable embodiment, the slipping agent is added to the outermost layer so as to improve the conveyability and the scratch resistance.

3) Surfactant

Surfactants described in JP-A No. 11-65021 (the disclosure of which is incorporated herein by reference in its entirety), Paragraph 0132, solvents described in ibid, Paragraph 0133, supports described in ibid, Paragraph 0134, antistatic layers and conductive layers described in ibid, Paragraph 0135, methods for forming color images described in ibid, Paragraph 0136, and slipping agents described in JP-A No. 11-84573 (the disclosure of which is incorporated herein by reference in its entirety), Paragraph 0061 to 0064 and JP-A No. 2001-83679 (the disclosure of which is incorporated herein by reference in its entirety) Paragraph 0049 to 0062, can be used in the invention.

In the invention, it is preferable to use a fluorochemical surfactants. Specific examples of the fluorochemical surfactants include compounds described in JP-A Nos. 10-197985, 2000-19680, and 2000-214554, the disclosures of which are incorporated herein by reference. Further, fluorine-containing polymer surfactants described in JP-A No. 9-281636 (the disclosure of which is incorporated herein by reference) are also preferable in the invention. In an embodiment, the fluorochemical surfactants described in JP-A Nos. 2002-82411, 2003-057780, and 2003-149766 (the disclosures of which are incorporated herein by reference) are used in the photothermographic material of the invention. The fluorochemical surfactants described in JP-A Nos. 2003-057780 and 2003-149766 are particularly preferred from the viewpoints of the electrification control, the stability of the coating surface, and the slipping properties in the case of using an aqueous coating liquid. The fluorochemical surfactants described in JP-A No. 2003-149766 are most preferred because they are high in the electrification control ability and are effective even when used in a small amount.

In the invention, the fluorochemical surfactant may be used in the emulsion surface and/or the back surface, and is preferably used in both the emulsion surface and/or the back surface. It is particularly preferable to use a combination of the fluorochemical surfactant and the above-described conductive layer including a metal oxide. In this case, sufficient performance can be achieved even if the fluorochemical surfactant in the electrically conductive layer side is reduced or removed.

The amount of the fluorochemical surfactant used in each of the emulsion surface and the back surface is preferably 0.1 to 100 mg/m², more preferably 0.3 to 30 mg/m², further preferably 1 to 10 mg/m². In particular, the fluorochemical surfactants described in JP-A No. 2003-149766 can exhibit excellent effects, whereby the amount thereof is preferably 0.01 to 10 mg/m², more preferably 0.1 to 5 mg/m².

(5) Image-Forming Layer

(Binder)

1) Polymer Prepared by Copolymerization of Monomers Including a Monomer Represented by Formula (M-1)

The binder of the image-forming layer comprises a polymer prepared by copolymerizing monomers including a monomer represented by the following formula (M-1):
CH₂═CR⁰¹-—CR⁰²═CH₂ Formula (M-1)
wherein R⁰¹ represents a hydrogen atom, an alkyl group having 1 to 6 carbon atoms, a halogen atom, or a cyano group; and R⁰² represents an alkyl group having 1 to 6 carbon atoms, a halogen atom, or a cyano group.

When R⁰¹ or R⁰² represents an alkyl group, the alkyl group preferably has 1 to 4 carbon atoms, and more preferably has 1 to 2 carbon atoms. When R⁰¹ or R⁰² represents a halogen atom, the halogen atom is preferably a fluorine atom, a chlorine atom, or a bromine atom, more preferably a chlorine atom.

In an embodiment, one of R⁰¹ and R⁰² is a hydrogen atom and the other is a methyl group or a chlorine atom.

The proportion of the copolymer including the monomer represented by the formula (M-1) as a copolymerization component to the binder of the image-forming layer is preferably 50% by mass or higher, more preferably 70 to 100% by mass, further preferably 90 to 100% by mass. When the proportion is lower than 50% by mass, the image storability is not significantly improved.

Specific examples of the monomer represented by the formula (M-1) include 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, 2-cyano-1,3-butadiene, and 1,3-butadiene.

The monomers to be copolymerized with the monomer represented by the formula (M-1) may be selected from the monomers described above as monomers usable in the non-photosensitive intermediate layer A.

Preferred examples of the copolymers including the monomer represented by the formula (M-1) as a copolymerization component include: a copolymer of styrene and the monomer represented by the formula (M-1), which may be a random copolymer or a block copolymer; a copolymer of styrene, butadiene, and the monomer represented by the formula (M-1), which may be a random copolymer, a butadiene-isoprene-styrene block copolymer, or a styrene-butadiene-isoprene-styrene block copolymer; a copolymer of ethylene, propylene, and the monomer represented by the formula (M-1); a copolymer of acrylonitrile and the monomer represented by the formula (M-1); a copolymer of isobutylene and the monomer represented by the formula (M-1); a copolymer of an acrylic ester and the monomer represented by the formula (M-1), in which the acrylic ester may be ethyl acrylate, butyl acrylate, etc.; and a copolymer of an acrylic ester, an acrylonitrile, and the monomer represented by the formula (M-1), in which the acrylic ester may be ethyl acrylate, butyl acrylate, etc. Among them, a copolymer of styrene and the monomer represented by the formula (M-1) is the most preferable.

The copolymerization ratio between the monomer represented by the formula (M-1) and the other monomers is not particularly restricted. The proportion of the mass of the monomer represented by the formula (M-1) to the mass of the copolymer is preferably 10 to 70% by mass, more preferably 15 to 65% by mass, further preferably 20 to 60% by mass.

The temperature Tg of the copolymer including the monomer represented by the formula (M-1) as a copolymerization component is preferably −30 to 70° C., more preferably −10 to 35° C., most preferably 0 to 35° C. When the Tg is lower than −30° C., the polymer is poor in the heat resistance though it is excellent in the film-forming properties. When the Tg is higher than 70° C., the polymer is poor in the film-forming properties though excellent in the heat resistance. Two or more polymers may be used in combination so as to obtain the preferred Tg. In an embodiment, polymers including a polymer having a Tg which is out of the above range are used in combination, and the combination has a Tg within the above range.

In the invention, Tg of a copolymer is calculated using the following equation:
1/Tg=Σ(Xi/Tgi).

Assuming the copolymer is comprised of n monomers which are designated by “monomer i” (i=1 to n). Xi is the weight fraction of the monomer i (ΣXi =1), and Tgi is the glass-transition temperature (absolute temperature) of the homopolymer of the monomer i. Σ(Xi/Tgi) is the sum of Xi/Tgi for i=1 to n. In the invention, the glass-transition temperature Tgi of the homopolymer of each monomer is a value described in J. Brandrup and E. H. Immergut, Polymer Handbook, 3rd Edition (Wiley-Interscience, 1989), the disclosure of which is incorporated by reference herein.

The I/O value of the copolymer including the monomer represented by the formula (M-1) as a copolymerization component is preferably 0.025 to 0.3, more preferably 0.05 to 0.15. The I/O value is a value obtained by dividing the inorganicity value by the organicity value based on the organic conceptual diagram. When the I/O value is lower than 0.025, the polymer is poor in affinity for aqueous solvents, whereby it is difficult to apply the polymer by using an aqueous coating liquid. When the I/O value is higher than 0.3, the resulting film is hydrophilic and shows poor photographic properties under a humid condition. The I/O value can be obtained by a method described in Yoshio Koda, Yuki Gainen Zu, Kiso to Oyo (Sankyo Shuppan, 1984), the disclosure of which is incorporated herein by reference.

The organic conceptual diagram shows properties of a compound by using a graph having orthogonal coordinates of an organic axis and an inorganic axis. The property of the compound corresponds to a point in the graph. The organicity value of a compound represents the covalent bonding tendency of the compound and the inorganicity value of the compound represents the ionic bonding tendency of the compound, which are to be used for plotting the point for the compound. The inorganicity value is an index of the degree of inorganicity, which is determined based on the influence of a substituent on the boiling point. Using a hydroxyl group as the standard, the inorganicity value of a substituent is determined as follows: since the difference between the boiling point curve of linear alcohol series and the boiling point curve of linear paraffin series is approximately 100° C. around the carbon number of 5, the influence of one hydroxyl group is defined as inorganicity value of 100; and the inorganicity values of other substituents are determined based on the influence of the respective substituents on the boiling point. The inorganicity value of a compound is the sum of the inorganicity value of the substituents on the compound. The organicity value is obtained, using the organicity value of a methylene group as the standard. The organicity value of a compound can be determined based on the number of the carbon atoms of the methylene groups in the molecule. Since the boiling point of a compound on the linear compound series increases by 20° C. on average with addition of one carbon atom within the carbon number range of 5 to 10, the basic value for one carbon atom is defined as 20. The I/O value is calculated using the inorganicity value and the organicity value determined as described above.

In a preferable embodiment, the copolymer including the monomer represented by the formula (M-1) as a copolymerization component is contained in the coating liquid as an aqueous dispersion. The aqueous dispersion may be a latex in which fine particles of a water-insoluble hydrophobic polymer are dispersed in an aqueous solvent, or a dispersion liquid in which polymer molecules are dispersed in the molecular or micell state. The aqueous dispersion is more preferably the latex dispersion.

The average particle diameter of the dispersed particles is 1 to 50,000 nm, preferably 5 to 1,000 nm, more preferably 10 to 500 nm, and furthermore preferably 50 to 200 nm. The particle size distribution of the dispersed particles is not particularly restricted, and may be a wide distribution or a monodisperse distribution. It is preferable to use two or more kinds of the particles each having a monodisperse distribution so as to adjust the physical properties of the coating liquid.

The polymer latex is particularly preferably a styrene-isoprene copolymer latex. In the styrene-isoprene copolymer, the mass ratio of the styrene monomer units to the isoprene monomer units is preferably 40/60 to 95/5.

In a preferable embodiment, the polymer latex includes styrene and isoprene, and the polymer latex further includes 1 to 6% by mass of acrylic acid and/or methacrylic acid, based on the total mass of styrene and isoprene. In a more preferable embodiment, the polymer latex includes styrene and isoprene, and the polymer latex further includes 2 to 5% by mass of acrylic acid and/or methacrylic acid, based on the total mass of styrene and isoprene. The polymer latex preferably includes acrylic acid. The polymer in the polymer latex has a number-average molecular weight of preferably 5,000 to 1,000,000, more preferably 10,000 to 200,000. When the molecular weight of the polymer is too small, the mechanical strength of the image forming layer is insufficient. When the molecular weight of the polymer is too large, the film forming property deteriorates. The polymer latex is preferably cross-linkable or cross-linked.

### SPECIFIC EXAMPLES OF COPOLYMER

Example Compounds (P-1) to (P-29) are illustrated below as specific examples of the copolymer including the monomer represented by the formula (M-1) as a copolymerization component. However, the copolymer is not limited to these specific examples. x, y, z, and z′ in the chemical formulae each represent a mass fraction of the polymer composition, the sum of x, y, z, and z′ being 100%. Tg represents a glass-transition temperature of the dry film of the copolymer.

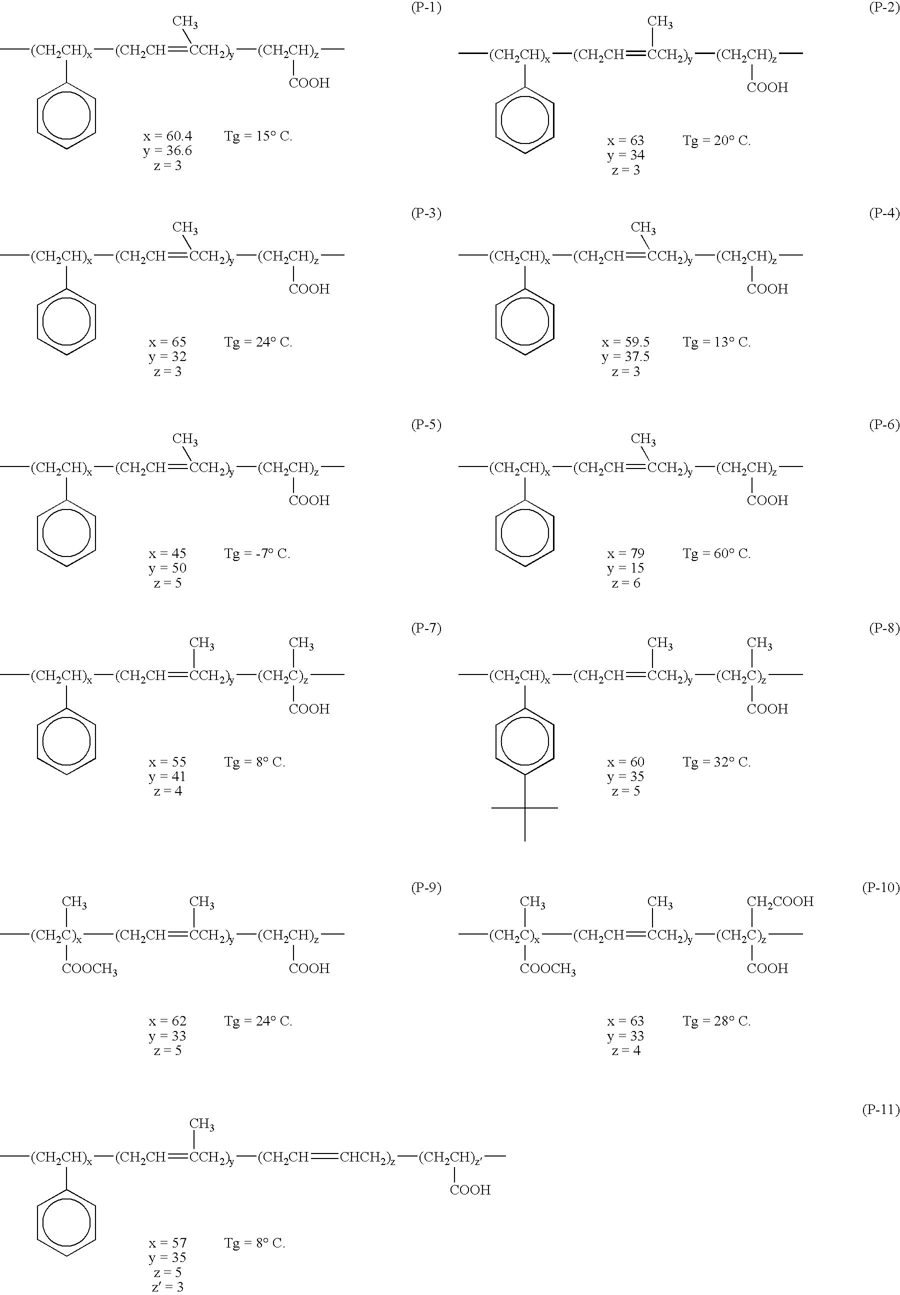

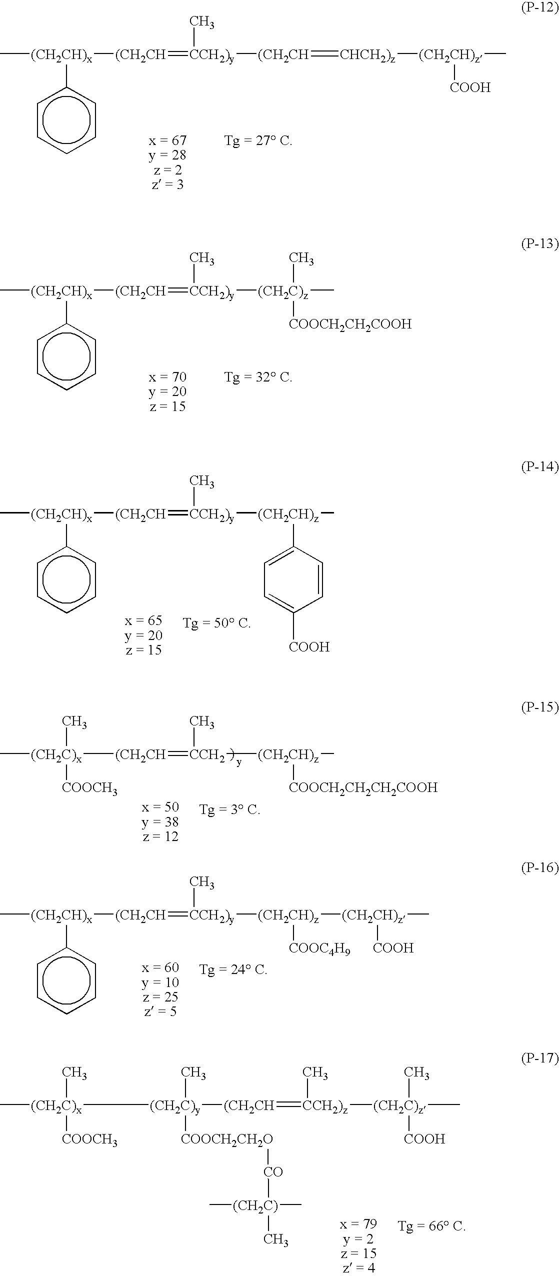

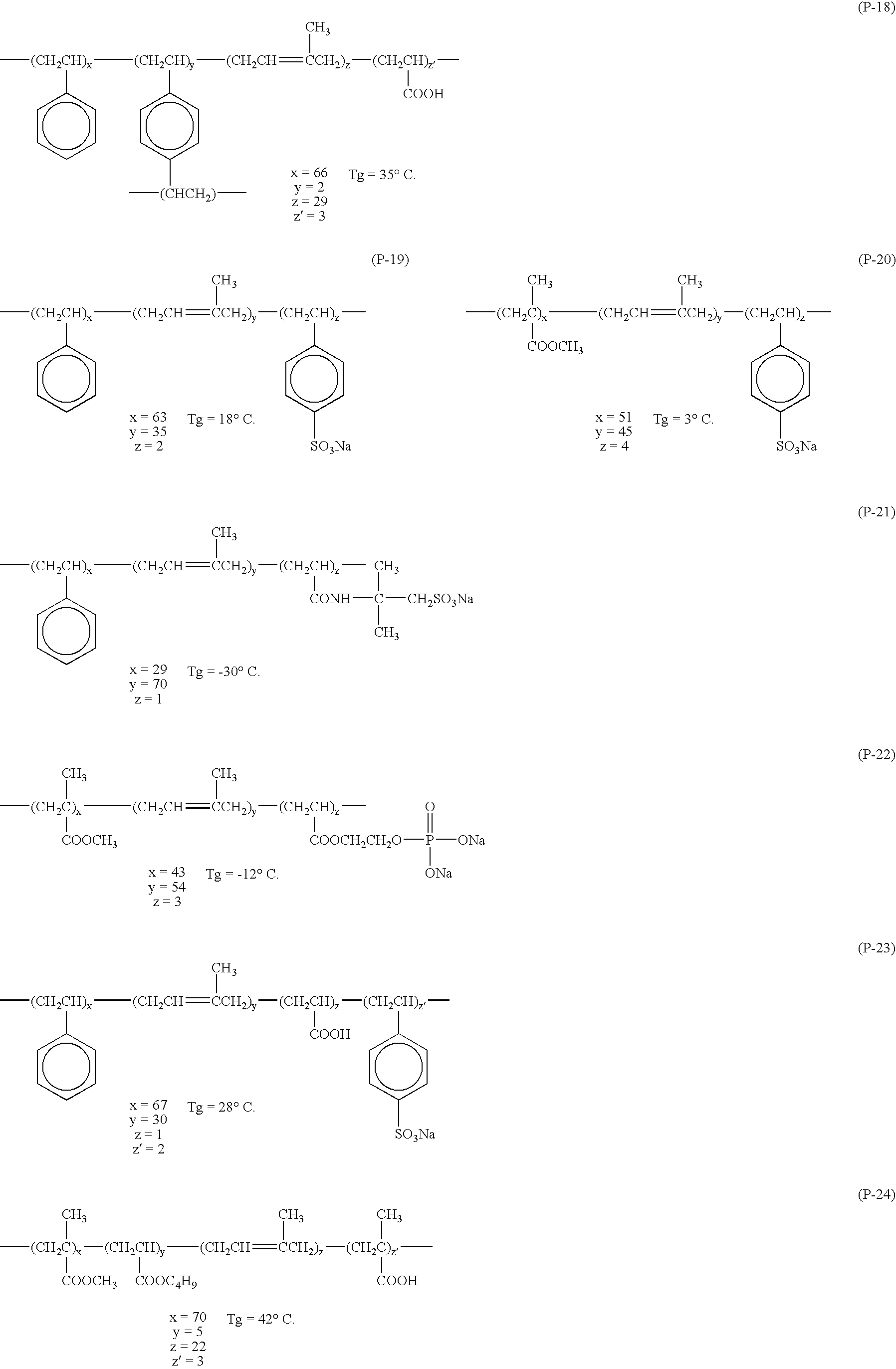

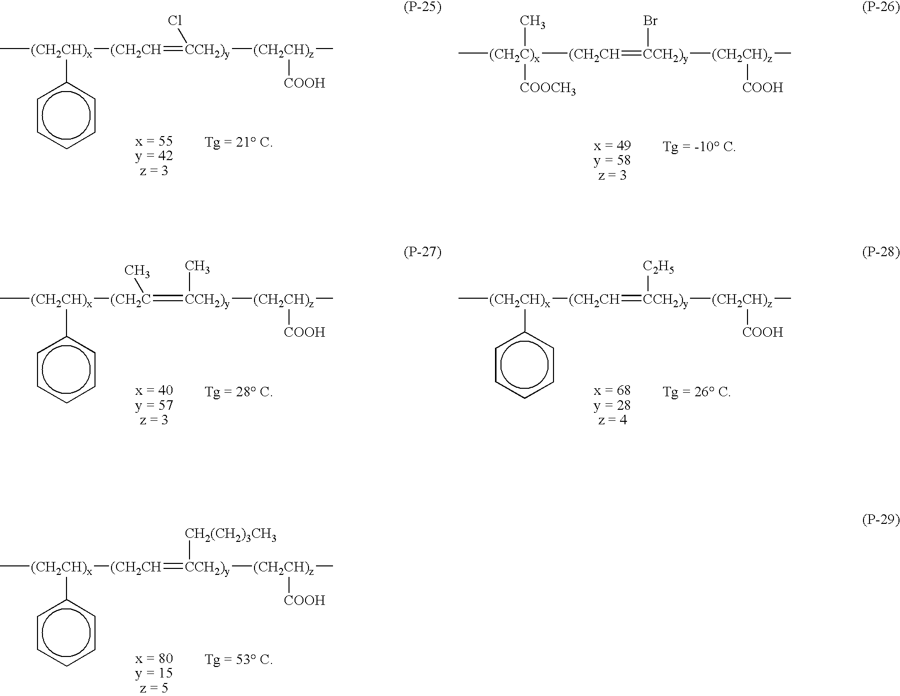

Synthesis Examples of the polymers are described below without intention of restricting the scope of the invention. The other Example Compounds can be synthesized in a similar manner.

### Synthesis Example 1

### Synthesis of Example Compound P-1

1,500 g of distilled water was put in a polymerization kettle of a gas monomer reactor TAS-2J manufactured by Taiatsu Techno Corporation, and heated at 90° C. for 3 hours to form passive films on a stainless-steel surface of the polymerization kettle and on members of a stainless-steel stirring device. To thus treated polymerization kettle were added 582.28 g of distilled water which had been subjected to nitrogen-gas bubbling for 1 hour, 9.49 g of a surfactant PIONINE A-43-S available from Takemoto Oil & Fat Co., Ltd., 19.56 g of 1 mol/l NaOH solution, 0.20 g of tetrasodium ethylenediaminetetraacetate, 314.99 g of styrene, 190.87 g of isoprene, 10.43 g of acrylic acid, and 2.09 g of tert-dodecylmercaptan. The gas monomer reactor was then closed, the contents were stirred at the stirring rate of 225 rpm, and the inner temperature of the reactor was raised to 65° C. A solution prepared by dissolving 2.61 g of ammonium persulfate in 40 ml of water was added thereto and stirred for 6 hours. The polymerization conversion ratio of the monomers, obtained by solid content measurement, was 90% at this moment. Then, a solution prepared by dissolving 5.22 g of acrylic acid in 46.98 g of water was added to the resultant mixture, 10 g of water was added thereto, and further a solution prepared by dissolving 1.30 g of ammonium persulfate in 50.7 ml of water was added. The inner temperature of the reactor was raised to 90° C. and the mixture was stirred for 3 hours. After the reaction, the inner temperature was lowered to the room temperature, and to the mixture were added 1 mol/l solutions of NaOH and NH₄OH such that the mole ratio of Na⁺ ions to NH₄⁺ ions was 1/5.3, whereby the pH value of the mixture was adjusted to 8.2. The resultant mixture was filtrated by a polypropylene filter having a pore diameter of 1.0 μm to remove extraneous substances such as wastes, and then stored. As a result, 1,248 g of Example Compound P-1 (solid content 40.3% by mass, particle diameter 113 nm) was obtained.

### Synthesis Example 2

### Synthesis of Example Compound P-2)

1,500 g of distilled water was put in a polymerization kettle of a gas monomer reactor TAS-2J manufactured by Taiatsu Techno Corporation, and heated at 90° C. for 3 hours to form passive films on a stainless-steel surface of the polymerization kettle and on members of a stainless-steel stirring device. To thus treated polymerization kettle were added 582.28 g of distilled water which had been subjected to nitrogen-gas bubbling for 1 hour, 9.49 g of a surfactant PIONINE A43-S available from Takemoto Oil & Fat Co., Ltd., 19.56 g of 1 mol/l NaOH solution, 0.20 g of tetrasodium ethylenediaminetetraacetate, 328.55 g of styrene, 177.31 g of isoprene, 13.04 g of acrylic acid, and 2.09 g of tert-dodecylmercaptan. The gas monomer reactor was then closed, the contents were stirred at the stirring rate of 225 rpm, and the inner temperature of the reactor was raised to 65° C. A solution prepared by dissolving 2.61 g of ammonium persulfate in 40 ml of water was added thereto and stirred for 6 hours. The polymerization conversion ratio of the monomers, obtained by solid content measurement, was 93% at this moment. Then, a solution prepared by dissolving 2.61 g of acrylic acid in 46.98 g of water was added to the resultant mixture, 10 g of water was added thereto, and further a solution prepared by dissolving 1.30 g of ammonium persulfate in 50.7 ml of water was added. The inner temperature of the reactor was raised to 90° C. and the mixture was stirred for 3 hours. After the reaction, the inner temperature was lowered to the room temperature, and to the mixture were added 1 mol/l solutions of NaOH and NH₄OH such that the mole ratio of Na⁺ ions to NH₄⁺ ions was 1/5.3, whereby the pH value of the mixture was adjusted to 8.2. The resultant mixture was filtrated by a polypropylene filter having a pore diameter of 1.0 μm to remove extraneous substances such as wastes, and then stored. As a result, 1,251 g of Example Compound P-2 (solid content 40.3% by mass, particle diameter 112 nm) was obtained.

### Synthesis Example 3

### Synthesis of Example Compound P-5

1,500 g of distilled water was put in a polymerization kettle of a gas monomer reactor TAS-2J manufactured by Taiatsu Techno Corporation, and heated at 90° C. for 3 hours to form passive films on a stainless-steel surface of the polymerization kettle and on members of a stainless-steel stirring device. To thus treated polymerization kettle were added 582.28 g of distilled water which had been subjected to nitrogen-gas bubbling for 1 hour, 9.49 g of a surfactant PIONINE A43-S available from Takemoto Oil & Fat Co., Ltd., 19.56 g of 1 mol/l NaOH solution, 0.20 g of tetrasodium ethylenediaminetetraacetate, 234.68 g of styrene, 260.76 g of isoprene, 7.82 g of acrylic acid, and 2.09 g of tert-dodecylmercaptan. The gas monomer reactor was then closed, the contents were stirred at the stirring rate of 225 rpm, and the inner temperature of the reactor was raised to 65° C. A solution prepared by dissolving 2.61 g of ammonium persulfate in 40 ml of water was added thereto and stirred for 6 hours. The polymerization conversion ratio of the monomers, obtained by solid content measurement, was 85% at this moment. Then, a solution prepared by dissolving 18.25 g of acrylic acid in 46.98 g of water was added to the resultant mixture, 10 g of water was added thereto, and further a solution prepared by dissolving 1.30 g of ammonium persulfate in 50.7 ml of water was added. The inner temperature of the reactor was raised to 90° C. and the mixture was stirred for 3 hours. After the reaction, the inner temperature was lowered to the room temperature, and to the mixture were added 1 mol/l solutions of NaOH and NH₄OH such that the mole ratio of Na⁺ ions to NH₄⁺ ions was 1/5.3, whereby the pH value of the mixture was adjusted to 8.2. The resultant mixture was filtrated by a polypropylene filter having a pore diameter of 1.0 μm to remove extraneous substances such as wastes, and then stored. As a result, 1,233 g of Example Compound P-5 (solid content 40.3% by mass, particle diameter 110 nm) was obtained.

The other Example Compounds can be synthesized in a similar manner.

2) Other Polymers

The other polymers in the binder of the image-forming layer may be any polymers. The polymers are each preferably transparent or translucent, and generally colorless. The polymers each may be a natural resin, polymer or copolymer, a synthetic resin, polymer or copolymer, or another film-forming medium, and specific examples thereof include gelatins, gums, polyvinyl alcohols, hydroxyethylcelluloses, cellulose acetates, cellulose acetate butyrates, polyvinylpyrrolidones, caseins, starches, polyacrylic acids, polymethylmethacrylic acids, polyvinyl chlorides, polymethacrylic acids, styrene-maleic anhydride copolymers, styrene-acrylonitrile copolymers, styrene-butadiene copolymers, polyvinyl acetals (e.g. polyvinyl formals, polyvinyl butyrals, etc.), polyesters, polyurethanes, phenoxy resins, polyvinylidene chlorides, polyepoxides, polycarbonates, polyvinyl acetates, polyolefins, cellulose esters, and polyamides. In the coating liquid, the binder may be dissolved or dispersed in an aqueous solvent or an organic solvent, or may be in the form of an emulsion.

The glass-transition temperature of the binder polymers (other than the copolymer including the monomer represented by the formula (M-1)) in the image-forming layer is preferably 0 to 80° C., more preferably 10 to 70° C., further preferably 15 to 60° C. Polymer having such high glass-transition temperatures are hereinafter referred to as “high Tg binders” occasionally.

In a preferable embodiment, a coating liquid is prepared which includes a solvent comprising water in an amount of 0.30% by mass based on the amount of the solvent, then the coating liquid is applied and dried to form the image-forming layer. In this embodiment, the binder is preferably a polymer latex having an equilibrium moisture content of 2% by mass or lower at 25° C. 60% RH. The latex preferably has an ionic conductivity of 2.5 mS/cm or lower, and such a latex can be prepared by purifying a synthesized polymer using a separation membrane.

The solvent of the above-described coating liquid is water or a mixed solvent of water and a water-miscible organic solvent, the proportion of the water-miscible organic solvent to the mixed solvent being 70% by mass or lower. Examples of the water-miscible organic solvent include alcohol solvents such as methyl alcohol, ethyl alcohol, and propyl alcohol; cellosolve solvents such as methyl cellosolve, ethyl cellosolve, and butyl cellosolve; ethyl acetate; and dimethylformamide.

The equilibrium moisture content at 25° C. 60% RH can be represented by the following equation:
Equilibrium moisture content at 25° C. 60% RH={(W1−W0)/W0}×100 (% by mass),
in which W1 is a weight of a polymer having an equilibrium moisture content in an atmosphere of 25° C. 60% RH, and W0 is a weight of the polymer in the absolute dry state at 25° C.

Definition and measuring methods of the moisture content is described in Kobunshi Kogaku Koza 14, Kobunshi Zairyo Shikenho, edited by The Society of Polymer Science, Japan, Chijin Shokan Co., Ltd., the disclosure of which is incorporated herein by reference.

The equilibrium moisture content at 25° C. 60% RH of the binder polymer to be used in combination with the copolymer including the monomer represented by the formula (M-1) is preferably 2% by mass or lower, more preferably 0.01 to 1.5% by mass, furthermore preferably 0.02 to 1% by mass.

The polymer to be used in combination with the copolymer including the monomer represented by the formula (M-1) is preferably dispersible in an aqueous solvent. The dispersion state of the polymer in the coating liquid may be a latex in which fine particles of a water-insoluble hydrophobic polymer are dispersed, or a dispersion (or emulsion) liquid in which polymer molecules are dispersed in the molecular or micell state. The latex dispersion is more preferable. The average particle diameter of the dispersed particles is 1 to 50,000 nm, preferably 5 to 1,000 nm, more preferably 10 to 500 nm, and furthermore preferably 50 to 200 nm. The particle size distribution of the dispersed particles is not particularly restricted, and may be a wide or monodisperse distribution. It is preferable to use two or more kinds of particles each having a monodisperse distribution so as to adjust the physical properties of the coating liquid.

Preferred examples of the polymers dispersible in the aqueous solvents include hydrophobic polymers such as acrylic polymers, polyesters, rubbers (e.g. SBR resins), polyurethanes, polyvinyl chlorides, polyvinyl acetates, polyvinylidene chlorides, and polyolefins. The polymer may be linear, branched, or cross-linked, and may be a homopolymer derived form one monomer or a copolymer derived form two or more monomers. The copolymer may be a random copolymer or a block copolymer. The number-average molecular weight of the polymer is preferably 5,000 to 1,000,000, more preferably 10,000 to 200,000. When the number-average molecular weight is too small, the resultant image-forming layer tends to have insufficient strength. On the other hand, when the number-average molecular weight is too large, the polymer is poor in the film-forming properties. Further, cross-linkable polymer latexes are particularly preferable.

Specific examples of the polymer latexes to be used in combination with the copolymer including the monomer represented by the formula (M-1) are described below. In the examples, the polymers are represented by the starting monomers, the numerals in parentheses represent the mass ratios (% by mass) of the monomers, and the molecular weights are number-average molecular weights. The polymers using multifunctional monomers have cross-linked structures and the concept of the molecular weight cannot be implemented therefor, whereby such polymers are referred to as cross-linked polymers and explanation of the molecular weight is omitted. Tg represent the glass-transition temperature.
P-1; Latex of -MMA(70)-EA(27)MAA(3)- (Molecular weight 37,000, Tg 61° C.)
P-2; Latex of -MMA(70)-2EHA(20)-St(5)-AA(5)- (Molecular weight 40,000, Tg 59° C.)
P-3; Latex of -St(50)-Bu(47)MAA(3)- (Cross-linked polymer, Tg −17° C.)
P-4; Latex of -St(68)-Bu(29)-AA(3)- (Cross-linked polymer, Tg 17° C.)
P-5; Latex of -St(71)-Bu(26)-AA(3)- (Cross-linked polymer, Tg 24° C.)
P-6; Latex of -St(70)-Bu(27)IA(3)- (Cross-linked polymer)
P-7; Latex of -St(75)-Bu(24)-AA(1)- (Cross-linked polymer, Tg 29° C.)
P-8; Latex of -St(60)-Bu(35)-DVB(3)MAA(2)- (Cross-linked polymer)
P-9; Latex of -St(70)-Bu(25)-DVB(2)-AA(3)- (Cross-linked polymer)
P-10; Latex of -VC(50)MMA(20)-EA(20)-AN(5)-AA(5)- (Molecular weight 80,000)
P-11; Latex of -VDC(85)MMA(5)-EA(5)MAA(5)- (molecular weight 67,000)
P-12; Latex of -Et(90)MAA(10)- (Molecular weight 12,000)
P-13; Latex of -St(70)-2EHA(27)-AA(3)- (Molecular weight 130,000, Tg 43° C.)
P-14; Latex of MMA(63)-EA(35)-AA(2)- (Molecular weight 33,000, Tg 47° C.)

The abbreviations in the above examples represent the following monomers.
MMA; Methyl methacrylate
EA; Ethyl acrylate
MAA; Methacrylic acid
2EHA; 2-Ethylhexyl acrylate
St; Styrene
Bu; Butadiene
AA; Acrylic acid
DVB; Divinylbenzene
VC; Vinyl chloride
AN; Acrylonitrile
VDC; Vinylidene chloride
Et; Ethylene
IA; Itaconic acid

Commercially-available polymer latexes may be used in the invention, and examples thereof include acrylic polymers such as CEBIAN A-4635, 4718, and 4601 (available from Daicel Chemical Industries, Ltd.) and Nipol LX811, 814, 821, 820, and 857 (available from Nippon Zeon Co., Ltd.); polyesters such as FINETEX ES650, 611, 675, and 850 (available from Dainippon Ink and Chemicals, Inc.) and WD-size and WMS (available from Eastman Chemical Co.); polyurethanes such as HYDRAN AP10, 20, 30, and 40 (available from Dainippon Ink and Chemicals, Inc.); rubbers such as LACSTAR 7310K, 3307B, 4700H, and 7132C (available from Dainippon Ink and Chemicals, Inc.) and Nipol LX416, 410, 438C, and 2507 (available from Nippon Zeon Co., Ltd.); polyvinyl chlorides such as G351 and G576 (available from Nippon Zeon Co., Ltd.); polyvinylidene chlorides such as L502 and L513 (available from Asahi Kasei Kogyo K. K.); and polyolefins such as CHEMIPEARL S120 and SA100 (available from Mitsui Chemicals, Inc.).

Only a single polymer latex may be used or a mixture of two or more polymer latexes may be used in accordance with the necessity.

A hydrophilic polymer such as gelatin, polyvinyl alcohol, methylcellulose, hydroxypropylcellulose, and carboxymethylcellulose may be added to the image-forming layer of the photosensitive material of the invention if necessary. The amount of the hydrophilic polymer is preferably 30% by mass or less, more preferably 20% by mass or less, based on the total amount of the binder in the image-forming layer.

3) Amount of Binder

In the image-forming layer, the weight ratio of the binder to the organic silver salt is preferably in the range of 1/10 to 10/1, more preferably in the range of 1/3 to, 5/1, furthermore preferably in the range of 1/1 to 3/1.

The layer containing the organic silver salt is generally the photosensitive layer (the image-forming layer) containing the photosensitive silver halide (the photosensitive silver salt). In this case, the weight ratio of the binder to the silver halide is preferably in the range of 400 to 5, more preferably in the range of 200 to 10.

In the invention, the total amount of the binder in the image-forming layer is preferably 0.2 to 30 g/m², more preferably 1 to 15 g/m², further preferably 2 to 10 g/m².

4) Film-Forming Aid

The copolymer including the monomer represented by the formula (M-1) is hydrophobic. In order to control the lowest film-forming temperature of the aqueous dispersion of the hydrophobic polymer, a film-forming aid may be incorporated into the image-forming layer. The film-forming aid may be selected from the film-forming aids described above as film-forming aids usable in the non-photosensitive intermediate layer A.

5) Thickener

It is preferable to add a thickener to the image-forming layer including a binder comprising a hydrophobic polymer. A hydrophobic layer having a uniform thickness can be formed by using the thickener. The thickener may be selected from the thickners described above as thickners usable in the non-photosensitive intermediate layer A.

When a thickner is added to the coating liquid for the image-forming layer, the viscosity of the coating liquid at 40° C. is preferably 10 to 100 mPa·s, more preferably 15 to 60 mPa·s, further preferably 20 to 40 mPa·s.

(Preferred Solvent for Coating Liquid)

In the invention, the solvent of the coating liquid for the image-forming layer is preferably an aqueous solvent including 30% by mass or more of water. The term “solvent” used herein means a solvent or a dispersion medium. The aqueous solvent may include any water-miscible organic solvent such as methyl alcohol, ethyl alcohol, isopropyl alcohol, methyl cellosolve, ethyl cellosolve, dimethylformamide, and ethyl acetate. The water content of the solvent for the coating liquid is preferably 50% by mass or higher, more preferably 70% by mass or higher. Examples of preferred solvents include water, 90/10 mixture of water/methyl alcohol, 70/30 mixture of water/methyl alcohol, 80/15/5 mixture of water/methyl alcohol/dimethylformamide, 85/10/5 mixture of water/methyl alcohol/ethyl cellosolve, and 85/10/5 mixture of water/methyl alcohol/isopropyl alcohol, the numerals representing the mass ratios (% by mass).

(Organic Silver Salt)

1) Composition

The non-photosensitive organic silver salt used in the invention is an organic silver salt which is relatively stable to light and which supplies a silver ion when heated to 80° C. or higher under the presence of the exposed photosensitive silver halide and the reducing agent, to form a silver image. The organic silver salt may be any organic substance that can be reduced by the reducing agent to provide a silver ion. Such non-photosensitive organic silver salts are described in JP-A No. 10-62899, Paragraph 0048 to 0049, EP-A No. 0803764A1, Page 18, Line 24 to Page 19, Line 37, EP-A No. 0962812A1, JP-A Nos. 11-349591, 2000-7683, and 2000-72711, etc. The disclosures of the above patent documents are incorporated herein by reference. The organic silver salt is preferably a silver salt of an organic acid, particularly preferably a silver salt of a long-chain aliphatic carboxylic acid having 10 to 30 carbon atoms, preferably having 15 to 28 carbon atoms. Examples of the fatty acid silver salts include silver lignocerate, silver behenate, silver arachidate, silver stearate, silver oleate, silver laurate, silver caproate, silver myristate, silver palmitate, silver erucate, and mixtures thereof. In the invention, the proportion of the amount of silver behenate to the total amount of the organic silver sal is preferably 50 to 100 mol %, more preferably 85 to 100 mol %, further preferably 90 to 100 mol %.

Further, the ratio of the amount of silver erucate to the total amount of the organic silver salts is preferably 2 mol % or less, more preferably 1 mol % or less, further preferably 0.1 mol % or less.

Further, the ratio of the amount of silver stearate to the total amount of the organic silver salts is preferably 1 mol % or lower so as to obtain a photothermographic material with a low Dmin, high sensitivity, and excellent image storability. The ratio of the amount of silver stearate to the total amount of the organic silver salts is more preferably 0.5 mol % or lower. In a preferable embodiment, the organic silver salts includes substantially no silver stearate.

When the organic silver salts include silver arachidate, the ratio of the amount of silver arachidate to the total amount of the organic silver salts is preferably 6 mol % or lower from the viewpoint of achieving a low Dmin and excellent image storability. The ratio of the amount of silver arachidate to the total amount of the organic silver salts is more preferably 3 mol % or lower.

2) Shape

The shape of the grains of the organic silver salts is not particularly restricted. The organic silver salt grains may be in a needle shape, a rod shape, a tabular shape, or a flaky shape.

In the invention, the organic silver salt grains are preferably in a flaky shape. It is also preferable to use organic silver salt grains in a short needle-shape, a rectangular shape, a cubic shape, or a potato-like shape, wherein each shape has a ratio of the longer axis to the shorter axis of lower than 5. Such organic silver salt grains cause less fogging which develops on the resultant photothermographic material in the heat development than long needle-shaped grains having a length ratio of the longer axis to the shorter axis of 5 or higher. The ratio of the longer axis to the shorter axis is more preferably 3 or lower, since the mechanical stability of the coating film is improved when organic silver salt grains having such a shape are used.

In the invention, organic silver salt grains in a flaky shape are defined as follows. Organic silver salt grains are observed by an electron microscope, and the shape of each grain is approximated by a rectangular parallelepiped shape. The lengths of the three sides of the rectangular parallelepiped shape are respectively represented by a, b, and c in the ascending order (wherein c and b may be the same values), and a value x is calculated from the smaller values a and b using the following equation: x=b/a. The values x of approximately 200 grains are calculated in the above-described manner to obtain an average x (the average of the values x). The organic silver salt grains in a flaky shape are defined as grains with an average x of 1.5 or larger. The average x is preferably 1.5 to 30, more preferably 1.5 to 15. In contrast, the organic silver salt grains in a needle-shape are defined as grains with an average x of 1 or larger but smaller than 1.5.

In the flaky grains (grains in a flaky shape), the length a may be considered as the thickness of a tabular grain having a main plane defined by the sides with the lengths b and c. The average of the lengths a of the grains is preferably 0.01 to 0.3 μm, more preferably 0.1 to 0.23 μm. The average of values c/b of the grains is preferably 1 to 9, more preferably 1 to 6, furthermore preferably 1 to 4, most preferably 1 to 3.

When the equivalent sphere diameters of the organic silver salt grains are 0.05 to 1 μm, the grains hardly aggregate in the photosensitive material, resulting in excellent image storability. The equivalent sphere diameter is preferably 0.1 to 1 μm. In the invention, the equivalent sphere diameter is measured by: directly photographing a sample using an electron microscope, and then image-processing the negative.

The aspect ratio of the flaky grain is defined as the value of the equivalent sphere diameter/a. The aspect ratio of the flaky grain is preferably 1.1 to 30, more preferably 1.1 to 15, so as to prevent the aggregation of the grains in the photosensitive material, thereby improving the image storability.

The grain size distribution of the organic silver salt grains is preferably monodisperse distribution. In the monodisperse distribution, the percentage obtained by dividing the standard deviation of the length of the longer axis by the length of the longer axis and the percentage obtained by dividing the standard deviation of the length of the shorter axis by the length of the shorter axis are preferably 100% or lower, more preferably 80% or less, further preferably 50% or less. In order to observe the shape of the organic silver salt grain, a transmission electron microscope may be used to give a micrograph of the organic silver salt dispersion. Alternatively, the monodisperse distribution may be evaluated based on the standard deviation of the volume-weighted average diameter of the organic silver salt grains, and the percentage (the variation coefficient) obtained by dividing the standard deviation by the volume-weighted average diameter is preferably 100% or lower, more preferably 80% or lower, further preferably 50% or lower. For example, the grain size (the volume-weighted average diameter) may be measured by: dispersing the organic silver salt grains in a liquid, and exposing the dispersion to a laser light and obtaining the autocorrelation function of fluctuation of the scattering light to time.

3) Preparation

The organic silver salt grains may be prepared and dispersed by known methods described, for example, in JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 200249117, 2002-31870, and 2002-107868, the disclosures of which are incorporated herein by reference.

When the organic silver salt grains are dispersed in the presence of a photosensitive silver salt, the fogging is intensified and the sensitivity is remarkably reduced. Thus, in a preferable embodiment, substantially no photosensitive silver salts are present when the organic silver salt grains are dispersed. In the invention, the amount of photosensitive silver salts in the aqueous dispersion liquid of the organic silver salt is preferably 1 mol % or less, more preferably 0.1 mol % or less, per 1 mol of the organic silver salt. It is more preferable not to add photosensitive silver salts to the dispersion liquid actively.

In an embodiment, the photosensitive material is prepared by processes comprising mixing an aqueous organic silver salt dispersion liquid with an aqueous photosensitive silver salt dispersion liquid. The mixing ratio between the organic silver salt and the photosensitive silver salt may be selected depending on the use of the photosensitive material. The mole ratio of the photosensitive silver salt to the organic silver salt is preferably 1 to 30 mol %, more preferably 2 to 20 mol %, particularly preferably 3 to 15 mol %. It is preferable to mix two or more aqueous organic silver salt dispersion liquids and two or more aqueous photosensitive silver salt dispersion liquids so as to adjust the photographic properties.

4) Amount

The amount of the organic silver salt may be selected without particular restrictions, and the total amount of the applied silver (including the photosensitive silver halide) is preferably 0.1 g/m² to 5.0, more preferably 0.3 g/m² to 3.0 g/m², furthermore preferably 0.5 g/m² to 2.0 g/m². In order to improve the image storability, the total amount of the applied silver is preferably 1.8 g/m² or less, more preferably 1.6 g/m² or less, further preferably 1.3 g/m² or less. In the invention, when a reducing agent preferred in the invention is used, sufficient image density can be achieved even with such a small amount of silver.

(Antifoggant)

Examples of antifoggants, stabilizers, and stabilizer precursors usable in the invention include compounds disclosed in JP-A No. 10-62899, Paragraph 0070 and EP-A No. 0803764A1, Page 20, Line 57 to Page 21, Line 7; compounds described in JP-A Nos. 9-281637 and 9-329864; and compounds described in U.S. Pat. No. 6,083,681 and EP No. 1048975. The disclosures of the above patent documents are incorporated herein by reference.

(1) Polyhalogen Compound

Organic polyhalogen compounds, which can be preferably used as the antifoggant in the invention, are described in detail below. The antifoggant is particularly preferably an organic polyhalogen compound represented by the following formula (H) since such an organic polyhalogen compound can improve the storability of the unexposed photosensitive material (the unprocessed stock storability), and can suppress the development of fog during storage under high temperature in the dark:
Q-(Y)ₙ—C(Z1)(Z2)X. Formula (H)

In the formula (H), Q represents an alkyl group, an aryl group, or a heterocyclic group, Y represents a divalent linking group, n represents 0 to 1, Z1 and Z2 each independently represent a halogen atom, and X represents a hydrogen atom or an electron-withdrawing group.

In the formula (H), Q represents preferably an alkyl group having 1 to 6 carbon atoms, an aryl group having 6 to 12 carbon atoms, or a heterocyclic group including at least one nitrogen atom such as a pyridyl group and a quinolyl group.

When Q represents an aryl group, the aryl group is preferably a phenyl group substituted by an electron-withdrawing group with a positive Hammett's substituent constant up. The Hammett's substituent constant is described, for example, in Journal of Medicinal Chemistry, 1973, Vol. 16, No. 11, 1207-1216, the disclosure of which is incorporated herein by reference. Examples of such an electron-withdrawing group include halogen atoms, alkyl groups having substituents of electron-withdrawing groups, aryl groups substituted by electron-withdrawing groups, heterocyclic groups, alkyl sulfonyl groups, aryl sulfonyl groups, acyl groups, alkoxycarbonyl groups, carbamoyl groups, and sulfamoyl groups. The electron-withdrawing group is preferably a halogen atom, a carbamoyl group, or an arylsulfonyl group, particularly preferably a carbamoyl group.

X represents preferably an electron-withdrawing group. The electron-withdrawing group is preferably a halogen atom, an aliphatic, aryl, or heterocyclyl sulfonyl group, an aliphatic, aryl, or heterocyclyl acyl group, an aliphatic, aryl, or heterocyclyl oxycarbonyl group, a carbamoyl group, or a sulfamoyl group, more preferably a halogen atom or a carbamoyl group, particularly preferably a bromine atom.

Z1 and Z2 each independently represent preferably a bromine atom or an iodine atom, more preferably a bromine atom.

Y represent preferably C(═O)—, —SO—, —SO₂—, C(═O)N(R)—, or —SO₂N(R)—, more preferably C(═O)—, —SO₂—, or —C(═O)N(R)—, particularly preferably —SO₂— or C(═O)N(R)—, in which R represents a hydrogen atom, an aryl group, or an alkyl group, preferably a hydrogen atom or an alkyl group, particularly preferably a hydrogen atom.

In the formula (H), n represents 0 or 1, preferably 1.

In the formula (H), Y represents preferably —C(═O)N(R)— when Q represents an alkyl group, and Y represents preferably —SO₂— when Q represents an aryl group or a heterocyclic group.

In an embodiment, the antifoggant is a compound including two or more units represented by the formula (H), wherein each unit is bound to another unit, and a hydrogen atom in the formula (H) is substituted with the bond in each unit. Such a compound is referred to as a bis-, tris-, or tetrakis-type compound.

The compound represented by (H) is preferably substituted by a dissociative group (such as a COOH group, a salt of a COOH group, an SO₃H group, a salt of an SO₃H group, a PO₃H group, or a salt of a PO₃H group); a group containing a quaternary nitrogen cation, such as an ammonium group or a pyridinium group; a polyethyleneoxy group; a hydroxyl group; or the like.

Specific examples of the compounds represented by the formula (H) are shown below.

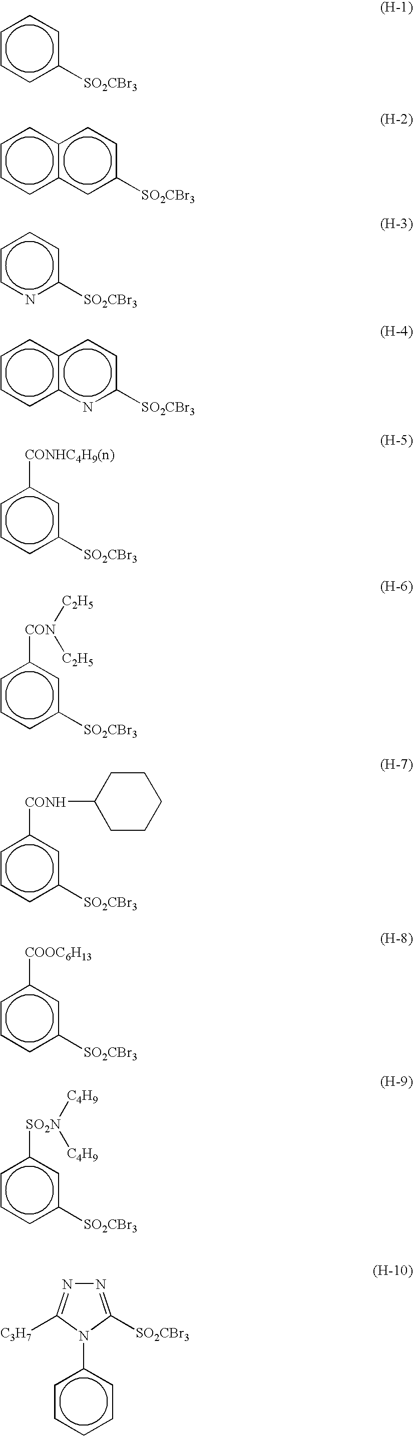

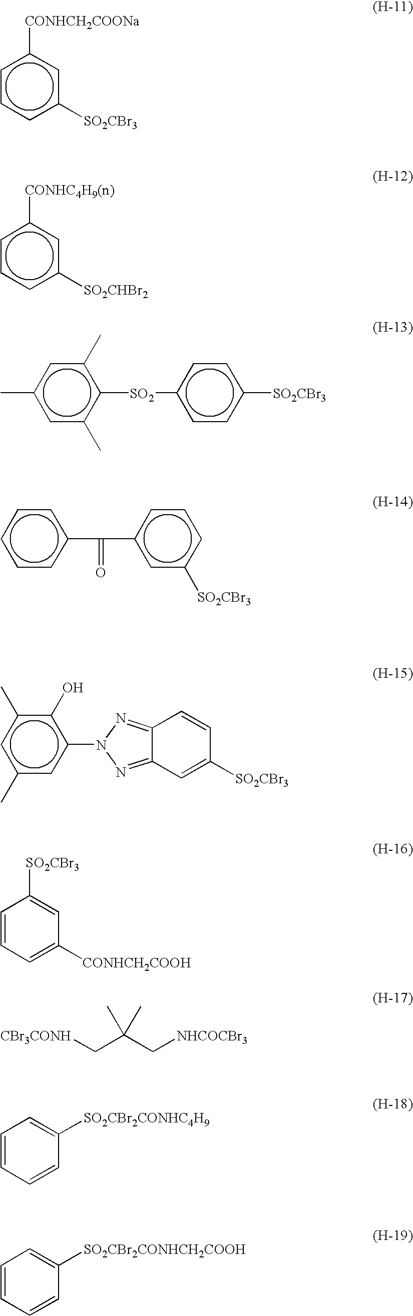

It is preferable to use two or more compounds represented by the formula (H) so as to further improve the unprocessed stock storability of the unexposed photosensitive material, the image storability of the exposed heat-developed material, and to suppress the fogging in unprocessed stock. The mixture of compounds represented by the formula (H) is preferably such a mixture that the value obtained by subtracting the heat development temperature from the melting temperature of the mixture is −10 to 50° C. When the heat development temperature is 120° C., specific examples of preferred combinations include the combination of (H-5) and (H-1) (melting temperature 129° C., difference from the heat developing temperature is 9° C.); the combination of (H-2) and (H-5) (melting temperature 154° C., difference from the heat developing temperature is 34° C.); the combination of (H-1) and (H-4) (melting temperature 122° C., difference from the heat developing temperature is 2° C.); the combination of (H-2) and (H-4) (melting temperature 132° C., difference 12° C.); and the combination of (H-4) and (H-5) (melting temperature 129° C., difference from the heat developing temperature is 9° C.). The combination is not limited to the above examples.

When two or more compounds represented by the formula (H) are used, the total amount of the compounds represented by the formula (H) applied per 1 m² of the photothermographic material is preferably 1×10⁻⁶ to 1×10⁻² mol/m², more preferably 1×10⁻⁵ to 5×10⁻³ mol/m², further preferably 2×10⁻⁵ to 2×10⁻³ mol/m². When two or more compounds represented by the formula (H) are used, the mole ratio between the compounds is not particularly restricted. For example, when two compounds of the formula (H) are used, the mole ratio between the compounds may be 0.5/99.5 to 99.5/0.5. When three or more compounds of the formula (H) are used, the total amount of the compounds other than the compound occupying the largest proportion may be 0.5 mol % or larger.

Examples of polyhalogen compounds usable in the invention include, in addition to the above compounds, compounds described in U.S. Pat. Nos. 3,874,946, 4,756,999, 5,340,712, 5,369,000, 5,464,737, and 6,506,548, and JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441, the disclosure of which are incorporated herein by reference. The compounds described in JP-A Nos. 7-2781, 2001-33911, and 2001-312027 are particularly preferred.

The amount of the polyhalogen compound is preferably 10⁻⁴ mol to 1 mol, more preferably 10⁻³ mol to 0.5 mol, further preferably mol 10⁻² to 0.2 mol, per 1 mol of the non-photosensitive silver salt.

The antifoggant may be added to the photosensitive material in any of the manners described above as examples of the method of adding the reducing agent. The organic polyhalogen compound is preferably added in the state of a solid particle dispersion.

(2) Other Antifoggants

Examples of other antifoggants usable in the invention include mercury (II) salts described in JP-A No. 11-65021, Paragraph 0113; benzoic acid compounds described in JP-A No. 11-65021, Paragraph 0114; salicylic acid derivatives described in JP-A No. 2000-206642; formalin scavenger compounds represented by the formula (S) described in JP-A No. 2000-221634; triazine compounds disclosed in claim 9 of JP-A No. 11-352624; compounds represented by the formula (III) described in JP-A No. 6-11791; and 4-hydroxy-6-methyl-1,3,3a,7-tetrazaindene. The disclosures of the above patent documents are incorporated herein by reference.

The photothermographic materials of the invention may further include an azolium salt for the purpose of preventing the fogging. Examples of the azolium salt include compounds represented by the formula (XI) described in JP-A No. 59-193447; compounds described in JP-B No. 55-12581; and compounds represented by the formula (II) described in JP-A No. 60-153039. The disclosures of the above patent documents are incorporated herein by reference. In an embodiment, the azolium salt is added to a layer on the same side as the image-forming layer. The layer to which the azolium salt may be added is preferably the image-forming layer. However, the azolium salt may be added to any portion of the material. The azolium salt may be added in any step in the preparation of the coating liquid. When the azolium salt is added to the image-forming layer, the azolium salt may be added in any step between the preparation of the organic silver salt and the preparation of the coating liquid. In an embodiment, the azolium salt is added during the period after the preparation of the organic silver salt but before the application of the coating liquid. The azolium salt may be added in the form of powder, a solution, a fine particle dispersion, etc. Further, the azolium salt may be added in the form of a solution which further contains other additives such as sensitizing dyes, reducing agents, and toning agents. The amount of the azolium salt to be added per 1 mol of silver is not particularly limited, and is preferably 1×10⁻⁶ mol to 2 mol, more preferably 1×10⁻³ mol to 0.5 mol.

(Reducing Agent)

The photothermographic material of the invention preferably includes a reducing agent for the organic silver salt. The reducing agent for the organic silver salt may be any substance that can reduce a silver ion to form silver metal. The reducing agent is preferably an organic substance. Examples of the reducing agents are described, for example, in JP-A No. 11-65021, Paragraph 0043 to 0045, EP-A No. 0803764A1, Page 7, Line 34 to Page 18, Line 12, the disclosures of which are incorporated herein by reference.

In the invention, the reducing agent is preferably a so-called hindered phenol reducing agent having a substituent at an ortho position relative to the phenolic hydroxyl group, or a bisphenol reducing agent, particularly preferably a compound represented by the following formula (R).

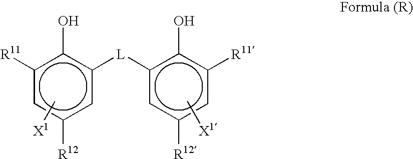

In the formula (R), R¹¹ and R^{11′} each independently represent an alkyl group having 1 to 20 carbon atoms; R¹² and R¹² each independently represent a hydrogen atom or a substituent which can be bonded to the benzene ring; L represents an —S— group or a —CHR¹³— group, and R¹³ represents a hydrogen atom or an alkyl group having 1 to 20 carbon atoms; X¹ and X^{1′} each independently represent a hydrogen atom or a substituent which can be bonded to the benzene ring.

The formula (R) is described in detail below. In the following, the scope of the term “an alkyl group” encompasses “a cycloalkyl group” unless mentioned otherwise.

1) R¹¹ and R^{11′}

R¹¹ and R^{11′} each independently represent a substituted or unsubstituted alkyl group having 1 to 20 carbon atoms. There are no particular restrictions on the substituents on the alkyl group. Examples of preferred substituents on the alkyl group include aryl groups, a hydroxy group, alkoxy groups, aryloxy groups, alkylthio groups, arylthio groups, acylamino groups, sulfonamide groups, sulfonyl groups, phosphoryl groups, acyl groups, carbamoyl groups, ester groups, ureido groups, urethane groups, and halogen atoms.

2) R¹² and R^{12′}, and X¹ and X^{1′}

R¹² and R^{12′} each independently represent a hydrogen atom or a substituent which can be bonded to the benzene ring. Also X¹ and X^{1′} each independently represent a hydrogen atom or a substituent which can be bonded to the benzene ring. Examples of preferable substituents which can be bonded to the benzene ring include alkyl groups, aryl groups, halogen atoms, alkoxy groups, and acylamino groups.

3) L

L represents an —S— group or a —CHR¹³— group. R¹³ represents a hydrogen atom or an alkyl group having 1 to 20 carbon atoms, and the alkyl group may have a substituent. When R¹³ represents an unsubstituted alkyl group, examples thereof include a methyl group, an ethyl group, a propyl group, a butyl group, a heptyl group, an undecyl group, an isopropyl group, a 1-ethylpentyl group, a 2,4,4-trimethylpentyl group, a cyclohexyl group, a 2,4-dimethyl-3-cyclohexenyl group, and a 2,4-dimethyl-3-cyclohexenyl group. Examples of the substituent on the alkyl group represented by R¹³ include the substituents described above as examples of the substituents on R¹¹ or R^{11′}. The substituent on the alkyl group may be a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, or a sulfamoyl group.

4) Preferred Substituents

R¹¹ and R^{11′} are each preferably a primary alkyl group having 1 to 15 carbon atoms, a secondary alkyl group having 1 to 15 carbon atoms, or a tertiary alkyl group having 1 to 15 carbon atoms. Specific examples of such an alkyl group include a methyl group, an isopropyl group, a tbutyl group, a t-amyl group, a t-octyl group, a cyclohexyl group, a cyclopentyl group, a 1-methyl cyclohexyl group, and a 1-methylcyclopropyl group. R¹¹ and R^{11′} each are more preferably an alkyl group having 1 to 4 carbon atoms, furthermore preferably a methyl group, a t-butyl group, a t-amyl group, or a 1-methylcyclohexyl group, most preferably a methyl group or a t-butyl group.

R¹² and R^{12′} are each preferably an alkyl group having 1 to 20 carbon atoms, and specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. R¹² and R^{12′} are each more preferably a methyl group, an ethyl group, a propyl group, an isopropyl group, or a t-butyl group, particularly preferably a methyl group or an ethyl group.

X¹ and X^{1′} are each preferably a hydrogen atom, a halogen atom, or an alkyl group, more preferably a hydrogen atom.

L is preferably a —CHR¹³— group.

R¹³ is preferably a hydrogen atom or an alkyl group having 1 to 15 carbon atoms. The alkyl group may be a linear alkyl group or a cyclic alkyl group, and may have a C═C bond. The alkyl group is preferably a methyl group, an ethyl group, a propyl group, an isopropyl group, a 2,4,4-trimethylpentyl group, a cyclohexyl group, a 2,4-dimethyl-3-cyclohexenyl group, or a 3,5-dimethyl-3-cyclohexenyl group. R¹³ is particularly preferably a hydrogen atom, a methyl group, an ethyl group, a propyl group, an isopropyl group, or a 2,4-dimethyl-3-cyclohexenyl group.

When R¹¹ and R^{11′} are tertiary alkyl groups and R¹² and R^{12′} are methyl groups, R¹³ is preferably a primary or secondary alkyl group having 1 to 8 carbon atoms such as a methyl group, an ethyl group, a propyl group, an isopropyl group, or a 2,4-dimethyl-3-cyclohexenyl group.

When R¹¹ and R^{11′} are tertiary alkyl groups and R¹² and R^{12′} are alkyl groups other than methyl, R¹³ is preferably a hydrogen atom.

When none of R¹¹ and R^{11′} is a tertiary alkyl group, R¹³ is preferably a hydrogen atom or a secondary alkyl group, particularly preferably a secondary alkyl group. The secondary alkyl group is preferably an isopropyl group or a 2,4-dimethyl-3-cyclohexenyl group.

The combination of R¹¹, R^{11′}, R¹², R^{12′} and R¹³ affects the heat developability of the resultant photothermographic material, the tone of the developed silver, and the like. It is preferable to use a combination of two or more reducing agents depending on the purpose since such properties can be adjusted by the combination of the reducing agents.

In the invention, the reducing agent is preferably a reducing agent represented by the following formula (R1):

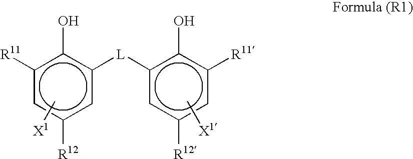

The formula (R1) is different from the formula (R) only in the difinition of R¹¹ and R^{11′}. In the formula (R1), R¹¹ and R^{11′} each independently represent a secondary or tertiary alkyl group having 1 to 15 carbon atoms. The difinitions of the groups respectively represented by R¹², R^{12′}, L, X¹, and X^{1′} in the formula (R1) are the same as the difinitions of the groups respectively represented by R¹², R^{12′}, L, X¹, and X^{1′} in the formula (R).

Specific examples of the reducing agent usable in the invention (such as compounds represented by the formula (R)) are illustrated below without intention of restricting the scope of the invention.

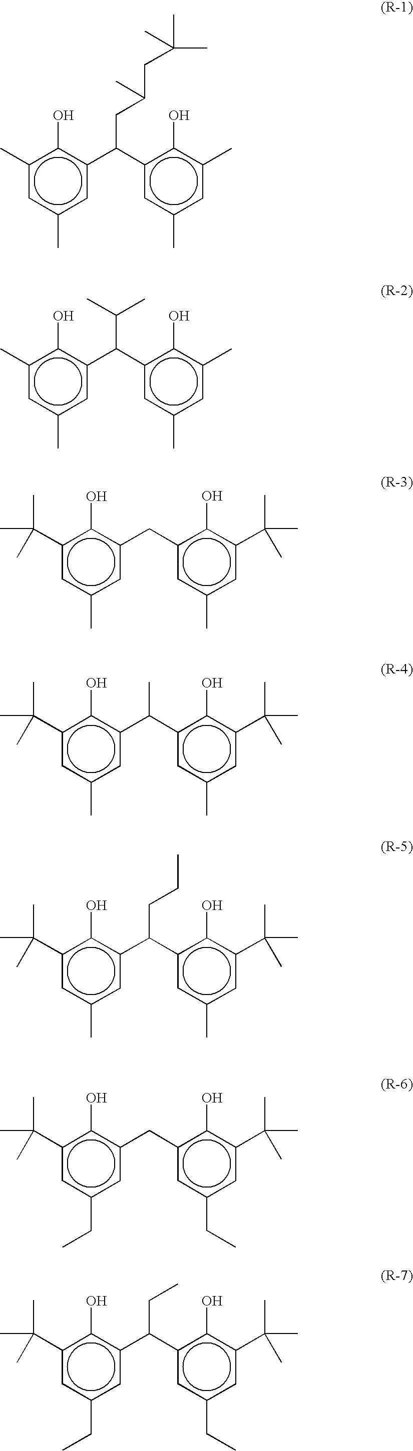

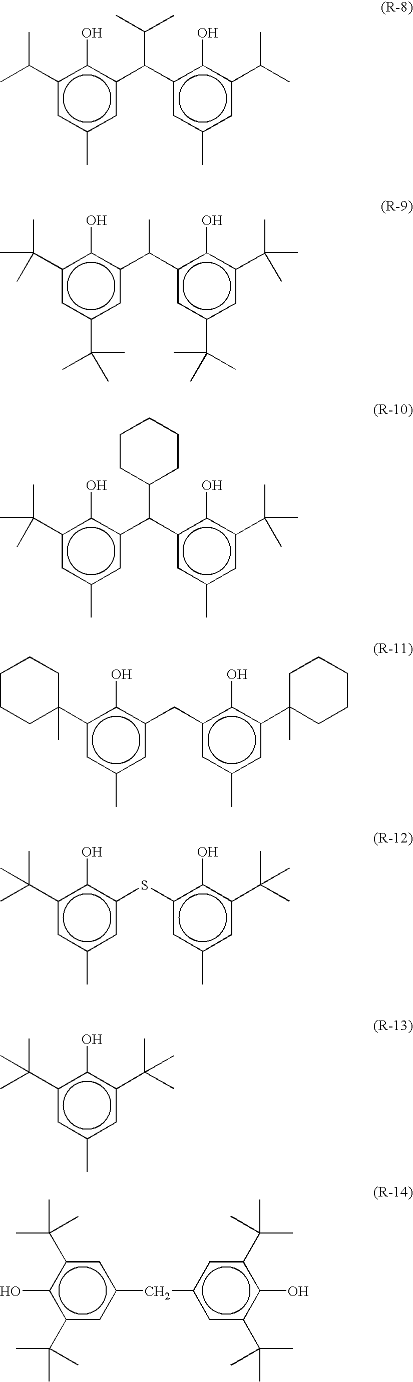

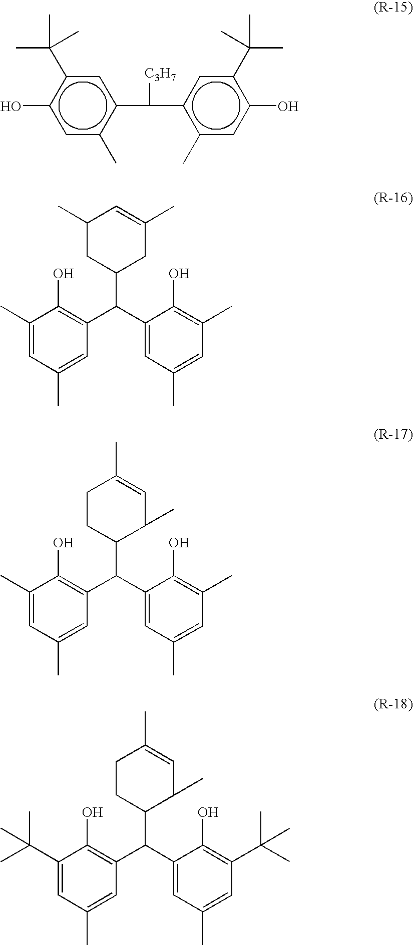

In addition, preferable reducing agents are also disclosed in JP-A Nos. 2001-188314, 2001-209145, 2001-350235, and 2002-156727, and EP 1278101A2, the disclosures of which are incorporated herein by reference.

The amount of the reducing agent in the photothermographic material is preferably 0.1 to 3.0 g/m², more preferably 0.2 to 2.0 g/m², furthermore preferably 0.3 to 1.0 g/m². Further, the mole ratio of the reducing agent to silver on the image-forming layer side is preferably 5 to 50 mol %, more preferably 8 to 30 mol %, further preferably 10 to 20 mol %.

The state of the reducing agent in the coating liquid may be any state such as a solution, an emulsion, a solid particle dispersion.

The emulsion of the reducing agent may be prepared by a well-known emulsifying method. The exemplary method comprises: dissolving the reducing agent in an oil such as dibutyl phthalate, tricresyl phosphate, dioctyl sebacate, or tri(2-ethylhexyl)phosphate, optionally using a cosolvent such as ethyl acetate or cyclohexanone; and then mechanically emulsifying the reducing agent in the presence of a surfactant such as sodium dodecylbenzene sulfonate, sodium oleoyl-N-methyltaurinate, or sodium di(2-ethylhexyl)sulfosuccinate. In this method, it is preferable to add a polymer such as α-methylstyrene oligomer or poly(t-butylacrylamide) to the emulsion in order to control the viscosity and the refractive index of the oil droplets.

In an embodiment, the solid particle dispersion is prepared by a method comprising dispersing powder of the reducing agent in an appropriate solvent such as water using a ball mill, a colloid mill, a vibration ball mill, a sand mill, a jet mill, a roll mill, or ultrasonic wave. A protective colloid (e.g. a polyvinyl alcohol) and/or a surfactant such as an anionic surfactant (e.g. a mixture of sodium triisopropylnaphthalenesulfonates each having a different combination of the substitution positions of the three isopropyl groups) may be used in the preparation. Beads of zirconia, etc. are commonly used as a dispersing medium in the above mills, and in some cases Zr, etc. is eluted from the beads and mixed with the dispersion. The amount of the eluted and mixed component depends on the dispersion conditions, and is generally within the range of 1 to 1,000 ppm. The eluted zirconia does not cause practical problems as long as the amount of Zr in the photothermographic material is 0.5 mg or smaller per 1 g of silver.

In a preferable embodiment, the aqueous dispersion includes an antiseptic agent such as a benzoisothiazolinone sodium salt.

The reducing agent is particularly preferably used in the state of a solid particle dispersion. The reducing agent is preferably added in the form of fine particles having an average particle size of 0.01 to 10 μm, more preferably 0.05 to 5 μm, further preferably 0.1 to 2 μm. In the invention, the particle sizes of particles in other solid dispersions are preferably in the above range.

(Development Accelerator)

The photothermographic material of the invention preferably includes a development accelerator, and preferred examples thereof include sulfonamidephenol compounds represented by the formula (A) described in JP-A Nos. 2000-267222 and 2000-330234; hindered phenol compounds represented by the formula (II) described in JP-A No. 2001-92075; hydrazine compounds represented by the formula (1) described in JP-A Nos. 10-62895 and 11-15116; hydrazine compounds represented by the formula (D) described in JP-A No. 2002-156727; hydrazine compounds represented by the formula (1) described in JP-A No. 2002-278017; phenol compounds and naphthol compounds represented by the formula (2) described in JP-A No. 2001-264929; phenol compounds described in JP-A Nos. 2002-311533 and 2002-341484; and naphthol compounds described in JP-A No. 2003-66558. The disclosures of the above patent documents are incorporated herein by reference. Naphthol compounds described in JP-A No. 2003-66558 are preferable.

The mol ratio of the development accelerator to the reducing agent is 0.1 to 20 mol %, preferably 0.5 to 10 mol %, more preferably 1 to 5 mol %.

The development accelerator may be added to the photothermographic material in any of the manners described above as examples of the method of adding the reducing agent. The development accelerator is particularly preferably added in the form of a solid dispersion or an emulsion. The emulsion of the development accelerator is preferably a dispersion prepared by emulsifying the development accelerator in a high-boiling-point solvent that is solid at ordinary temperature and a low-boiling-point cosolvent, or a so-called oilless emulsion which includes no high-boiling-point solvents.

In the invention, the hydrazine compounds described in JP-A Nos. 2002-156727 and 2002-278017, and the naphthol compounds described in JP-A No. 2003-66558 are more preferable development accelerators.

In the invention, the development accelerator is particularly preferably a compound represented by the following formula (A-1) or (A-2).
Q1-NHNH-Q2 Formula (A-1);

In the formula (A-1), Q1 represents an aromatic group or a heterocyclic group each of which has a carbon atom bonded to the —NHNH-Q2 group. Q2 represents a carbamoyl group, an acyl group, an alkoxycarbonyl group, an aryloxycarbonyl group, a sulfonyl group, or a sulfamoyl group.

In the formula (A-1), the aromatic group or the heterocyclic group represented by Q1 preferably has a 5- to 7-membered unsaturated ring. Examples of the 5- to 7-membered unsaturated ring include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring, a thiophene ring, and condensed rings thereof.

The ring may have a substituent. When the ring has two or more substituents, they may be the same as each other or different from each other. Examples of the substituents include halogen atoms, alkyl groups, aryl groups, carbonamide groups, alkylsulfonamide groups, arylsulfonamide groups, alkoxy groups, aryloxy groups, alkylthio groups, arylthio groups, carbamoyl groups, sulfamoyl groups, a cyano group, alkylsulfonyl groups, arylsulfonyl groups, alkoxycarbonyl groups, aryloxycarbonyl groups, and acyl groups. These substituents may further have substituents, and preferred examples thereof include halogen atoms, alkyl groups, aryl groups, carbonamide groups, alkylsulfonamide groups, arylsulfonamide groups, alkoxy groups, aryloxy groups, alkylthio groups, arylthio groups, acyl groups, alkoxycarbonyl groups, aryloxycarbonyl groups, carbamoyl groups, a cyano group, sulfamoyl groups, alkylsulfonyl groups, arylsulfonyl groups, and acyloxy groups.

When Q2 represents a carbamoyl group, the carbamoyl group preferably has 1 to 50 carbon atoms, and more preferably has 6 to 40 carbon atoms. Examples of the carbamoyl group include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N2-hexyldecyl)carbamoyl, N-phenylcarbamoyl, N4-dodecyloxyphenyl)carbamoyl, N-(2-chloro-5-dodecyloxycarbonylphenyl)carbamoyl, N-naphtylcarbamoyl, N-3-pyridylcarbamoyl, and N-benzylcarbamoyl.

When Q2 represents an acyl group, the acyl group preferably has 1 to 50 carbon atoms, and more preferably has 6 to 40 carbon atoms. Examples of the acyl group include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl.

When Q2 represents an alkoxycarbonyl group, the alkoxycarbonyl group preferably has 2 to 50 carbon atoms, and more preferably has 6 to 40 carbon atoms. Examples of the alkoxycarbonyl group include methoxycarbonyl, ethoxycarbonyl, isobutyloxycarbonyl, cyclohexyloxycarbonyl, dodecyloxycarbonyl, and benzyloxycarbonyl.

When Q2 represents an aryloxycarbonyl group, the aryloxycarbonyl group preferably has 7 to 50 carbon atoms, and more preferably has 7 to 40 carbon atoms. Examples of the aryloxycarbonyl group include phenoxycarbonyl, 4-octyloxyphenoxycarbonyl, 2-hydroxymethylphenoxycarbonyl, and 4-dodecyloxyphenoxycarbonyl.

When Q2 represents a sulfonyl group, the sulfonyl group preferably has 1 to 50 carbon atoms, and more preferably has 6 to 40 carbon atoms. Examples of the sulfonyl groups include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

When Q2 represents a sulfamoyl group, the sulfamoyl group preferably has 0 to 50 carbon atoms, and more preferably has 6 to 40 carbon atoms. Examples of the sulfamoyl group include unsubstituted sulfamoyl, N-ethylsulfamoyl, N2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl.

The group represented by Q2 may have a substituent selected from the groups described above as examples of the substituent on the 5- to 7-membered unsaturated ring of Q1. When the group represented by Q2 has two or more substituents, the substituents may be the same as each other or different from each other.

The group represented by Q1 preferably has a 5- or 6-membered unsaturated ring, and more preferably has a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isoxazole ring, or a condensed ring in which any of the above rings is fused with a benzene ring or an unsaturated heterocycle. Q2 represents preferably a carbamoyl group, particularly preferably a carbamoyl group having a hydrogen atom on the nitrogen atom.

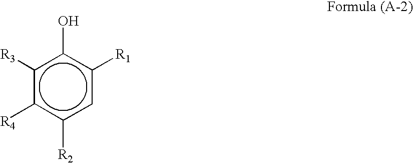

In the formula (A-2), R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonic acid ester group. R₃ and R₄ each independently represent a substituent which can be bonded to the benzene ring, which may be selected from the substituents described above in the explanation on the formula (A-1). R₃ and R₄ may combine to form a condensed ring.

R₁ represents preferably: an alkyl group having 1 to 20 carbon atoms such as a methyl group, an ethyl group, an isopropyl group, a butyl group, a tert-octyl group, or a cyclohexyl group; an acylamino group such as an acetylamino group, a benzoylamino group, a methylureido group, or a 4-cyanophenylureido group; or a carbamoyl group such as an n-butylcarbamoyl group, an N,N-diethylcarbamoyl group, a phenylcarbamoyl group, a 2-chlorophenylcarbamoyl group, or a 2,4-dichlorophenylcarbamoyl group. R₁ represents more preferably an acylamino group, which may be a ureido group or a urethane group. R₂ represents preferably: a halogen atom (more preferably a chlorine atom or a bromine atom); an alkoxy group such as a methoxy group, a butoxy group, an n-hexyloxy group, an n-decyloxy group, a cyclohexyloxy group, or a benzyloxy group; or an aryloxy group such as a phenoxy group or a naphthoxy group.

R₃ represents preferably a hydrogen atom, a halogen atom, or an alkyl group having 1 to 20 carbon atoms, most preferably a halogen atom. R₄ represents preferably a hydrogen atom, an alkyl group, or an acylamino group, more preferably an alkyl group or an acylamino group. Preferred examples of the group represented by R₃ or R₄ are equal to the above-described examples of the group represented by R₁. When R₄ represents an acylamino group, R₄ and R₃ may be bound to each other to form a carbostyryl ring.

When R₃ and R₄ combine with each other to form a condensed ring in the formula (A-2), the condensed ring is particularly preferably a naphthalene ring. The naphthalene ring may have a substituent selected from the above-described examples of the substituents on the ring of Q1 in the formula (A-1). When the compound represented by the formula (A-2) is a naphthol-based compound, R₁ represents preferably a carbamoyl group, particularly preferably a benzoyl group. R₂ represents preferably an alkoxy group or an aryloxy group, particularly preferably an alkoxy group.

Preferable examples of the development accelerator are illustrated below without intention of restricting the scope of the present invention. 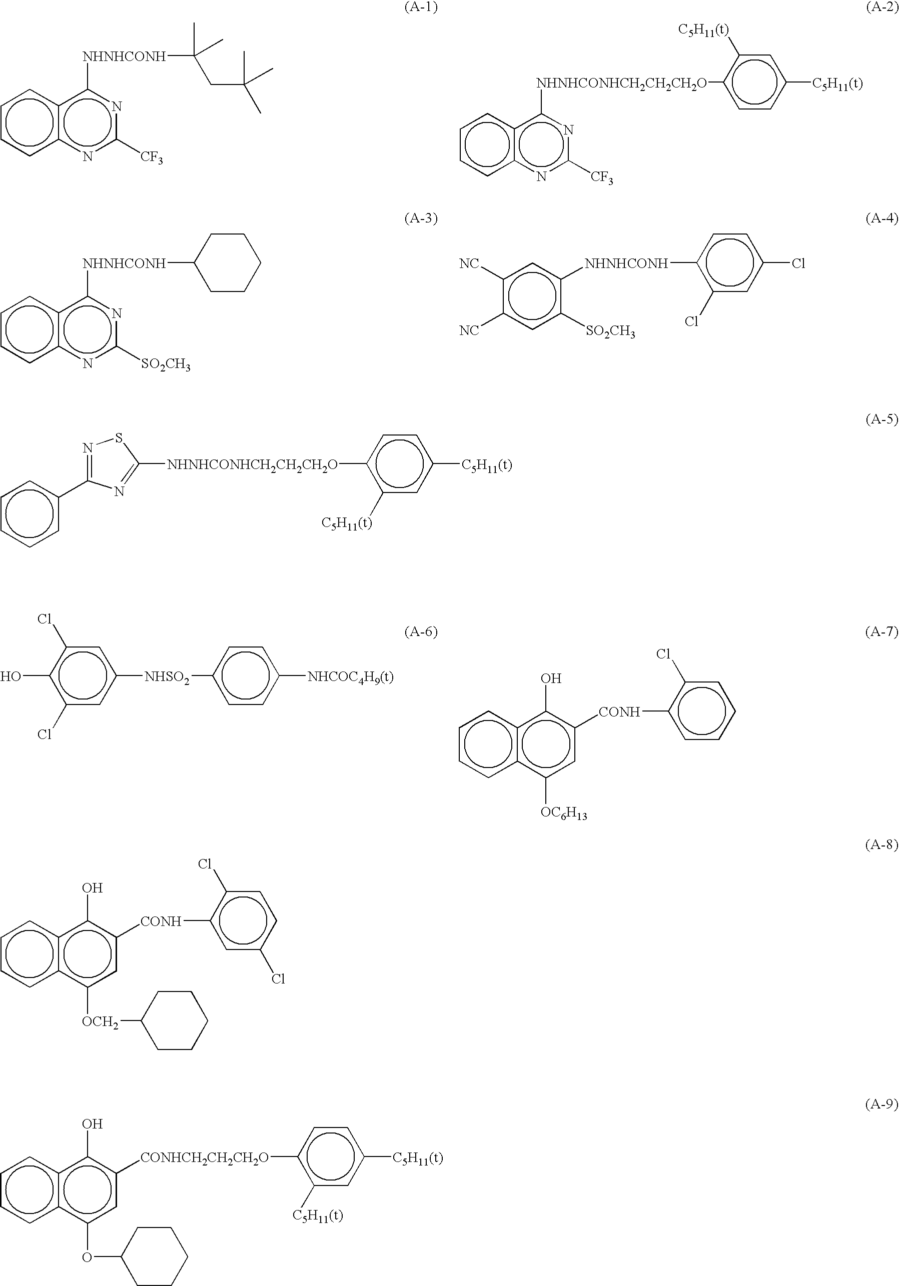 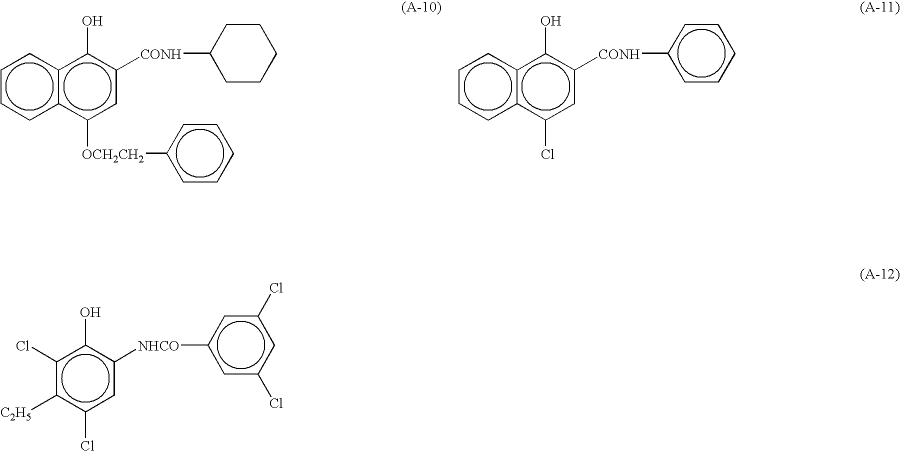
(Hydrogen-Bonding Compound)

When the reducing agent has an aromatic hydroxyl group (—OH) or amino group (—NHR, in which R represents a hydrogen atom or an alkyl group), particularly when the reducing agent is the above-m entioned bisphenol compound, it is preferable to use a non-reducing, hydrogen-bonding compound having a group capable of forming a hydrogen bond with the hydroxyl or amino group.

Examples of the group capable of forming a hydrogen bond with the hydroxyl or amino group include phosphoryl groups, sulfoxide groups, sulfonyl groups, carbonyl groups, amide groups, ester groups, urethane groups, ureido groups, tertiary amino groups, and nitrogen-including aromatic groups. The group capable of forming a hydrogen bond with the hydroxyl or amino group is preferably a phosphoryl group; a sulfoxide group; an amide group having no >N—H groups, but the nitrogen atom being blocked as >N—Ra (in which Ra represents a substituent); an urethane group having no >N—H groups, the nitrogen atom being blocked as >N—Ra (in which Ra represents a substituent); and an ureido group having no >N—H group, but the nitrogen atom being blocked as >N—Ra (in which Ra represents a substituent).

The hydrogen-bonding compound used in the invention is particularly preferably a compound represented by the following formula (D):

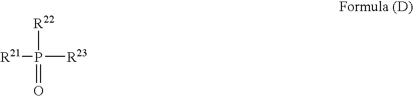

In the formula (D), R²¹ to R²³ each independently represent an alkyl group, an aryl group, an alkoxy group, an aryloxy group, an amino group, or a heterocyclic group. These groups each may be unsubstituted or substituted.

When any of R²¹ to R²³ has a substituent, examples of the substituent include halogen atoms, alkyl groups, aryl groups, alkoxy groups, amino groups, acyl groups, acylamino groups, alkylthio groups, arylthio groups, sulfonamide groups, acyloxy groups, oxycarbonyl groups, carbamoyl groups, sulfamoyl groups, sulfonyl groups, and phosphoryl groups. Preferred substituents are alkyl groups and aryl groups, and specific examples thereof include a methyl group, an ethyl group, an isopropyl group, a tbutyl group, a t-octyl group, a phenyl group, 4-alkoxyphenyl groups, and 4-acyloxyphenyl groups.

When any of R²¹ to R²³ represents an alkyl group, examples thereof include a methyl group, an ethyl group, a butyl group, an octyl group, a dodecyl group, an isopropyl group, a tbutyl group, a t-amyl group, a t-octyl group, a cyclohexyl group, a 1-methylcyclohexyl group, a benzyl group, a phenethyl group, and a 2-phenoxypropyl group.

When any of R²¹ to R²³ represents an aryl group, examples thereof include a phenyl group, a cresyl group, a xylyl group, a naphtyl group, a 4-t-butylphenyl group, a 4-t-octylphenyl group, a 4-anisidyl group, and a 3,5-dichlorophenyl group.

When any of R²¹ to R²³ represents an alkoxy group, examples thereof include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group.

When any of R²¹ to R²³ represents an aryloxy group, examples thereof include a phenoxy group, a cresyloxy group, an isopropylphenoxy group, a 4-t-butylphenoxy group, a naphthoxy group, and a biphenyloxy group.

When any of R²¹ to R²³ represents an amino group, examples thereof include a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

R²¹ to R²³ are each preferably an alkyl group, an aryl group, an alkoxy group, or an aryloxy group. In order to obtain the effects of the invention, in a preferable embodiment, at least one of R²¹ to R²³ represents an alkyl group or an aryl group. In a more preferable embodiment, two or more of R²¹ to R²³ represent groups selected from alkyl groups and aryl groups. Further, it is preferable to use a compound represented by the formula (D) in which R²¹ to R²³ represent the same groups, from the viewpoint of reducing the cost.

Specific examples of the hydrogen-bonding compound (such as a compound represented by the formula (D)) are illustrated below without intention of restricting the scope of the present invention.

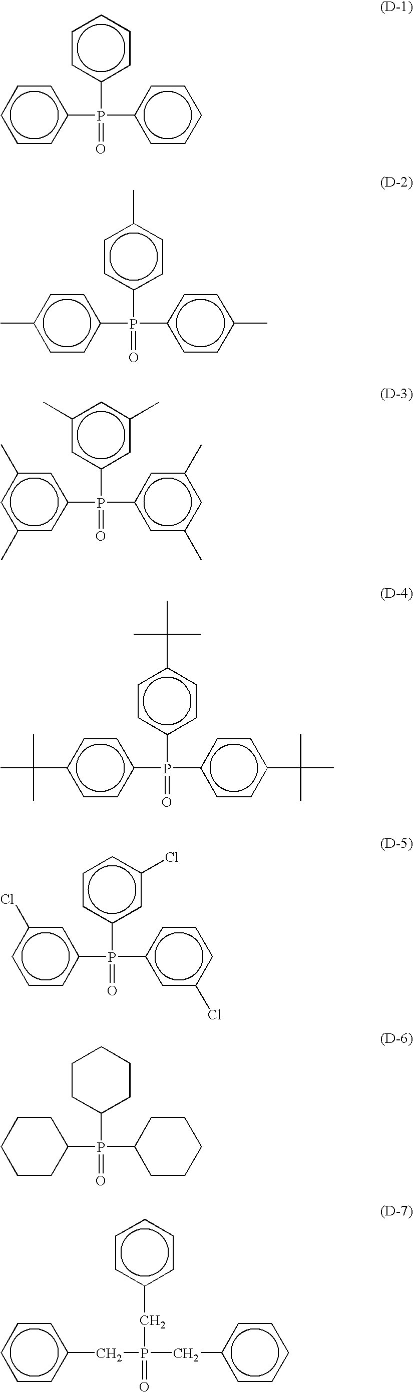

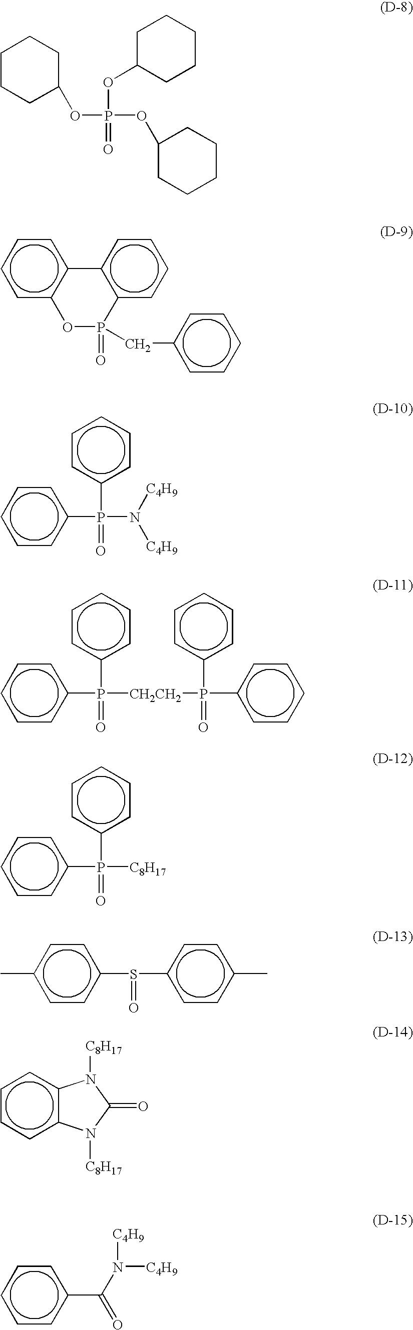

Specific examples of the hydrogen-bonding compound further include compounds disclosed in EP No. 1096310, and JP-A Nos. 2002-156727 and 2002-318431, the disclosures of which are incorporated by reference herein.

The compound of the formula (D) may be added to the coating liquid and used in the photothermographic material in the form of a solution, an emulsion, or a solid particle dispersion. The specific manner of producing the solution, emulsion, or solid particle dispersion may be the same as in the case of the reducing agent. The compound is preferably used in the form of a solid dispersion. The hydrogen-bonding compound forms a hydrogen-bond complex with the reducing agent having a phenolic hydroxyl group or an amino group in the solution. The complex can be isolated as a crystal depending on the combination of the reducing agent and the compound of the formula (D).

It is particularly preferable to use the powder of the isolated crystal to form a solid particle dispersion, from the viewpoint of achieving stable performances. In a preferable embodiment, powder of the reducing agent and powder of the compound of the formula (D) are mixed, and then the mixture is dispersed in the presence of a dispersing agent by a sand grinder mill, etc., thereby forming the complex in the dispersing process.

The mole ratio of the compound represented by the formula (D) to the reducing agent is preferably 1 to 200 mol %, more preferably 10 to 150 mol %, further preferably 20 to 100 mol %.

(Silver Halide)

1) Halogen Composition

The halogen composition of the photosensitive silver halide used in the invention is not particularly restricted, and may be silver chloride, silver chlorobromide, silver bromide, silver iodobromide, silver iodochlorobromide, or silver iodide. Among them, silver bromide, silver iodobromide, and silver iodide are preferable. In a grain of the photosensitive silver halide, the halogen composition may be uniform in the entire grain, or may vary stepwise or steplessly. In an embodiment, the photosensitive silver halide grain has a core-shell structure. The core-shell structure is preferably a 2- to 5-layered structure, more preferably a 2- to 4-layered structure. It is also preferable to employ techniques for localizing silver bromide or silver iodide on the surface of the grain of silver chloride, silver bromide, or silver chlorobromide.

2) Method of Forming a Photosensitive Silver Halide Grain

Methods of forming the photosensitive silver halide grain are well known in the field. For example, the methods described in Research Disclosure, No. 17029, June 1978 (the disclosure of which is incorporated by reference) and U.S. Pat. No. 3,700,458 (the disclosure of which is incorporated by reference) may be used in the invention. In an embodiment, the photosensitive silver halide grains are prepared by: adding a silver source and a halogen source to a solution of gelatin or another polymer to form a photosensitive silver halide; and then mixing the silver halide with an organic silver salt. The method disclosed in the following documents are also preferable: JP-A No. 11-119374, Paragraph 0217 to 0224, and JP-A Nos. 11-352627 and 2000-347335, the disclosure of which are incorporated by reference herein.

3) Grain Size

The grain size of the photosensitive silver halide grain is preferably small so as to suppress the clouding after image formation. Specifically, the grain size is preferably 0.20 μm or smaller, more preferably 0.01 μm to 0.15 μm, further preferably 0.02 μm to 0.12 μm. The grain size of the photosensitive silver halide grain is the average diameter of the circle having the same area as the projected area of the grain; in the case of tabular grain, the projected area refers to the projected area of the principal plane.

4) Shape of Photosensitive Silver Halide Grain

The photosensitive silver halide grain may be a cuboidal grain, an octahedral grain, a tabular grain, a spherical grain, a rod-shaped grain, a potato-like grain, etc. In the invention, the cuboidal grain is preferable. Silver halide grains with roundish corners are also preferable. The face index (Miller index) of the outer surface plane of the photosensitive silver halide grain is not particularly limited. In a preferable embodiment, the silver halide grains have a high proportion of {100} faces; a spectrally sensitizing dye adsorbed to the {100} faces exhibits a higher spectral sensitization efficiency. The proportion of the {100} faces is preferably 50% or higher, more preferably 65% or higher, further preferably 80% or higher. The proportion of the {100} faces according to the Miller indices can be determined by a method described in T. Tani, J. Imaging Sci., 29, 165 (1985) (the disclosure of which is incorporated herein by reference) using adsorption dependency between {111} faces and {100} faces upon adsorption of a sensitizing dye.

5) Heavy Metal

The photosensitive silver halide grain used in the invention may include a metal selected from the metals of Groups 3 to 13 of the Periodic Table of Elements (having Groups 1 to 18) or a complex thereof. When the photosensitive silver halide grain includes a metal selected from the metals of Groups 8 to 10 of the Periodic Table of Elements or a metal complex containing a metal selected from the metals of Groups 8 to 10 as the central metal, the metal or the central metal is preferably rhodium, ruthenium, or iridium. The metal complex may be used singly or in combination with another complex including the same or different metal. The amount of the metal or the metal complex is preferably 1×10⁻⁹ mol to 1×10⁻³ mol per 1 mol of silver. The heavy metals, the metal complexes, and methods of adding them are described, for example, in JP-A No. 7-225449, JP-A No. 11-65021, Paragraph 0018 to 0024, and JP-A No. 11-119374, Paragraph 0227 to 0240, the disclosures of which are incorporated by reference herein.

In the invention, the silver halide grain is preferably a silver halide grain having a hexacyano metal complex on its outer surface. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻; [Ir(CN)₆]³⁻, [Cr(CN)₆]³⁻, and [Re(CN)₆]³⁻. The hexacyano metal complex is preferably a hexacyano Fe complex.

The counter cation of the hexacyano metal complex is not important because the hexacyano metal complex exists as an ion in an aqueous solution. The counter cation is preferably a cation which is highly miscible with water and suitable for precipitating the silver halide emulsion; examples thereof include: alkaline metal ions such as a sodium ion, a potassium ion, a rubidium ion, a cesium ion, and a lithium ion; and ammonium and alkylammonium ions such as a tetramethylammonium ion, a tetraethylammonium ion, a tetrapropylammonium ion, and a tetra-(n-butyl)-ammonium ion.

The hexacyano metal complex may be added in the form of a solution in water, or in a mixed solvent of water and a water-miscible organic solvent (e.g. an alcohol, an ether, a glycol, a ketone, an ester, an amide, etc.), or in a gelatin.

The amount of the hexacyano metal complex to be added is preferably 1×10⁻⁵ mol to 1×10⁻² mol per 1 mol of silver, more preferably 1×10⁻⁴ mol to 1×10⁻³ mol per 1 mol of silver.

In order to allow the hexacyano metal complex to exist on the outer surface of the silver halide grains, the hexacyano metal complex may be directly added to the silver halide grains after the completion of the addition of an aqueous silver nitrate solution for grain formation but before the chemical sensitization (which may be chalcogen sensitization such as sulfur sensitization, selenium sensitization, or tellurium sensitization or may be noble metal sensitization such as gold sensitization). Specifically, the hexacyano metal complex may be directly added to the silver halide grains before the completion of the preparation step, in the water-washing step, in the dispersion step, or before the chemical sensitization step. It is preferable to add the hexacyano metal complex immediately after grain formation but before the completion of the preparation step so as to prevent excess growth of the silver halide grains.

In an embodiment, the addition of the hexacyano metal complex is started after 96% by mass of the total amount of silver nitrate for the grain formation is added. In a preferable embodiment, the addition is started after 98% by mass of the total amount of silver nitrate is added. In a more preferable embodiment, the addition is started after 99% by mass of the total amount of silver nitrate is added.

When the hexacyano metal complex is added after the addition of the aqueous silver nitrate solution but immediately before the completion of the grain formation, the hexacyano metal complex is adsorbed onto the outer surface of the silver halide grain, and most of the adsorbed hexacyano metal complex forms a hardly-soluble salt with silver ion on the surface. The silver salt of hexacyano iron (II) is less soluble than AgI and thus preventing redissolution of the fine grains, whereby the silver halide grains with a smaller grain size can be produced.

The metal atoms and metal complexes such as [Fe(CN)₆]⁴⁻ which may be added to the silver halide grains, and the desalination methods and the chemical sensitization methods for the silver halide emulsion are described in JP-A No. 11-84574, Paragraph 0046 to 0050, JP-A No. 11-65021, Paragraph 0025 to 0031, and JP-A No. 11-119374, Paragraph 0242 to 0250, the disclosures of which are incorporated herein by reference.

6) Gelatin

In the invention, the gelatin contained in the photosensitive silver halide emulsion may be selected from varios gelatins. The gelatin has a molecular weight of preferably 10,000 to 1,000,000 so as to maintain excellent dispersion state of the photosensitive silver halide emulsion in the coating liquid including the organic silver salt. Substituents on the gelatin are preferably phthalated. The gelatin may be added during the grain formation or during the dispersing process after the desalting treatment, and is preferably added during the grain formation.

7) Sensitizing Dye

The sensitizing dye used in the invention is a sensitizing dye which can spectrally sensitize the silver halide grains when adsorbed by the grains, so that the sensitivity of the silver halide is heightened in the desired wavelength range. The sensitizing dye may be selected from sensitizing dyes having spectral sensitivities which are suitable for spectral characteristics of the exposure light source. The sensitizing dyes and methods of adding them are described, for example, in JP-A No. 11-65021, Paragraph 0103 to 0109; JP-A No. 10-186572 (the compounds represented by the formula (II)); JP-A No. 11-119374 (the dyes represented by the formula (1) and Paragraph 0106); U.S. Pat. No. 5,510,236; U.S. Pat. No. 3,871,887 (the dyes described in Example 5); JP-A No. 2-96131; JP-A No. 59-48753 (the dyes disclosed therein); EP-A No. 0803764A1, Page 19, Line 38 to Page 20, Line 35; JP-A Nos. 2001-272747, 2001-290238, and 2002-23306, the disclosures of which are incorporated herein by reference. Only a single sensitizing dye may be used or two or more sensitizing dyes may be uesd. In an embodiment, the sensitizing dye is added to the silver halide emulsion after the desalination but before the coating. In a preferable embodiment, the sensitizing dye is added to the silver halide emulsion after the desalination but before the completion of the chemical ripening.

The amount of the sensitizing dye to be added may be selected in accordance with the sensitivity and the fogging properties, and is preferably 10⁻⁶ mol to 1 mol per 1 mol of the silver halide in the image-forming layer, more preferably 10⁻⁴ mol to 10⁻¹ mol per 1 mol of the silver halide in the image-forming layer.

In the invention, a super-sensitizer may be used in order to increase the spectral sensitization efficiency. Examples of the super-sensitizer include compounds described in EP-A No. 587,338, U.S. Pat. Nos. 3,877,943 and 4,873,184, JP-A Nos. 5-341432, 11-109547, and 10-111543, the disclosures of which are incorporated herein by reference.

8) Chemical Sensitization

In a preferable embodiment, the photosensitive silver halide grains are chemically sensitized by methods selected from the sulfur sensitization method, the selenium sensitization method, and the tellurium sensitization method. Known compounds such as the compounds described in JP-A No. 7-128768 (the disclosure of which is incorporated herein by reference) may be used in the sulfur sensitization method, the selenium sensitization method, and the tellurium sensitization method. In the invention, the tellurium sensitization is preferred, and it is preferable to use a compound or compounds selected from the compounds described in JP-A No. 11-65021, Paragraph 0030 and compounds represented by the formula (II), (III), or (IV) described in JP-A No. 5-313284, the disclosures of which are incorporated by reference herein.

In a preferable embodiment, the photosensitive silver halide grains are chemically sensitized by the gold sensitization method, which may be conducted alone or in combination with the chalcogen sensitization. The gold sensitization method preferably uses a gold sensitizer having a gold atom with the valence of +1 or +3. The gold sensitizer is preferably a common gold compound. Typical examples of the gold sensitizer include chloroauric acid, bromoauric acid, potassium chloroaurate, potassium bromoaurate, auric trichloride, potassium auricthiocyanate, potassium iodoaurate, tetracyanoauric acid, ammonium aurothiocyanate, and pyridyltrichloro gold. Further, the gold sensitizers described in U.S. Pat. No. 5,858,637 and JP-A No. 2002-278016 (the disclosures of which are incorporated herein by reference) are also preferable in the invention.

In the invention, the chemical sensitization may be carried out at any time between grain formation and coating. The chemical sensitization may be carried out after desalination, for example, (1) before spectral sensitization, (2) during spectral sensitization, (3) after spectral sensitization, or (4) immediately before coating.

The amount of the sulfur, selenium, or tellurium sensitizer may be changed in accordance with the kind of the silver halide grains, the chemical ripening condition, and the like, and is generally 10⁻⁸ mol to 10⁻² mol per 1 mol of the silver halide, preferably 10⁻⁷ mol to 10⁻³ mol per 1 mol of the silver halide.

The amount of the gold sensitizer to be added may be selected in accordance with the conditions, and is preferably 10⁻⁷ mol to 10⁻³ mol per 1 mol of the silver halide, more preferably 10⁻⁶ mol to 5×10⁻⁴ mol per 1 mol of the silver halide.

The conditions for the chemical sensitization are not particularly restricted and are generally conditions in which pH is 5 to 8, pAg is 6 to 11, and temperature is 40 to 95° C.

A thiosulfonic acid compound may be added to the silver halide emulsion by a method described in EP-A No. 293,917, the disclosure of which is incorporated by reference herein.

In the invention, the photosensitive silver halide grains may be subjected to reduction sensitization using a reduction sensitizer. The reduction sensitizer is preferably selected from ascorbic acid, aminoiminomethanesulfinic acid, stannous chloride, hydrazine derivatives, borane compounds, silane compounds, and polyamine compounds. The reduction sensitizer may be added at any time between crystal growth and coating in the preparation of the photosensitive emulsion. It is also preferable to ripen the emulsion while maintaining the pH value of the emulsion at 7 or higher and/or maintaining the pAg value at 8.3 or lower, so as to reduction sensitize the photosensitive emulsion. Further, it is also preferable to conduct reduction sensitization by introducing a single addition part of a silver ion during grain formation.

9) Compound Whose One-Electron Oxidized Form Formed by One-Electron Oxidation Can Release One or More Electron(s)

The photothermographic material of the invention preferably comprises a compound whose one-electron oxidized form formed by one-electron oxidation can release one or more electron(s). The compound may be used alone or in combination with the above-mentioned chemical sensitizers, thereby heightening the sensitivity of the silver halide.

The compound whose one-electron oxidized form formed by one-electron oxidation can release one or more electron(s) is the following compound of Type 1 or 2.
(Type 1) a compound whose one-electron oxidized form formed by one-electron oxidation can release one or more electron(s) through a subsequent bond cleavage reaction.
(Type 2) a compound whose one-electron oxidized form formed by one-electron oxidation can release one or more electron(s) through a subsequent bond formation.

The compound of Type 1 is described first.

Specific examples of the compound of Type 1 include compounds described as a one-photon two-electron sensitizer or a deprotonating electron donating sensitizer in JP-A No. 9-211769 (Compounds PMT-1 to S-37 described in Tables E and F in Pages 28 to 32); JP-A No. 9-211774; JP-A No. 11-95355 (Compounds INV 1 to 36); Japanese Patent Application National Publication Laid-Open No. 2001-500996 (Compounds 1 to 74, 80 to 87, and 92 to 122); U.S. Pat. Nos. 5,747,235, and 5,747,236; EP No. 786692A1 (Compounds INV 1 to 35); EP No. 893732A1; U.S. Pat. Nos. 6,054,260, and 5,994,051; the disclosures of which are incorporated by reference herein. Preferred embodiments of the compounds are also described in the patent documents.

Further, examples of the compounds of Type 1 include compounds represented by the following formula (1) (equivalent to the formula (1) described in JP-A No. 2003-114487); compounds represented by the following formula (2) (equivalent to the formula (2) described in JP-A No. 2003-114487); compounds represented by the following formula (3) (equivalent to the formula (1) described in JP-A No. 2003-114488); compounds represented by the following formula (4) (equivalent to the formula (2) described in JP-A No. 2003-114488); compounds represented by the following formula (5) (equivalent to the formula (3) described in JP-A No. 2003-114488); compounds represented by the following formula (6) (equivalent to the formula (1) described in JP-A No. 2003-75950); compounds represented by the following formula (7) (equivalent to the formula (2) described in JP-A No. 2003-75950); compounds represented by the following formula (8) (equivalent to the formula (1) described in JP-A No. 2004-239943); and compounds represented by the following formula (9) (equivalent to the formula (3) described in JP-A No. 2004-245929) which can undergo a reaction represented by the following chemical reaction formula (1) (equivalent to the chemical reaction formula (1) described in JP-A No. 2004-245929). The disclosures of the above patent documents are incorporated by reference herein. Preferred embodiments of the compounds are described in the patent documents.

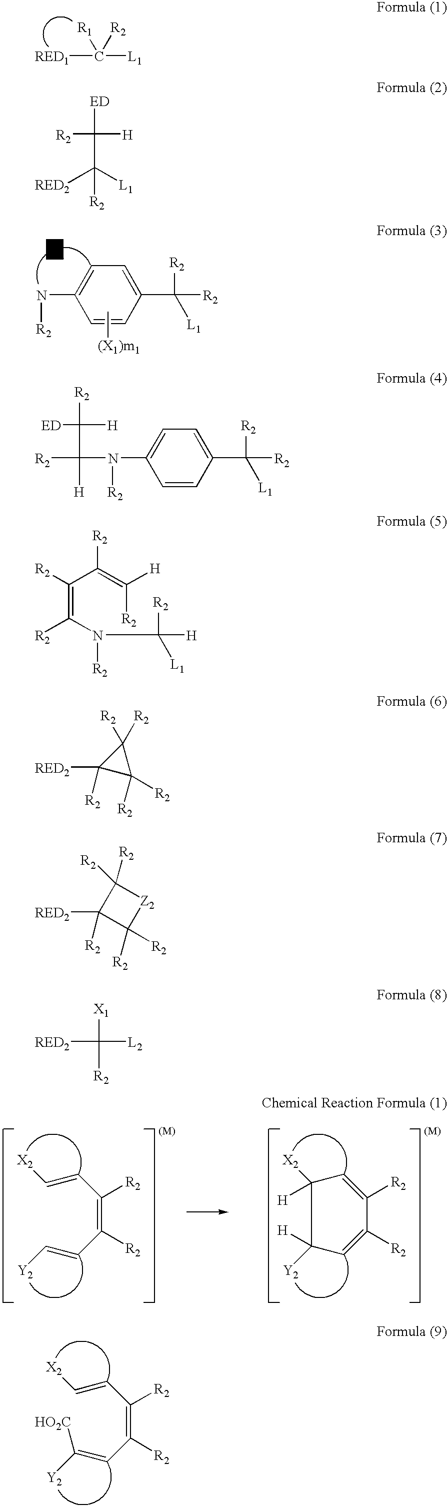

In the formulae, RED₁ and RED₂ each represent a reducing group. R₁ represents a nonmetallic atomic group which, together with the carbon atom C and RED₁, forms a ring structure corresponding to a tetrahydro- or octahydro-derivative of a 5- or 6-membered aromatic ring (or aromatic heterocycle). R₂ represents a hydrogen atom or a substituent. When one compound has a plurality of R₂'s, they may be the same as each other or different from each other. L₁ represents a leaving group. ED represents an electron-donating group. Z₁ represents an atomic group which, together with the nitrogen atom and two carbon atoms in the benzene ring, can form a 6-membered ring. X₁ represents a substituent, and m₁ represents an integer of 0 to 3. Z₂ represents —CR₁₁R₁₂—, —NR₁₃—, or —O—. R₁₁ and R₁₂ each independently represent a hydrogen atom or a substituent. R₁₃ represents a hydrogen atom, an alkyl group, an aryl group, or a heterocyclic group. Specifically, X₁ may represent an alkoxy group, an aryloxy group, a heterocyclyloxy group, an alkylthio group, an arylthio group, a heterocyclylthio group, an alkylamino group, an arylamino group, or a heterocyclylamino group. L₂ represents a carboxyl group or a salt thereof, or a hydrogen atom. X₂ represents a group which, together with the C═C group, forms a 5-membered heterocycle. Y₂ represents a group which, together with the C═C group, forms a 5- or 6-membered, aryl or heterocyclic group. M represents a radical, a radical cation, or a cation.

The compound of Type 2 is described next.

Examples of the compounds of Type 2 include compounds represented by the following formula (10) (equivalent to the formula (1) described in JP-A No. 2003-140287), and compounds represented by the following formula (11) (equivalent to the formula (2) described in JP-A No. 2004-245929) which can undergo a reaction represented by the following chemical reaction formula (1) (equivalent to the chemical reaction formula (1) described in JP-A No. 2004-245929). Preferred embodiments of the compounds are described in the patent documents.

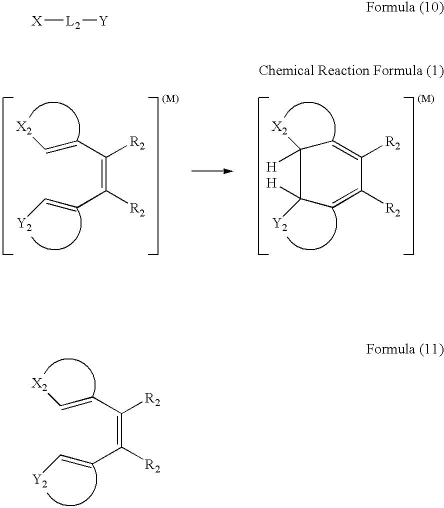

In the formulae, X represents a reducing group that can be one-electron-oxidized. Y represents a reactive group which includes a carbon-carbon double bond, a carbon-carbon triple bond, an aromatic group, or a benzo-condensed, nonaromatic heterocyclic group, and which can react with the one-electron-oxidized group derived from X to form a bond. L₂ represents a linking group that connects X and Y R₂ represents a hydrogen atom or a substituent. When a compound has a plurality of R₂'s, they may be the same as each other or different from each other. X₂ represents a group which, together with the C═C group, forms a 5-membered heterocycle. Y₂ represents a group which, together with the C═C group, forms a 5- or 6-membered, aryl or heterocyclic group. M represents a radical, a radical cation, or a cation.

The compound of Type 1 or 2 preferably has a group which can adsorb silver halide, or a spectrally sensitizing dye moiety. Typical examples of the group which can adsorb silver halide include groups described in JP-A No. 2003-156823, Page 16, Right column, Line 1 to Page 17, Right column, Line 12, disclosure of which is incorporated by reference herein. The spectrally sensitizing dye moiety has a structure described in JP-A No. 2003-156823, Page 17, Right column, Line 34 to Page 18, Left column, Line 6, disclosure of which is incorporated by reference herein.

The compound of Type 1 or 2 is more preferably a compound having a group which can adsorb silver halide, and furthermore preferably has a compound having two or more groups which can adsorb silver halide. When the compound has two or more groups which can adsorb silver halide, the groups may be the same as each other or different from each other.

Preferable examples of the group which can adsorb silver halide include mercapto-substituted, nitrogen-including, heterocyclic groups (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group, a 1,5-dimethyl-1,2,4-triazolium-3-thiolate group, etc.), and nitrogen-including heterocyclic groups each having an —NH— group capable of forming a silver imide (>NAg) as a moiety of the heterocycle (e.g., a benzotriazole group, a benzimidazole group, an indazole group, etc.) Particularly preferred among them are a 5-mercaptotetrazole group, a 3-mercapto-1,2,4-triazole group, and a benzotriazole group, and most preferred are a 3-mercapto-1,2,4-triazole group and a 5-mercaptotetrazole group.

In a preferable embodiment, the compound of Type 1 or 2 is a compound having a group which can adsorb silver halide, the group having two or more mercapto groups. Each mercapto group (—SH) may be converted to a thione group when it can be tautomerized. The group which can adsorb silver halide and has two or more mercapto groups may be a dimercapto-substituted, nitrogen-including, heterocyclic group, etc., and preferred examples thereof include a 2,4-dimercaptopyrimidine group, a 2,4-dimercaptotriazine group, and a 3,5-dimercapto-1,2,4-triazole group.

The group which can adsorb silver may be a quaternary salt group of nitrogen or phosphorus. Specifically, the quaternary nitrogen salt group may comprise: an ammonio group such as a trialkylammonio group, a dialkylaryl (or heteroaryl)-ammonio group or an alkyl-diaryl (or diheteroaryl)ammonio group; or a heterocyclic group containing a quaternary nitrogen. The quaternary phosphorus salt group may comprise a phosphonio group such as a trialkylphosphonio group, a dialkylaryl (or heteroaryl)-phosphonio group, an alkyl-diaryl (or diheteroaryl)-phosphonio group, or a triaryl (or triheteroaryl)-phosphonio group. The quaternary salt group is more preferably a quaternary nitrogen salt group, further preferably an aromatic, quaternary-nitrogen-containing, heterocyclic group having a 5- or 6-membered ring structure, particularly preferably a pyridinio group, a quinolinio group, or a isoquinolinio group. The quaternary-nitrogen-containing heterocyclic groups may have a substituent.

Examples of the counter anion of the quaternary salt group include halogen ions, a carboxylate ion, a sulfonate ion, a sulfate ion, a perchlorate ion, a carbonate ion, a nitrate ion, BF₄⁻, PF₆⁻, and Ph₄B⁻. When the compound has a group with a negative charge such as a carboxylate group, the quaternary salt may be formed within the molecule. Examples of preferred counter anions other than the internal anions include a chlorine ion, a bromine ion, and a methanesulfonate ion.

When the compound of Type 1 or 2 has a quaternary nitrogen or phosphorus salt group as the group which can adsorb silver halide, the compound is preferably a compound represented by the following formula (X):
(P-Q1-)ᵢ-R(-Q2-S)ⱼ. Formula (X)

In the formula (X), P and R each independently represent a quaternary nitrogen or phosphorus salt group which is not the sensitizing dye moiety. Q1 and Q2 each independently represent a linking group which may be selected from a single bond, an alkylene group, an arylene group, a heterocyclic group, —O—, —S—, —NR_{N}—, (═O)—, —SO₂—, —SO—, —P(═O)—, or a combination thereof. R_{N} represents a hydrogen atom, an alkyl group, an aryl group, or a heterocyclic group. S represents a residue obtained by removing an atom from a compound of Type 1 or 2. i and j each independently represent an integer of 1 or larger, the sum of i and j being 2 to 6. In an embodiment, i represents 1 to 3 and j represents 1 to 2. In a preferable embodiment, i represents 1 or 2 and j represents 1. In a more preferable embodiment, i represents 1 and j represents 1. The compound represented by the formula (X) preferably has 10 to 100 carbon atoms. The carbon number of the compound is more preferably 10 to 70, further preferably 11 to 60, particularly preferably 12 to 50.

The compound of Type 1 or 2 may be added at any time in the preparation of the photothermographic material, for example, in the preparation of the photosensitive silver halide emulsion. For example, the compound may be added during the formation of the photosensitive silver halide grains, during the desalination, during the chemical sensitization, or before coating. The compound may be added two or more times. The compound may be added, preferably after the completion of the photosensitive silver halide grain formation but before desalination; or during the chemical sensitization (just before the chemical sensitization to immediately after the chemical sensitization); or before coating. The compound may be added, more preferably during the period from the chemical sensitization to just before the mixing of the silver halide with the non-photosensitive organic silver salt.

The compound of Type 1 or 2 may be added preferably after dissolved in water, a water-soluble solvent such as methanol or ethanol, or a mixed solvent thereof. When the compound whose solubitity in water varies depending on pH is dissolved in water, the pH value of the solution may be appropriately adjusted so as to dissolve the compound well, before added to the silver halide.

It is preferable to incorporate the compound of Type 1 or 2 into the image-forming layer comprising the photosensitive silver halide and the non-photosensitive organic silver salt. It is also preferable to incorporate the compound of Type 1 or 2 into a protective layer, an intermediate layer, etc. as well as the image-forming layer, so that the compound diffuses during the coating. The compound may be added after or before or simultaneously with the addition of the sensitizing dye. In the silver halide emulsion layer (the image-forming layer), the amount of the compound is preferably 1×10⁻⁹ mol to 5×10⁻¹ mol per 1 mol of the silver halide, more preferably 1×10⁻⁸ mol to 5×10⁻² mol, per 1 mol of the silver halide.

10) Adsorbent Redox Compound Having Adsorbent Group and Reducing Group

The photothermographic material of the invention preferably includes an adsorbent redox compound having a reducing group and an adsorbent group which can adsorb silver halide. The adsorbent redox compound is preferably a compound represented by the following formula (I):
A-(W)ₙ-B. Formula (I)

In the formula (I), A represents a group which can adsorb silver halide (hereinafter referred to as an adsorbent group), W represents a divalent linking group, n represents 0 or 1, B represents a reducing group.

In the formula (I), the adsorbent group represented by A is a group which can directly adsorb silver halide, or a group which fascilitates the adsorption of silver halide. Specifically, the adsorbent groups may be a mercapto group or a salt thereof; a thione group comprising —C(═S)— a heterocyclic group including at least one atom selected from the group consisting of nitrogen atoms, sulfur atoms, selenium atoms, and tellurium atoms; a sulfide group; a disulfide group; a cationic group; or an ethynyl group.

The mercapto groups (or a salt thereof) used as the adsorbent group may be a mercapto group itself (or a salt thereof), and is more preferably a heterocyclic group, an aryl group, or an alkyl group, each of which has at least one mercapto group (or salt thereof). The heterocyclic group may be a 5- to 7-membered, aromatic or nonaromatic, heterocyclic group having a monocyclic or condensed ring structure, and examples thereof include imidazole ring groups, thiazole ring groups, oxazole ring groups, benzoimidazole ring groups, benzothiazole ring groups, benzoxazole ring groups, triazole ring groups, thiadiazole ring groups, oxadiazole ring groups, tetrazole ring groups, purine ring groups, pyridine ring groups, quinoline ring groups, isoquinoline ring groups, pyrimidine ring groups, and triazine ring groups. The heterocyclic group may include a quaternary nitrogen atom, and in this case, the mercapto group as the substituent may be dissociated to form a meso-ion. When the mercapto group forms a salt, the counter ion thereof may be: a cation of an alkaline metal, an alkaline earth metal, a heavy metal, etc. such as Li⁺, Na⁺, K⁺, Mg²⁺, Ag⁺ and Zn²⁺; an ammonium ion; a heterocyclic group including a quaternary nitrogen atom; or a phosphonium ion.

The mercapto group as the adsorbent group may be tautomerized into a thione group.

The thione group as the adsorbent group may be, for example, a linear or cyclic, thioamide or thioureide or thiourethane or dithiocarbamic acid ester group.

The heterocyclic group including at least one atom selected from the group consisting of nitrogen atoms, sulfur atoms, selenium atoms, and tellurium atoms, used as the adsorbent group, is a nitrogen-containing heterocyclic group having —NH— capable of forming a silver imide (>NAg) as a moiety of the heterocycle, or a heterocyclic group having, as a moiety of the heterocycle, —S—, —Se—, —Te—, or ═N— capable of forming a coordinate bond with a silver ion. Examples of the former include benzotriazole groups, triazole groups, indazole groups, pyrazole groups, tetrazole groups, benzoimidazole groups, imidazole groups, and purine groups. Examples of the latter include thiophene groups, thiazole groups, oxazole groups, benzothiophene groups, benzothiazole groups, benzoxazole groups, thiadiazole groups, oxadiazole groups, triazine groups, selenazole groups, benzoselenazole groups, tellurazole groups, and benzotellurazole groups.

The sulfide group and the disulfide group used as the adsorbent group may be any group having an —S— or —S—S— moiety.

The cationic group used as the adsorbent group is a group including a quaternary nitrogen atom, and may be a group having a nitrogen-including heterocyclic group containing an ammonio group or a quaternary nitrogen atom. Examples of the quaternary-nitrogen-containing heterocyclic group include pyridinio groups, quinolinio groups, isoquinolinio groups, and imidazolio groups.

The ethynyl group used as the adsorbent group is a —C≡CH group, in which the hydrogen atom may be replaced with a substituent.

The above-described adsorbent groups may have any substituents.

Specific examples of the adsorbent group further include those described in JP-A No. 11-95355, Page 4 to 7, the disclosure of which is incorporated herein by reference.

In the formula (1), the adsorbent group represented by A is preferably a mercapto-substituted heterocyclic group (e.g. a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, a 2,4-dimercaptopyrimidine group, a 2,4-dimercaptotriazine group, a 3,5-dimercapto-1,2,4-triazole group, 2,5-dimercapto-1,3-thiazole group, etc.) or a nitrogen-including heterocyclic group having —NH— capable of forming a silver imide (>NAg) in the heterocycle (e.g. a benzotriazole group, a benzimidazole group, an indazole group, etc.), more preferably a 2-mercaptobenzimidazole group or a 3,5-dimercapto-1,2,4-triazole group.

In the formula (I), W represents a divalent linking group. The linking group is not particularly limited as long as the linking group causes no adverse effects on the photographic properties. For example, the divalent linking group may be composed of an atom or atoms selected from carbon atoms, hydrogen atoms, oxygen atoms, nitrogen atoms, and sulfur atoms. Specific examples of the divalent linking group include: alkylene groups each having 1 to 20 carbon atoms such as a methylene group, an ethylene group, a trimethylene group, a tetramethylene group, and a hexamethylene group; alkenylene groups each having 2 to 20 carbon atoms; alkynylene groups each having 2 to 20 carbon atoms; arylene groups each having 6 to 20 carbon atoms such as a phenylene group and a naphthylene group; —CO—, —SO₂—; —O-1-S—; —NR1-; and combinations thereof. R1 represents a hydrogen atom, an alkyl group, a heterocyclic group, or an aryl group.

The linking group represented by W may have any substituent(s).

In the formula (I), the reducing group represented by B is a group capable of reducing a silver ion, and examples thereof include a formyl group, an amino group, triple bond groups such as an acetylene group and a propargyl group, a mercapto group, and residues obtained by removing one hydrogen atom from each of the following compounds: hydroxylamine compounds, hydroxamic acid compounds, hydroxyurea compounds, hydroxyurethane compounds, hydroxysemicarbazide compounds, reductone compounds (including reductone derivatives), aniline compounds, phenol compounds (including chroman-6-ol compounds, 2,3-dihydrobenzofuran-5-ol compounds, aminophenol compounds, sulfonamidephenol compounds, and polyphenol compounds such as hydroquinone compounds, catechol compounds, resorcinol compounds, benzenetriol compounds, and bisphenol compounds), acylhydrazine compounds, carbamoylhydrazine compounds, and 3-pyrazolidone compounds. The above reducing groups may have any substituent(s).

The oxidation potential of the reducing group represented by B in the formula (I) can be measured by a method described in Akira Fujishima, Denki Kagaku Sokutei-ho, Page 150-208, Gihodo Shuppan Co., Ltd., or The Chemical Society of Japan, Jikken Kagaku Koza, 4th edition, Vol. 9, Page 282-344, Maruzen, the disclosures of which are incorporated by reference herein. For example, the oxidation potential may be determined by a rotating disk voltammetry technique; specifically, in the technique, a sample is dissolved in a 10/90 (volume %) solvent of methanol/pH 6.5 Britton-Robinson buffer, and then the solution is subjected to bubbling with nitrogen gas for 10 minutes, and then the electric potential of the solution is measured at 25° C. at 1,000 round/minute at the sweep rate of 20 mV/second using a glassy carbon rotating disk electrode (RDE) as a working electrode, a platinum wire as a counter electrode, and a saturated calomel electrode as a reference electrode, thereby obtaining a voltammogram. The half wave potential (E½) can be obtained from the voltammogram.

The reducing group represented by B has an oxidation potential of preferably about −0.3 to about 1.0 V when measured by the above method. The oxidation potential is more preferably about −0.1 to about 0.8 V, particularly preferably about 0 to about 0.7 V.

The reducing group represented by B is preferably a residue provided by removing one hydrogen atom from a hydroxylamine compound, a hydroxamic acid compound, a hydroxyurea compound, a hydroxysemicarbazide compound, a reductone compound, a phenol compound, an acylhydrazine compound, a carbamoylhydrazine compound, or a 3-pyrazolidone compound.

The compound of the formula (I) may have a ballast group or a polymer chain each of which is commonly used in an immobile photographic additive such as a coupler. The polymer chain may be selected from the polymer chains described in JP-A No. 1-100530, the disclosure of which is incorporated by reference herein.

The compound of the formula (I) may be in the form of a dimer or a trimer. The molecular weight of the compound of the formula (I) is preferably 100 to 10,000, more preferably 120 to 1,000, particularly preferably 150 to 500.

Examples of the compound represented by the formula (I) are illustrated below without intention of restricting the scope of the invention.

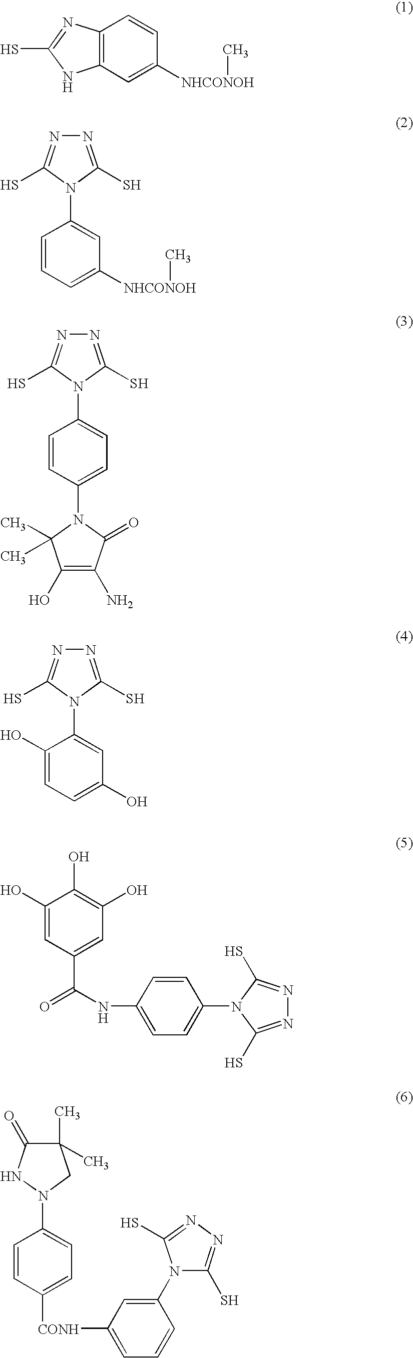

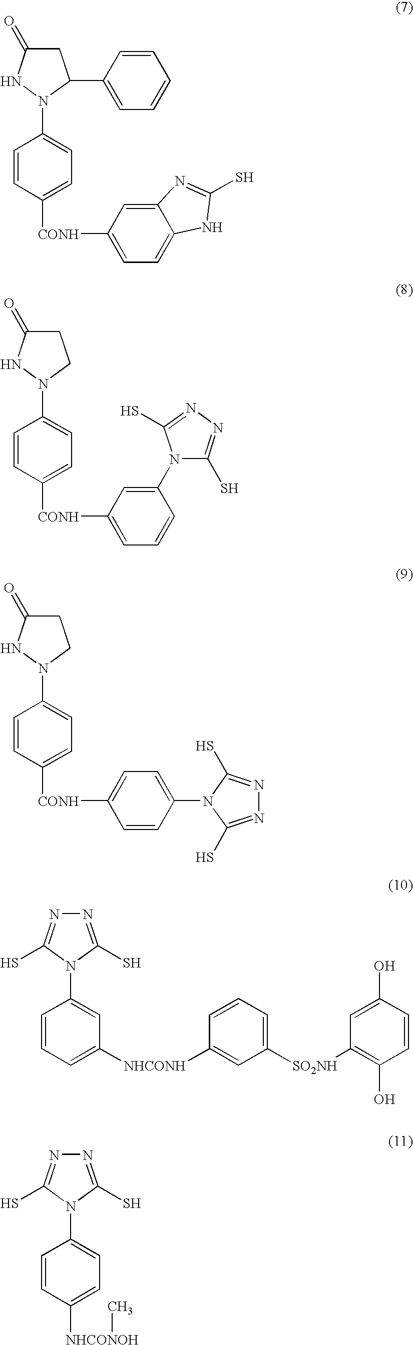

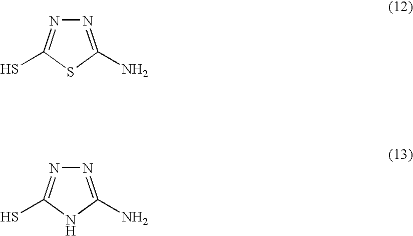

Further, Compounds 1 to 30 and 1″-1 to 1″-77 described in EP No. 1308776A2, Page 73 to 87 (the disclosure of which is incorporated herein by reference) may be preferably used as the compound having the adsorbent group and the reducing group.

These compounds can be easily synthesized by a known method. Only a single kind of a compound of the formula (I) may be used, or two or more kinds of compounds of the formula (I) may be used in combination. When two or more compounds of the formula (I) are used, they may be included in the same layer or in respectively different layers, and may be added by respectively different methods.

The compound of the formula (I) is preferably included in the silver halide emulsion layer. It is preferable to add the compound of the formula (I) during the preparation of the silver halide emulsion. The compound may be added at any time in the preparation of the emulsion. For example, the compound may be added (i) during the silver halide grain formation, (ii) before the desalination, (iii) during the desalination, (iv) before the chemical ripening, (v) during the chemical ripening, (vi) before the finishing. The compound may be added two or more times. The compound may be used preferably in the image-forming layer. In an embodiment, the compound is added to a protective layer, an intermediate layer, etc. as well as the image-forming layer, so that the compound diffuses during coating.

The preferred amount of the compound to be added depends largely on the adding method and the type of the compound. The amount of the compound is generally 1×10⁻⁶ mol to 1 mol per 1 mol of the photosensitive silver halide, preferably 1×10⁻⁵ mol to 5×10⁻¹ per 1 mol of the photosensitive silver halide, more preferably 1×10⁻⁴ mol to 1×10⁻¹ mol per 1 mol of the photosensitive silver halide.

The compound of the formula (I) may be added in the form of a solution in water, a water-soluble solvent such as methanol or ethanol, or a mixed solvent thereof. The pH value of the solution may be appropriately adjusted by an acid or a base. A surfactant may be added to the solution. Further, the compound may be added in the form of an emulsion in an organic high boiling point solvent, or in the form of a solid dispersion.

11) Combination of Silver Halides

In an embodiment, only one kind of photosensitive silver halide emulsion is used in the photothermographic material of the invention. In another embodiment, two or more kinds of photosensitive silver halide emulsions are used in the photothermographic material; the photosensitive silver halide emulsions may be different from each other in characteristics such as average grain size, halogen composition, crystal habit, and chemical sensitization condition. The image gradation can be adjusted by using two or more kinds of photosensitive silver halide emulsions having different sensitivities. The related techniques are described, for example in JP-A Nos. 57-119341, 53-106125, 47-3929, 48-55730, 46-5187, 50-73627, and 57-150841, the disclosure of which are incorporated herein by reference. The difference in sensitivity between the emulsions is preferably 0.2 logE or larger.

12) Application Amount

The amount of the photosensitive silver halide to be applied is, in terms of the applied silver amount per 1 m² of photothermographic material, preferably 0.03 to 0.6 g/m², more preferably 0.05 to 0.4 g/m², still more preferably 0.07 to 0.3 g/m². Further, the amount of the photosensitive silver halide per 1 mol of the organic silver salt is preferably 0.01 to 0.5 mol, more preferably 0.02 to 0.3 mol, further preferably 0.03 to 0.2 mol.

13) Mixing of Photosensitive Silver Halide and Organic Silver Salt

The methods and conditions of mixing the photosensitive silver halide and the organic silver salt, which are separately prepared, are not particularly restricted as long as the advantageous effects of the invention can be sufficiently obtained. In an embodiment, the silver halide and the organic silver salt are separately prepared and then mixed by a high-speed stirrer, a ball mill, a sand mill, a colloid mill, a vibrating mill, a homogenizer, etc. In another embodiment, the prepared photosensitive silver halide is added to the organic silver salt during the preparation of the organic silver salt, and the preparation of the organic silver salt is then completed. It is preferable to mix two or more aqueous organic silver salt dispersion liquids and two or more aqueous photosensitive silver salt dispersion liquids so as to adjust the photographic properties.

14) Addition of Silver Halide to Coating Liquid

The silver halide is added to the coating liquid for the image-forming layer preferably between 180 minutes before coating and immediately before coating, more preferably between 60 minutes before coating and 10 seconds before coating. There are no particular restrictions on the methods and conditions of the coating as long as the advantageous effects of the invention can be sufficiently obtained. In an embodiment, the silver halide is mixed with the coating liquid in a tank while controlling the addition flow rate and the feeding amount to the coater, such that the average retention time calculated from the addition flow rate and the feeding amount to the coater is the desired time. In another embodiment, the silver halide is mixed with the coating liquid by a method using a static mixer described, for example, in N. Harnby, M. F. Edwards, and A. W. Nienow, translated by Koji Takahashi, Ekitai Kongo Gijutsu, Chapter 8 (Nikkan Kogyo Shimbun, Ltd., 1989), the disclosure of which is incorporated herein by reference.

(Thermal Solvent)

The photothermographic material of the invention may include a thermal solvent. In the invention, the term “thermal solvent” refers to such a substance that the heat development temperature of the photothermographic material including the substance can be lowered by 1° C. or more, preferably by 2° C. or more, particularly preferably by 3° C. or more, compared with the photothermographic material not including the substance. For example, provided that there are a photothermographic material A and a photothermographic material B which are the same except that the photothermographic A includes a substance but the photothermographic material B does not include the substance, and the photothermographic material A, when subjected to exposure and to thermal development at 119° C. or lower for 20 seconds, gives the same density as the density obtained by subjecting the photothermographic B to the same exposure and to thermal development at 120° C. for 20 seconds, the substance is considered to be a thermal solvent.

Although the thermal solvent can increase the development rate to improve the apparent sensitivity, such a photothermographic material including the thermal solvent is easily affected by the outside environment such as the storage condition. However, the photothermographic material of the invention having the particular layer structure is less easily affected by the outside environment than conventional photothermographic materials which include thermal solvent.

The thermal solvent used in the invention has a polar group as a substituent. The thermal solvent is preferably a compound represented by the following formula (1), but not limited to the compound.
(Y)ₙZ Formula (1)

In the formula (1), Y represents an alkyl group, an alkenyl group, an alkynyl group, an aryl group, or a heterocyclic group. Z represents a hydroxy group, a carboxy group, an amino group, an amide group, a sulfonamide group, a phosphoric amide group, a cyano group, an imide group, an ureido group, a sulfoxide group, a sulfone group, a phosphine group, a phosphine oxide group, or a nitrogen-including heterocyclic group. n represents an integer of 1 to 3. n represents 1 when Z is a monovalent group, and n represents a number which is the same as the valence of Z when Z is di- or more valent group. When n represents an integer of 2 or larger, a plurality of Y's may be the same as each other or different from each other. Y may have a substituent which may be a group selected from the groups described as examples of the group Z.

Y in the formula (1) is described in more detail below. When Y represents an alkyl group, the alkyl group may be a linear, branched, or cyclic alkyl group. The alkyl group preferably has 1 to 40 carbon atoms, more preferably has 1 to 30 carbon atoms, and particularly preferably has 1 to 25 carbon atoms. Examples of the alkyl roup include a methyl group, an ethyl group, an n-propyl group, an iso-propyl group, a sec-butyl group, a t-butyl group, a t-octyl group, an n-amyl group, a t-amyl group, an n-dodecyl group, an n-tridecyl group, an octadecyl group, an eicosyl group, a docosyl group, a cyclopentyl group, and a cyclohexyl group. When Y represents an alkenyl group, the alkenyl group preferably has 2 to 40 carbon atoms, more preferably has 2 to 30 carbon atoms, and particularly preferably has 2 to 25 carbon atoms. Examples of the alkenyl group include a vinyl group, an allyl group, a 2-butenyl group, and a 3-pentenyl group. When Y represents an aryl group, the aryl group preferably has 6 to 40 carbon atoms, more preferably has 6 to 30 carbon atoms, and particularly preferably has 6 to 25 carbon atoms. Examples of the aryl group include a phenyl group, a p-methylphenyl group, and a naphtyl group. When Y represents a heterocyclic group, the heterocyclic group preferably has 2 to 20 carbon atoms, more preferably has 2 to 16 carbon atoms, and particularly preferably has 2 to 12 carbon atoms. Examples of the heterocyclic group include a pyridyl group, a pyrazyl group, an imidazoyl group, and a pyrrolidyl group. These groups may further have a substituent, and may be bonded to each other to form a ring.

Y may have a substituent, and examples of the substituent include: halogen atoms such as a fluorine atom, a chlorine atom, a bromine atom, and an iodine atom; alkyl groups each of which may be linear, branched, or cyclic, wherein the scope of the alkyl groups include bicycloalkyl groups and active methine groups; alkenyl groups; alkynyl groups; aryl groups; heterocyclic groups (the position which is bonded to the main structure of Y is not limited); acyl groups; alkoxycarbonyl groups; aryloxycarbonyl groups; heterocyclyloxycarbonyl groups; carbamoyl groups; N-acylcarbamoyl groups; N-sulfonylcarbamoyl groups; N-carbamoylcarbamoyl groups; thiocarbamoyl groups; N-sulfamoylcarbamoyl groups; carbazoyl groups; a carboxy group and salts thereof; oxalyl groups; oxamoyl groups; a cyano group; carbonimidoyl groups; a formyl group; a hydroxy group; alkoxy groups which may include a plurality of ethyleneoxy or propyleneoxy groups as repetition units; aryloxy groups; heterocyclyloxy groups; acyloxy groups; alkoxycarbonyloxy groups; aryloxycarbonyloxy groups; carbamoyloxy groups; sulfonyloxy groups; amino groups; alkylamino groups; arylamino groups; heterocyclylamino groups; acylamino groups; sulfonamide groups; ureido groups; thioureide groups; imide groups; alkoxycarbonylamino groups; aryloxycarbonylamino groups; sulfamoylamino groups; semicarbazide groups; thiosemicarbazide groups; ammonio groups; oxamoylamino groups; N-alkyl-sulfonylureide groups; N-aryl-sulfonylureide groups; N-acylureide groups; N-acylsulfamoylamino groups; a nitro group; heterocyclic groups including quaternary nitrogen atoms, such as a pyridinio group, an imidazolio group, a quinolinio group, and an isoquinolinio group; an isocyano group; imino groups; a mercapto group; alkyl-thio groups; aryl-thio groups; heterocyclyl-thio groups; alkyl-dithio groups; aryl-dithio groups; heterocyclyl-dithio groups; alkylsulfonyl groups; arylsulfonyl groups; alkylsulfinyl groups; arylsulfinyl groups; a sulfo group and salts thereof; sulfamoyl groups; N-acylsulfamoyl groups; N-sulfonylsulfamoyl groups and salts thereof; phosphino groups; phosphinyl groups; phosphinyloxy groups; phosphinylamino groups; and silyl groups. The term “active methine group” refers to a methine group substituted by two electron-withdrawing groups. The electron-withdrawing group is selected from an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, and a carbonimidoyl group. The two electron-withdrawing groups may be bonded to each other to form a ring structure. Cations of the above salts each may be selected from metal cations such as alkaline metal ions, alkaline earth metal ions, and heavy metal ions, and organic cations such as ammonium ions and phosphonium ions. The above substituents may be further substituted by substituents selected from the above substituents. The group represented by Y may have a substituent selected from the groups described, in this specification, as exmples of the group represented by Z.

It is presumed that the thermal solvent is melt around the development temperature and forms an eutectic mixture with the components for the development, whereby the thermal solvent lowers the development temperature to achieve an advantageous effect of the invention. In a preferable embodiment, a thermal solvent having a polar group is used to form a reaction field having an appropriate polarity which is preferable to the reductive heat development reaction using a carboxylic acid, a silver ion carrier, and the like, which have relatively high polarity.

The melting point of the thermal solvent used in the invention is 50 to 200° C., preferably 60 to 150° C. The melting point of the thermal solvent is particularly preferably 100 to 150° C. in the case of making a photothermographic material which is hardly deteriorated by the outer environment and which has high image storability, as in the present invention.

Specific examples of the thermal solvent usable in the invention are described below without intention of restricting the scope of the present invention. The numerals in parentheses represent the melting points of the solvents.

The specific examples of the thermal solvent include N-methyl-N-nitroso-p-toluenesulfonamide (61° C.), 1,8-octanediol (62° C.), phenyl benzoate (67 to 71° C.), hydroquinone diethyl ether (67 to 73° C.), ε-caprolactam (68 to 70° C.), diphenyl phosphate (68 to 70° C.), (±)-2-hydroxyoctanoic acid (68 to 71° C.), (±)-3-hydroxydodecanoic acid (68 to 71° C.), 5-chloro-2-methylbenzothiazole (68 to 71° C.), β-naphtyl acetate (68 to 71° C.), batyl alcohol (68 to 73° C.), (±)-2-hydroxydecanoic acid (69 to 72° C.), 2,2,2-trifluoroacetamide (69 to 72° C.), pyrazole (69° C.), (±)-2-hydroxyundecanoic acid (70 to 73° C.), N,N-diphenylformamide (71 to 72° C.), dibenzyl disulfide (71 to 72° C.), (±)-3-hydroxyundecanoic acid (71 to 74° C.), 2,2′-dihydroxy-4-methoxybenzophenone (71° C.), 2,4-dinitrotoluene (71° C.), 2,4-dimethoxybenzaldehyde (71° C.), 2,6-di-tbutyl-4-methylphenol (71° C.), 2,6-dichlorobenzaldehyde (71° C.), diphenyl sulfoxide (71° C.), stearic acid (71° C.), 2,5-dimethoxy-nitrobenzene (72 to 73° C.), 1,10-decanediol (72 to 74° C.), (R)-(−)-3-hydroxytetradecanoic acid (72 to 75° C.), 2-tetradecylhexadecanoic acid (72 to 75° C.), 2-methoxynaphthalene (72 to 75° C.), methyl 3-hydroxy-2-naphthoate (72 to 76° C.), tristearin (73.5° C.), dotriacontane (74 to 75° C.), flavanone (74 to 78° C.), 2,5-diphenyloxazole (74° C.), 8-quinolinol (74° C.), o-chlorobenzyl alcohol (74° C.), oleic amide (75 to 76° C.), (±)-2-hydroxydodecanoic acid (75 to 78° C.), n-hexatriacontane (75 to 79° C.), iminodiacetonitrile (75 to 79° C.), p-chlorobenzyl alcohol (75° C.), diphenyl phthalate (75° C.), N-methylbenzamide (76 to 78° C.), (±)-2-hydroxytridecanoic acid (76 to 79° C.), 1,3-diphenyl-1,3-propanedione (76 to 79° C.), N-methyl-p-toluenesulfonamide (76 to 79° C.), 3′-nitroacetophenone (76 to 80° C.), 4-phenylcyclohexanone (76 to 80° C.), eicosanoic acid (76° C.), 4-chlorobenzophenone (77 to 78° C.), (±)-3-hydroxytetradecanoic acid (77 to 80° C.), 2-hexadecyloctadecanoic acid (77 to 80° C.), p-nitrophenyl acetate (77 to 80° C.), 4′-nitroacetophenone (77 to 81° C.), 12-hydroxystearic acid (77° C.), α,α′-dibromo-m-xylene (77° C.), 9-methylanthracene (78 to 81° C.), 1,4-cyclohexanedione (78° C.), m-diethylaminophenol (78° C.), methyl m-nitrobenzoate (78° C.), (±)-2-hydroxytetradecanoic acid (79 to 82° C.), 1-phenylsulfonylindole (79° C.), di-p-tolylmethane (79° C.), propioneamide (79° C.), (±)-3-hydroxytridecanoic acid (80 to 83° C.), guaiacol glycerin ether (80 to 85° C.), octanoyl-N-methylglucamide (80 to 90° C.), o-fluoroacetanilide (80° C.), acetoacetanilide (80° C.), docosanoic acid (81 to 82° C.), p-bromobenzophenone (81° C.), triphenylphosphine (81° C.), dibenzofuran (82.8° C.), (±)-2-hydroxypentadecanoic acid (82 to 85° C.), 2-octadecyleicosanoic acid (82 to 85° C.), 1,12-dodecanediol (82° C.), methyl 3,4,5-trimethoxybenzoate (83° C.), p-chloronitrobenzene (83° C.), (±)-3-hydroxyhexadecanoic acid (84 to 85° C.), o-hydroxybenzyl alcohol (84 to 86° C.), 1-triacontanol (84 to 88° C.), o-aminobenzyl alcohol (84° C.), 4-methoxybenzyl acetate (84° C.), (±)-2-hydroxyhexadecanoic acid (85 to 88° C.), m-dimethylaminophenol (85° C.), p-dibromobenzene (86 to 87° C.), methyl 2,5-dihydroxybenzoate (86 to 88° C.), (±)-3-hydroxypentadecanoic acid (86 to 89° C.), 4-benzylbiphenyl (86° C.), p-fluorophenylacetic acid (86° C.), 1,14-tetradecanediol (87 to 89° C.), 2,5-dimethyl-2,5-hexanediol (87 to 90° C.), p-pentylbenzoic acid (87 to 91° C.), α-trichloromethyl)benzyl acetate (88 to 89° C.), 4,4′-dimethylbenzoin (88° C.), diphenyl carbonate (88° C.), m-dinitrobenzene (89.57° C.), (3R,5R)(+)-2,6-dimethyl-3,5-heptanediol (90 to 93° C.), (3S,5S)-(−)-2,6-dimethyl-3,5-heptanediol (90 to 93° C.), cyclohexanone oxime (90° C.), p-bromoiodobenzene (91 to 92° C.), 4,4′-dimethylbenzophenone (92 to 95° C.), triphenylmethane (92 to 95° C.), stearic acid anilide (92 to 96° C.), p-hydroxyphenylethanol (92° C.), monoethylurea (92° C.), acenaphthylene (93.5 to 94.5° C.), m-hydroxyacetophenone (93 to 97° C.), xylitol (93 to 97° C.), p-iodophenol (93° C.), methyl p-nitrobenzoate (94 to 98° C.), p-nitrobenzyl alcohol (94° C.), 1,2,4-triacetoxybenzene (95 to 100° C.), 3-acetylbenzonitrile (95 to 103° C.), ethyl 2-cyano-3,3-diphenylacrylate (95 to 97° C.), 16-hydroxyhexadecanoic acid (95 to 99° C.), D-(−)ribose (95° C.), o-benzoylbenzoic acid (95° C.), α,α′-dibromo-o-xylene (95° C.), benzil (95° C.), iodoacetamide (95° C.), n-propyl p-hydroxybenzoate (96 to 97° C.), n-propyl p-hydroxybenzoate (96 to 97° C.), flavone (96 to 97° C.), 2-deoxy-D-ribose (96 to 98° C.), lauryl galliate (96 to 99° C.), 1-naphthol (96° C.), 2,7-dimethylnaphthalene (96° C.), 2-chlorophenylacetic acid (96° C.), acenaphthene (96° C.), dibenzyl terephthalate (96° C.), fumaronitrile (96° C.), 4′-amino-2′,5′-diethoxybenzanilide (97 to 100° C.), phenoxyacetic acid (97 to 100° C.), 2,5-dimethyl-3-hexyne-2,5-diol (97° C.), D-sorbitol (97° C.), m-aminobenzyl alcohol (97° C.), diethyl acetamidomalonate (97° C.), 1,10-phenanthroline monohydrate (98 to 100° C.), 2-hydroxy-4-methoxy-4′-methylbenzophenone (98 to 100° C.), 2-bromo-4′-chloroacetophenone (98° C.), methylurea (98° C.), 4-phenoxyphthalonitrile (99 to 100° C.), o-methoxybenzoic acid (99 to 100° C.), p-butylbenzoic acid (99 to 100° C.), xanthene (99 to 100° C.), pentafluorobenzoic acid (99 to 101° C.), phenanthrene (99° C.), p-t-butylphenol (100.4° C.), 9-fluorenylmethanol (100 to 101° C.), 1,3-dimethylurea (100 to 102° C.), 4-acetoxyindole (100 to 102° C.), 1,3-cyclohexanedione (100° C.), stearic acid amide (100° C.), tri-m-tolylphosphine (100° C.), 4-biphenylmethanol (101 to 102° C.), 1,4-cyclohexanediol (a mixture of cis and trans isomers) (101° C.), α,α′-dichloro-p-xylene (101° C.), 2-t-butylanthraquinone (102° C.), dimethyl fumarate (102° C.), 3,3-dimethylglutaric acid (103 to 104° C.), 2-hydroxy-3-methyl-2-cyclopentene-1-one (103° C.), 4-chloro-3-nitroaniline (103° C.), N,N-diphenylacetamide (103° C.), 3(2)-t-butyl-4-hydroxyanisole (104 to 105° C.), 4,4′-dimethylbenzil (104 to 105° C.), 2,2-bis(hydroxymethyl)-2,2′,2″-nitrilotriethanol (104° C.), m-trifluoromethylbenzoic acid (104° C.), 3-pentanol (105 to 108° C.), 2-methyl-1,4-naphthoquinone (105° C.), α,α,α′,α′-tetrabromo-m-xylene (105° C.), 4-chlorophenylacetic acid (106° C.), 4,4′-difluorobenzophenone (107.5 to 108.5° C.), 2,4-dichloro-1-naphthol (107 to 108° C.), L-ascorbic palmitate (107 to 117° C.), 2,4-dimethoxybenzoic acid (108 to 109° C.), o-trifluoromethylbenzoic acid (108 to 109° C.), p-hydroxyacetophenone (109° C.), dimethylsulfone (109° C.), 2,6-dimethylnaphthalene (110 to 111° C.), 2,3,5,6-tetramethyl-1,4-benzoquinone (110° C.), tridecanedioic acid (110° C.), triphenylchloromethane (110° C.), fluoranthene (110° C.), lauramide (110° C.), 1,4-benzoquinone (111° C.), 3-benzylindole (111° C.), resorcinol (111° C.), 1-bromobutane (112.3° C.), 2,2-bis(bromomethyl)-1,3-propanediol (112 to 114° C.), p-ethylbenzoic acid (113.5° C.), 1,4-diacetoxy-2-methylnaphthalene (113° C.), 1-ethyl-2,3-piperazinedione (113° C.), 4-methyl-2-nitroaniline (113° C.), L-ascorbic dipalmitate (113° C.), o-phenoxybenzoic acid (113° C.), p-nitrophenol (113° C.), methyldiphenylphosphine oxide (113° C.), cholesterol acetate (114 to 115° C.), 2,6-dimethylbenzoic acid (114 to 116° C.), 3-nitrobenzonitrile (114° C.), m-nitroaniline (114° C.), ethyl α-D-glucoside (114° C.), acetanilide (115 to 116° C.), (±)-2-phenoxypropionic acid (115° C.), 4-chloro-1-naphthol (116 to 117° C.), p-nitrophenylacetonitrile (116 to 117° C.), ethyl p-hydroxybenzoate (116° C.), p-isopropylbenzoic acid (117 to 118° C.), D(+)-galactose (118 to 120° C.), o-dinitrobenzene (118° C.), benzyl p-benzyloxybenzoic acid (118° C.), 1,3,5-bromobenzene (119° C.), 2,3-dimethoxybenzoic acid (120 to 122° C.), 4-chloro-2-methylphenoxyacetic acid (120° C.), meso-erythritol (121.5° C.), 9,10-dimethyl-1,2-benzanthracene (122 to 123° C.), 2-naphthol (122° C.), N-phenylglycine (122° C.), bis(4-hydroxy-3-methylphenyl)sulfide (122° C.), p-hydroxybenzyl alcohol (124.5 to 125.5° C.), 2′,4′-dihydroxy-3′-propylacetophenone (124 to 127° C.), 1,1-bis(4-hydroxyphenyl)ethane (124° C.), m-fluorobenzoic acid (124° C.), diphenylsulfone (124° C.), 2,2-dimethyl-3-hydroxypropionic acid (125° C.), 3,4,5-trimethoxycinnamic acid (125° C.), o-fluorobenzoic acid (126.5° C.), isonitrosoacetophenone (126 to 128° C.), 5-methyl-1,3-cyclohexanedione (126° C.), 4-benzoylbutyric acid (127° C.), methyl p-hydroxybenzoate (127° C.), p-bromonitrobenzene (127° C.), 3,4-dihydroxyphenylacetic acid (128 to 130° C.), 5α-cholestane-3-one (128 to 130° C.), 6-bromo-2-naphthol (128° C.), isobutylamide (128° C.), 1-naphtylacetic acid (129° C.), 2,2-dimethyl-1,3-propanediol (129° C.), p-diiodobenzene (129° C.), dodecanedioic acid (129° C.), 4,4′-dimethoxybenzil (131 to 133° C.), dimethylolurea (132.5° C.), o-ethoxybenzamide (132 to 134° C.), sebacic acid (132° C.), p-toluenesulfonamide (134° C.), salicylanilide (135° C.), β-sitosterol (136 to 137° C.), 1,2,4,5-tetrachlorobenzene (136° C.), 1,3-bis(1-hydroxy-1-methylethyl)benzene (137° C.), phthalonitrile (138° C.), 4-n-propylbenzoic acid (139° C.), 2,4-dichlorophenoxyacetic acid (140.5° C.), 2-naphtylacetic acid (140° C.), methyl terephthalate (140° C.), 2,2-dimethylsuccinic acid (141° C.), 2,6-dichlorobenzonitrile (142.5 to 143.5° C.), o-chlorobenzoic acid (142° C.), 1,2-bis(diphenylphosphino)ethane (143 to 144° C.), α,α,α-tribromomethylphenylsulfone (143° C.), D(+)-xylose (144 to 145° C.), phenylurea (146° C.), n-propyl gallate (146° C.), 4,4′-dichlorobenzophenone (147 to 148° C.), 2′,4′-dihydroxyacetophenone (147° C.), cholesterol (148.5° C.), 2-methyl-1-pentanol (148° C.), 4,4′-dichlorodiphenylsulfone (148° C.), diglycollic acid (148° C.), adipic acid (149 to 150° C.), 2-deoxy-D-glucose (149° C.), diphenylacetic acid (149° C.), and o-bromobenzoic acid (150° C.).

The amount of the thermal solvent to be added is preferably 0.01 to 5.0 g/m², more preferably 0.05 to 2.5 g/m², further preferably 0.1 to 1.5 g/m². When the thermal solvent is added, the thermal solvent is added preferably to the image-forming layer.

Only a single thermal solvent may be used, or two or more thermal solvents may be used in combination.

The thermal solvent may be added to the coating liquid in any form such as a solution, an emulsion, or a solid particle dispersion.

In an exemplary emulsification method, the thermal solvent is dissolved in an oil such as dibutyl phthalate, tricresyl phosphate, glyceryl triacetate, or diethyl phthalate, and/or a cosolvent such as ethyl acetate and cyclohexanone, and then mechanically emulsified.

In an embodiment, the solid particle dispersion is prepared by a method comprising dispersing powder of the thermal solvent in an appropriate solvent such as water using a ball mill, a colloid mill, a vibration ball mill, a sand mill, a jet mill, a roll mill, or ultrasonic wave. A protective colloid (e.g. a polyvinyl alcohol) and/or a surfactant such as an anionic surfactant (e.g. a mixture of sodium triisopropylnaphthalenesulfonates each having a different combination of the substitution positions of the three isopropyl groups) may be used in the preparation. Beads of zirconia, etc. are commonly used as a dispersing medium in the above mills, and in some cases Zr, etc. is eluted from the beads and mixed with the dispersion. The amount of the eluted and mixed component depends on the dispersion conditions, and is generally within the range of 1 to 1,000 ppm. The eluted zirconia does not cause practical problems as long as the amount of Zr in the photothermographic material is 0.5 mg or smaller per 1 g of silver.

In a preferable embodiment, the aqueous dispersion includes an antiseptic agent such as a benzoisothiazolinone sodium salt. The thermal solvent is particularly preferably used in the form of a solid particle dispersion.

(Other Additives)

1) Mercapto Compound, Disulfide Compound, and Thione Compound

Substances selected from mercapto compounds, disulfide compounds, and thione compounds may be used in the photothermographic material of the invention in order to control (inhibit or accelerate) the development, to heighten the spectral sensitization efficiency, or to improve the storability before or after the development, etc. Examples of the compounds are described in JP-A No. 10-62899, Paragraph 0067 to 0069; JP-A No. 10-186572, the compounds represented by the formula (I) and specific examples thereof described in Paragraph 0033 to 0052; EP-A No. 0803764A1, Page 20, Line 36-56; the disclosures of which are incorporated herein by reference. Mercapto-substituted heteroaromatic compounds described, for example, in JP-A Nos. 9-297367, 9-304875, 2001-100358, 2002-303954, and 2002-303951, (the disclosures of which are incorporated herein by reference) are particularly preferred in the invention.

2) Toning Agent

It is preferable to add a toning agent to the photothermographic material of the invention. The toning agent used in the invention is not particularly limited, and may be a toning agent which has been used in a conventional photothermographic material using an organic silver salt. The toning agent may be a so-called precursor, which effectively performs the function only in the development. Examples of the toning agent usable in the invention include the toning agents described in JP-A Nos. 46-6077, 47-10282, 49-5019, 49-5020, 49491215, 50-2524, 50-32927, 50-67132, 50-67641, 50-114217, 51-3223, 51-27923, 52-14788, 5249813, 53-1020, 53-76020, 54-156524, 54-156525, 61-183642, and 4-56848, JP-B Nos. 49-10727 and 54-20333, U.S. Pat. Nos. 3,080,254, 3,446,648, 3,782,941, 4,123,282, and 4,510,236, British Patent No. 1,380,795, and Belgian Patent No. 841,910, the disclosures of which are incorporated by reference herein.

The specific examples of the toning agent include: phthalimides and N-hydroxyphthalimides; cyclic imides such as succinimide, pyrazoline-5-one, quinazolinone, 3-phenyl-2-pyrazoline-5-one, 1-phenylurazole, quinazoline, and 2,4-thiazolidinedione; naphthalimides such as N-hydroxy-1,8-naphthalimide; cobalt complexes such as cobalt hexamine trifluoroacetate; mercaptan compounds such as 3-mercapto-1,2,4-triazole, 2,4-dimercaptopyrimidine, 3-mercapto-4,5-diphenyl-1,2,4-triazole, and 2,5-dimercapto-1,3,4-thiadiazole; N-(aminomethyl)aryldicarboxyimides such as (N,N-dimethylaminomethyl)phthalimide and N,N-(dimethylaminomethyl)-naphthalene-2,3-dicarboxyimide; blocked pyrazoles, isothiouronium derivatives, and certain photobleaching agents, such as N,N′-hexamethylenebis(1-carbamoyl-3,5-dimethylpyrazole), 1,8-(3,6-diazaoctane)bis(isothiouronium trifluoroacetate), and 2-tribromomethylsulfonylbenzothiazole; 3-ethyl-5[(3-ethyl-2-benzothiazolinylidene)-1-methylethylidene]-2-thio-2,4-oxazolidinedione; phthalazinone, phthalazinone derivatives, and metal salts thereof, such as 4-(1-naphtyl)phthalazinone, 6-chlorophthalazinone, 5,7-dimethoxyphthalazinone, and 2,3-dihydro-1,4-phthalazinedione; combinations of phthalazinone with a phthalic acid derivative such as phthalic acid, 4-methylphthalic acid, 4-nitrophthalic acid, or tetrachlorophthalic anhydride; phthalazine, phthalazine derivatives, and metal salts thereof, such as 4-(1-naphtyl)phthalazine, 6-chlorophthalazine, 5,7-dimethoxyphthalazine, 6-isobutylphthalazine, 6-tert-butylphthalazine, 5,7-dimethylphthalazine, and 2,3-dihydrophthalazine; combinations of phthalazine or a derivative thereof with a phthalic acid derivative such as phthalic acid, 4-methylphthalic acid, 4-nitrophthalic acid, or tetrachlorophthalic anhydride; quinazolinediones, benzoxazines, and naphthoxazine derivatives; rhodium complexes, which act not only as the toning agent but also as halide ion sources for generating the silver halide, such as ammonium hexachlororhodinate (III), rhodium bromide, rhodium nitrate, and potassium hexachlororhodinate (III); inorganic peroxides and persulfates, such as ammonium peroxide disulfide and hydrogen peroxide; benzoxazine-2,4-diones such as 1,3-benzoxazine-2,4-dione, 8-methyl-1,3-benzoxazine-2,4-dione, and 6-nitro-1,3-benzoxazine-2,4-dione; pyrimidines and asymmetric triazines, such as 2,4-dihydroxypyrimidine and 2-hydroxy-4-aminopyrimidine; and azauracils and tetraazapentalene derivatives, such as 3,6-dimercapto-1,4-diphenyl-1H,4H-2,3a,5,6a-tetraazapentalene and 1,4-di(o-chlorophenyl)-3,6-dimercapto-1H,4H-2,3a,5,6a-tetraazapentalene.

The toning agent used in the invention is particularly preferably a phthalazine derivative represented by the following formula (I). In the formula (I), R represents a substituent, and m represents an integer of 1 to 6. When m represents an integer of 2 or larger, a plurality of R's may be the same as each other or different from each other.

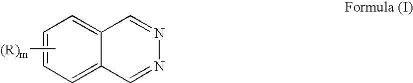

The substituent represented by R may be any substituent as long as the resultant toning agent does not cause adverse effects on the photographic properties. Examples of the substituent include halogen atoms such as a fluorine atom, a chlorine atom, a bromine atom, and an iodine atom; linear alkyl groups, branched alkyl groups, and cyclic alkyl groups, each of which preferably has 1 to 20 carbon atoms, more preferably have 1 to 16 carbon atoms, and particularly preferably have 1 to 12 carbon atoms, such as a methyl group, an ethyl group, an isopropyl group, a tert-butyl group, a tert-octyl group, a tert-amyl group, and a cyclohexyl group; alkenyl groups, which preferably have 2 to 20 carbon atoms, more preferably have 2 to 16 carbon atoms, and particularly preferably have 2 to 12 carbon atoms, such as a vinyl group, an allyl group, a 2-butenyl group, and a 3-pentenyl group; aryl groups, which preferably have 6 to 30 carbon atoms, more preferably have 6 to 20 carbon atoms, and particularly preferably have 6 to 12 carbon atoms, such as a phenyl group, a p-methylphenyl group, and a naphtyl group; alkoxy groups, which preferably have 1 to 20 carbon atoms, more preferably have 1 to 16 carbon atoms, and particularly preferably have 1 to 12 carbon atoms, such as a methoxy group, an ethoxy group, and a butoxy group; aryloxy groups, which preferably have 6 to 30 carbon atoms, more preferably have 6 to 20 carbon atoms, and particularly preferably have 6 to 12 carbon atoms, such as a phenyloxy group and a 2-naphtyloxy group; acyloxy groups, which preferably have 1 to 20 carbon atoms, more preferably have 2 to 16 carbon atoms, and particularly preferably have 2 to 12 carbon atoms, such as an acetoxy group and a benzoyloxy group; amino groups, which preferably have 0 to 20 carbon atoms, more preferably have 2 to 16 carbon atoms, and particularly preferably have 12 carbon atoms, such as a dimethylamino group, a diethylamino group, and a dibutylamino group; acylamino groups, which preferably have 1 to 20 carbon atoms, more preferably have 2 to 16 carbon atoms, and particularly preferably have 2 to 12 carbon atoms, such as an acetylamino group and a benzoylamino group; sulfonylamino groups, which preferably have 1 to 20 carbon atoms, more preferably have 1 to 16 carbon atoms, and particularly preferably have 1 to 12 carbon atoms, such as a methanesulfonylamino group and a benzenesulfonylamino group; ureido groups, which preferably have 1 to 20 carbon atoms, more preferably have 1 to 16 carbon atoms, and particularly preferably have 1 to 12 carbon atoms, such as a ureido group, a methylureido group, and a phenylureido group; carbamate groups, which preferably have 2 to 20 carbon atoms, more preferably have 2 to 16 carbon atoms, and particularly preferably have 2 to 12 carbon atoms, such as a methoxycarbonylamino group and a phenyloxycarbonylamino group; a carboxyl group; carbamoyl groups, which preferably have 1 to 20 carbon atoms, more preferably have 1 to 16 carbon atoms, and particularly preferably have 1 to 12 carbon atoms, such as a carbamoyl group, an N,N-diethylcarbamoyl group, and an N-phenylcarbamoyl group; alkoxycarbonyl groups, which preferably have 2 to 20 carbon atoms, more preferably have 2 to 16 carbon atoms, and particularly preferably have 2 to 12 carbon atoms, such as a methoxycarbonyl group and an ethoxycarbonyl group; acyl groups, which preferably have 2 to 20 carbon atoms, more preferably have 2 to 16 carbon atoms, and particularly preferably have 2 to 12 carbon atoms, such as an acetyl group, a benzoyl group, a formyl group, and a pivaloyl group; a sulfo group; sulfonyl groups, which preferably have 1 to 20 carbon atoms, more preferably have 1 to 16 carbon atoms, and particularly preferably have 1 to 12 carbon atoms, such as a mesyl group and a tosyl group; sulfamoyl groups, which preferably have 0 to 20 carbon atoms, more preferably have 0 to 16 carbon atoms, and particularly preferably have 0 to 12 carbon atoms, such as a sulfamoyl group, a methylsulfamoyl group, a dimethylsulfamoyl group, and a phenylsulfamoyl group; a cyano group; a nitro group; a hydroxyl group; a mercapto group; alkylthio groups, which preferably have 1 to 20 carbon atoms, more preferably have 1 to 16 carbon atoms, and particularly preferably have 1 to 12 carbon atoms, such as a methylthio group and a butylthio group; and heterocyclic groups, which preferably have 2 to 20 carbon atoms, more preferably have 2 to 16 carbon atoms, and particularly preferably have 2 to 12 carbon atoms, such as a pyridyl group, an imidazolyl group, and a pyrrolidyl group.

The substituent represented by R is preferably a halogen atom, a linear, branched, or cyclic alkyl group, an aryl group, an alkoxy group, an aryloxy group, a cyano group, a nitro group, a hydroxyl group, a mercapto group, or an alkylthio group, more preferably a linear, branched, or cyclic alkyl group, an alkoxy group, or an aryloxy group, particularly preferably a linear or branched alkyl group.

When m is 2 or larger, a plurality of R's may be the same as each other or different from each other. The substituents may further have a substituent. Further, the substituents may be bond to each other to form a ring structure.

The compound represented by the formula (I) has a melting point of preferably 130° C. or lower. The compound represented by the formula (I) may be a compound which takes a liquid form at ordinary temperature (approximately 15° C.).

Specific examples of the compound which is represented by the formula (I) and which has a melting point of 130° C. or lower are illustrated below. The compound represented by the formula (I) is not limited to these examples.

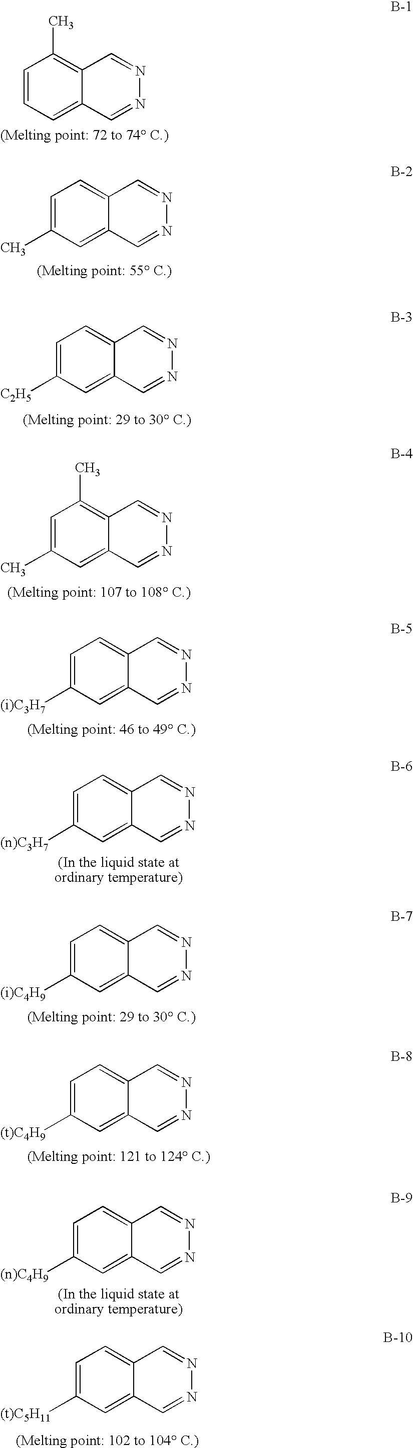

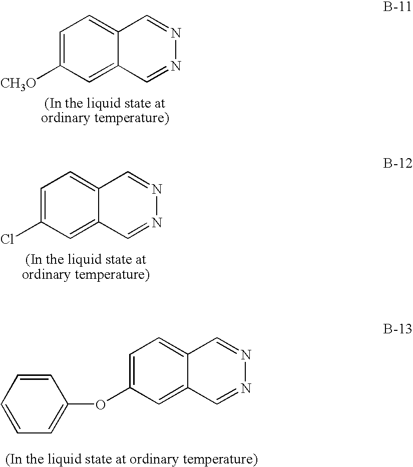

The amount of the toning agent used in the photothermographic material of the invention is selected such that the toning agent improves the image quality to the desired degree. A proper amount of the toning agent can increase the image density and improves the image quality of a black-colored silver image. The amount of the toning agent on the image-forming layer side is preferably 0.1 to 50 mol % of the amount of silver, more preferably 0.5 to 20 mol % of the amount of silver.

The toning agent may be added to any layer(s) on the image-forming layer side of the support. In an embodiment, the toning agent is added to the image-forming layer and/or a layer adjacent to the image-forming layer. In a preferable embodient, the toning agent is added to the image-forming layer.

3) Color Tone Controlling Agent

The photothermographic material of the invention preferably comprises a color tone controlling agent for controlling the color tone of the developed silver. The color tone controlling agent is an additive capable of adjusting the color tone of the developed silver to the desired tone. For example, when a pure black image is desired but the developed silver has a blue color tone, it is preferable to use a reducing compound that generates a yellow oxidation product as a color tone controlling agent. Further, when the developed silver has a yellowish brown color tone, it is preferable to use a compound which forms a cyan color as a color tone controlling agent. As described above, it is preferable to select a color tone controlling agent having a suitable color based on the color tone of the developed silver and the desired color tone of the image.

1) Color Tone Controlling Agent Represented by Formula (P)

In the invention, it is preferable to use a compound represented by the following formula (P) as a color tone controlling agent.

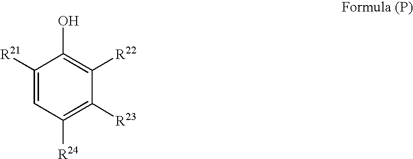

In the formula (P), R²¹ and R²² each independently represent a hydrogen atom, an alkyl group, or an acylamino group. However, neither R²¹ nor R²² represents a 2-hydroxyphenylmethyl group, and at least one of R²¹ and R²² represents a group other than a hydrogen atom. R²³ represents a hydrogen atom or an alkyl group. R²⁴ represents a substituent which can be bonded to the benzene ring.

When R²¹ represents an alkyl group, the alkyl group is preferably an alkyl group having 1 to 30 carbon atoms, more preferably an alkyl group having 1 to 10 carbon atoms.

The alkyl group may be substituted or unsubstituted. Preferred examples of the unsubstituted alkyl group include a methyl group, an ethyl group, a butyl group, an octyl group, an isopropyl group, a t-butyl group, a t-octyl group, a t-amyl group, a sec-butyl group, a cyclohexyl group, and a 1-methylcyclohexyl group. The unsubstituted alkyl group is more preferably an isopropyl group or a bulkier group than an isopropyl group, such as an isononyl group, a t-butyl group, a t-amyl group, a t-octyl group, a cyclohexyl group, a 1-methylcyclohexyl group, or an adamanthyl group; particularly preferably a tertiary alkyl group such as a tbutyl group, a t-octyl group, or a t-amyl group.

When the alkyl group has a substituent, examples of the substituent include halogen atoms, aryl groups, alkoxy groups, amino groups, acyl groups, acylamino groups, alkylthio groups, arylthio groups, sulfonamide groups, acyloxy groups, oxycarbonyl groups, carbamoyl groups, sulfamoyl groups, sulfonyl groups, and phosphoryl groups.

When R²² represents an alkyl group, the alkyl group is preferably an alkyl group having 1 to 30 carbon atoms, more preferably an unsubstituted alkyl group having 1 to 24 carbon atoms.

The alkyl group may be substituted or unsubstituted. Preferred examples of the unsubstituted alkyl group include a methyl group, an ethyl group, a butyl group, an octyl group, an isopropyl group, a t-butyl group, a t-octyl group, a t-amyl group, a sec-butyl group, a cyclohexyl group, and a 1-methylcyclohexyl group.

Examples of the substituents on the alkyl group of R²² may be the same as in the case of the substituents on R²¹.

When any of R²¹ and R²² represents an acylamino group, the acylamino group is preferably an acylamino group having 1 to 30 carbon atoms, more preferably an acylamino group having 1 to 10 carbon atoms.

The acylamino group may be unsubstituted or substituted. Specific examples of the acylamino group include an acetylamino group, alkoxyacetylamino groups, and aryloxyacetylamino groups.

The group or atom represented by R²¹ is preferably an alkyl group.

The group or atom represented by R²² is preferably a hydrogen atom, an alkyl group, or an acylamino group, preferably a hydrogen atom or an unsubstituted alkyl group having 1 to 24 carbon atoms, such as a methyl group, an isopropyl group, and a tbutyl group.

It should be noted that neither R²¹ nor R²² is a 2-hydroxyphenylmethyl group, and at least one of R²¹ and R²² is a group other than a hydrogen atom.

The group or atom represented by R²³ is preferably a hydrogen atom or an alkyl group having 1 to 30 carbon atoms, more preferably a hydrogen atom or an unsubstituted alkyl group having 1 to 24 carbon atoms. Examples of the alkyl group of R²³ may be the same as in the case of the alkyl group of R²². Specific examples of the alkyl group of R²³ include a methyl group, an isopropyl group, and a tbutyl group.

In a preferable embodiment, at least one of R²² and R²³ is a hydrogen atom.

R²⁴ represents a substituent which can be bonded to the benzene ring. Examples of the substituent of R²⁴ are the same as the above-described examples of R¹² and R^{12′} in the formula (R). The group represented by R²⁴ is preferably a substituted or unsubstituted alkyl group having 1 to 30 carbon atoms or an oxycarbonyl group having 2 to 30 carbon atoms, more preferably an alkyl group having 1 to 24 carbon atoms. The substituent(s) on the alkyl group may be selected from aryl groups, amino groups, alkoxy groups, oxycarbonyl groups, acylamino groups, acyloxy groups, imide groups, and ureido groups, more preferably selected from aryl groups, amino groups, oxycarbonyl groups, and alkoxy groups.

The compound represented by the formula (P) is further preferably a compound represented by the following formula (P-2):

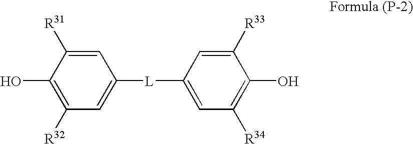

In the formula (P-2), R³¹, R³², R³³ and R³⁴ each independently represent a hydrogen atom, or a substituted or unsubstituted alkyl group having 1 to 20 carbon atoms. At least one of R³¹ and R³² represents a group other than a hydrogen atom, and at least one of R³³ and R³⁴ represents a group other than a hydrogen atom. R³¹, R³², R³³ and R³⁴ are each preferably an alkyl group having 1 to 10 carbon atoms. The substituent(s) on the alkyl group may be any substituent(s), and preferred examples thereof include aryl groups, a hydroxy group, alkoxy groups, aryloxy groups, alkylthio groups, arylthio groups, acylamino groups, sulfonamide groups, sulfonyl groups, phosphoryl groups, acyl groups, carbamoyl groups, ester groups, and halogen atoms. The alkyl group is preferably an isopropyl group or a bulkier group than an isopropyl group, such as an isopropyl group, an isononyl group, a t-butyl group, a t-amyl group, a t-octyl group, a cyclohexyl group, a 1-methylcyclohexyl group, and an adamanthyl group. In a more preferable embodiment, at least two of R³¹ to R³⁴ represent such bulky groups. The alkyl group is further preferably a tertiary alkyl group which is bulkier than an isopropyl group, such as a t-butyl group, a t-octyl group, and a t-amyl group.

The group or atom represented by L is preferably a —CHR¹³— group.

The group or atom represented by R¹³ is preferably a hydrogen atom or an alkyl group having 1 to 15 carbon atoms. The alkyl group may be a linear alkyl group or a cyclic alkyl group. The alkyl group may have a C═C bond. Preferred examples of the alkyl group include a methyl group, an ethyl group, a propyl group, an isopropyl group, a 2,4,4-trimethylpentyl group, a cyclohexyl group, a 2,4-dimethyl-3-cyclohexenyl group, and a 3,5-dimethyl-3-cyclohexenyl group. The group or atom represented by R¹³ is particularly preferably a hydrogen atom, a methyl group, an ethyl group, a propyl group, an isopropyl group, or a 2,4-dimethyl-3-cyclohexenyl group.

Specific examples of compounds represented by the formula (P) (which may be compounds represented by (P-2)) are described below without intention of restricting the scope of the invention. 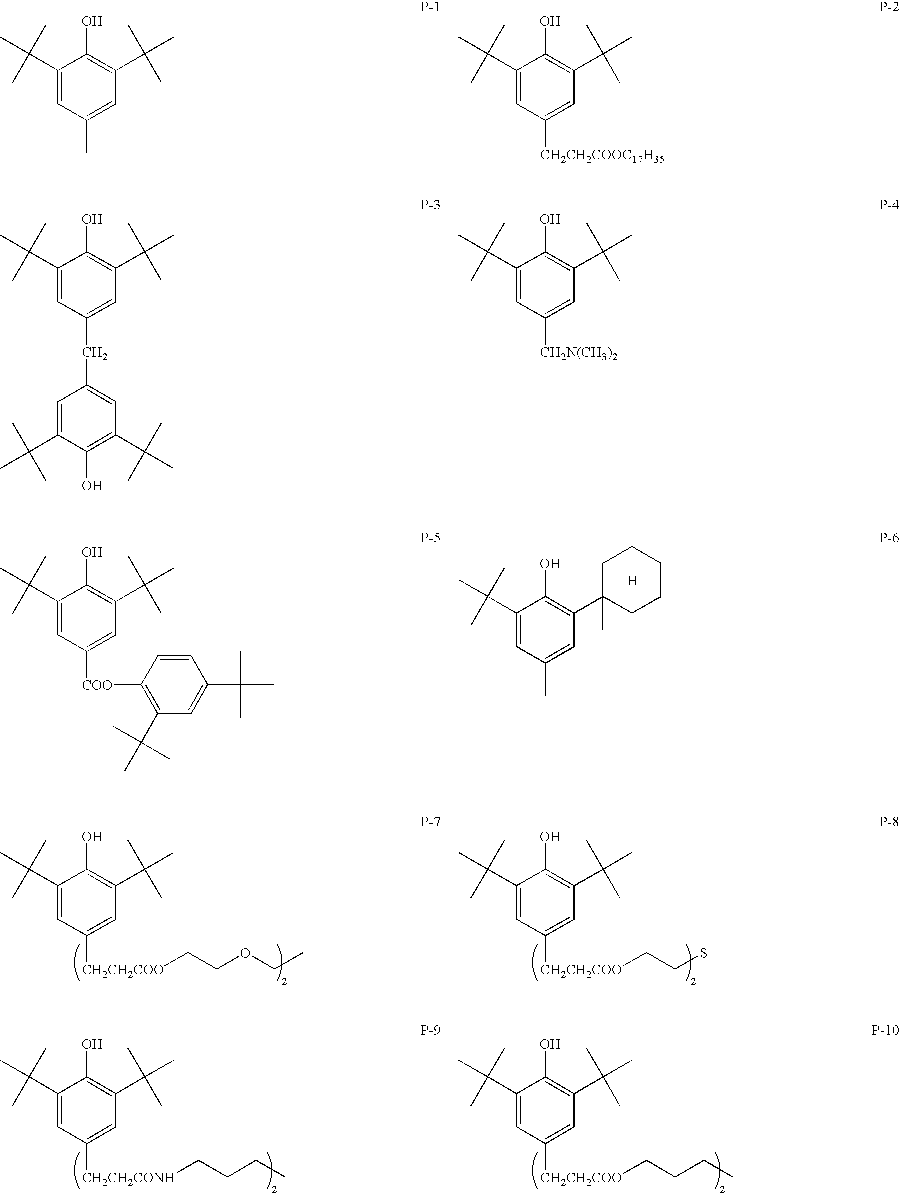 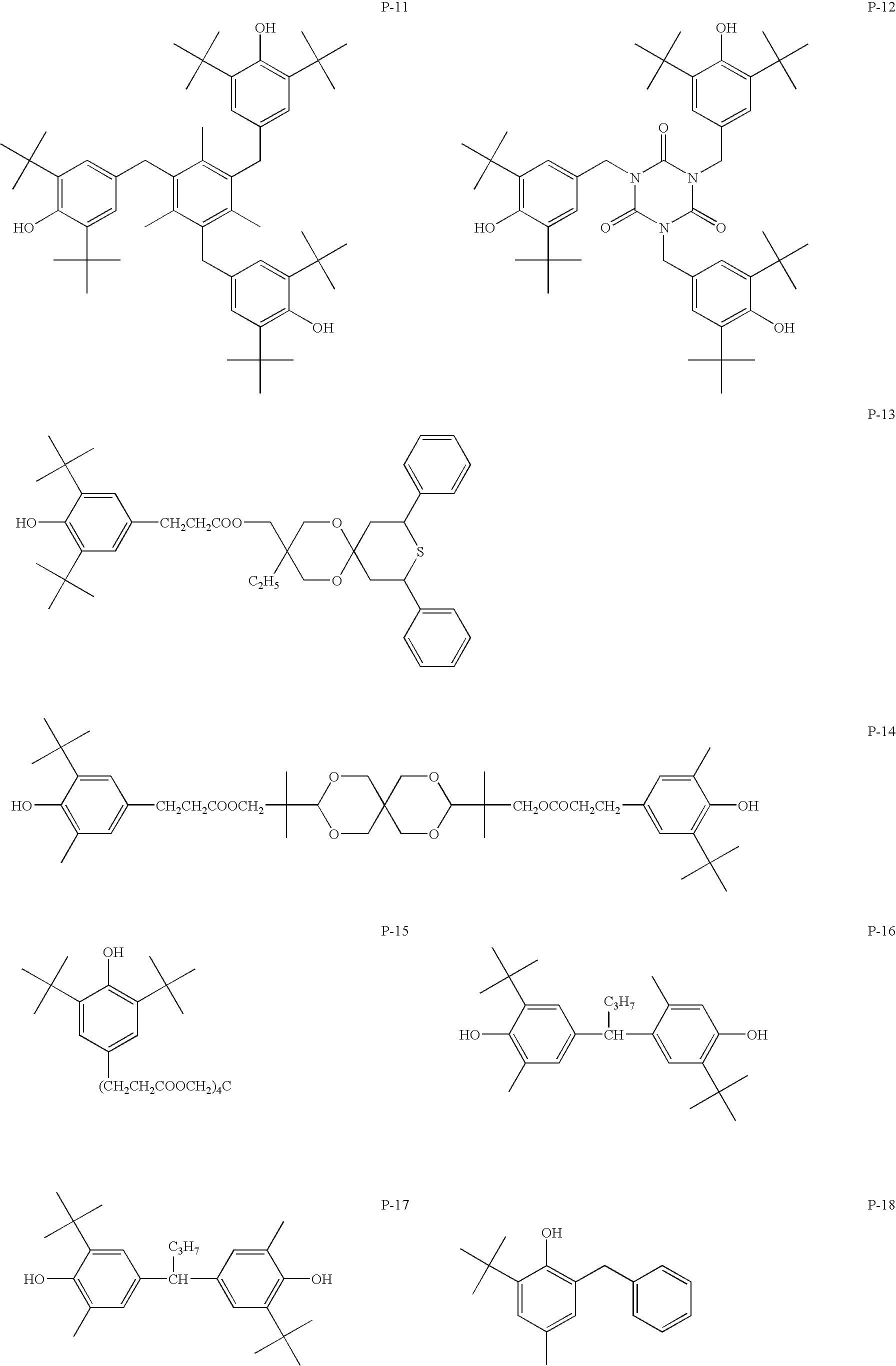 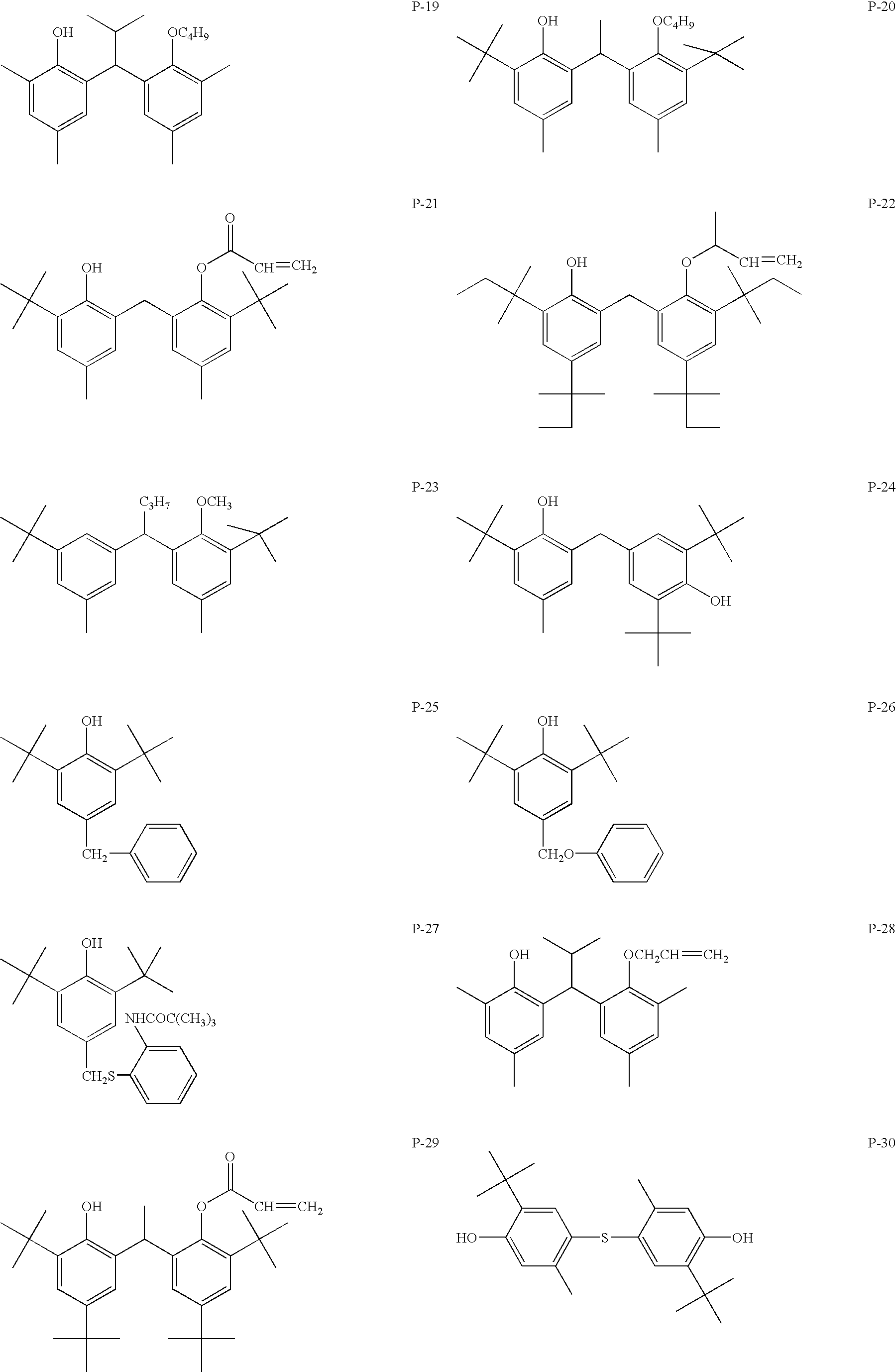 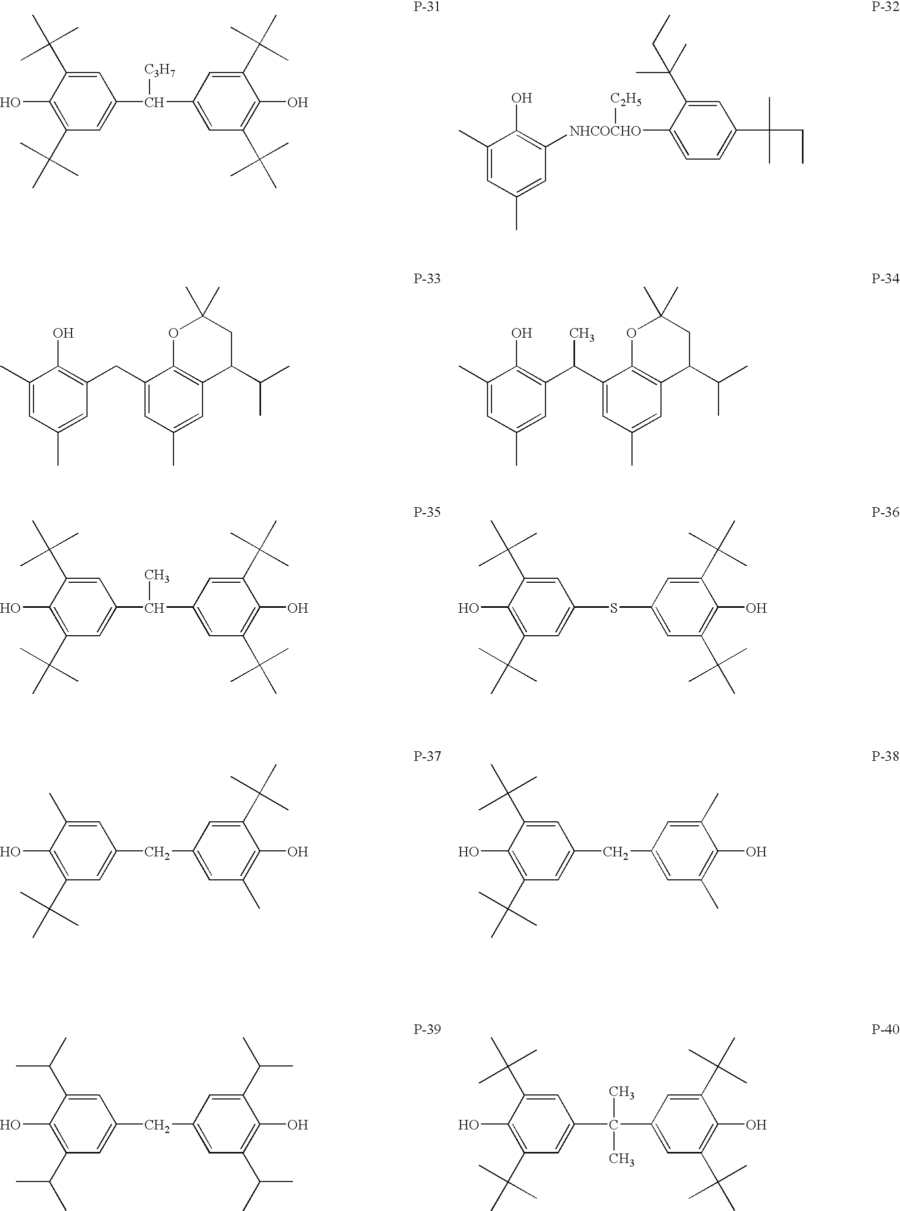
2) Coupler

A coupler, which can form a color when coupled with the oxidation product generated by the oxidation of the reducing agent at thermal development, may be used as a color tone controlling agent. Examples of the coupler are described in JP-A Nos. 2002-311533, 2002-328444, 2002-318432, 2002-221768, 2002-287296, and 2002-296731, the disclosures of which are incorporated herein by reference. A desired color can be formed by an appropriate combination of the reducing agent and the coupler.

The color tone controlling agent may be added to the coating liquid in any form such as a solution, an emulsion, or a solid particle dispersion.

In an exemplary emulsification method, the color tone controlling agent is dissolved in an oil such as dibutyl phthalate, tricresyl phosphate, glyceryl triacetate, or diethyl phthalate, and/or a cosolvent such as ethyl acetate and cyclohexanone, and then mechanically emulsified.

In an embodiment, the solid particle dispersion is prepared by a method comprising dispersing powder of the color tone controlling agent in an appropriate solvent such as water using a ball mill, a colloid mill, a vibration ball mill, a sand mill, a jet mill, a roll mill, or ultrasonic wave. A protective colloid (e.g. a polyvinyl alcohol) and/or a surfactant such as an anionic surfactant (e.g. a mixture of sodium triisopropylnaphthalenesulfonates each having a different combination of the substitution positions of the three isopropyl groups) may be used in the preparation. The aqueous dispersion may further include an antiseptic agent such as a benzoisothiazolinone sodium salt.

In a preferable embodiment, the color tone controlling agent is included in the image-forming layer including the organic silver salt. In another embodiment, a color tone controlling agent is included in the image-forming layer and another color controlling agent is included in a non-image-forming layer which is adjacent to the image-forming layer. In another embodiment, two or more color tone controlling agents are included in the non-image-forming layer. In another embodiment, the image-forming layer has a plurality of layers, and the color tone controlling agents are included in respectively different layers in the image-forming layer.

The mole ratio of the color tone controlling agent to the reducing agent represented by the formula (R) is preferably 0.001 to 0.2, more preferably 0.005 to 0.1, further preferably 0.008 to 0.05.

4) Plasticizer

A known plasticizer may be used in the invention in order to improve the physical properties of the layer. The plasticizer for the image-forming layer or the non-photosensitive layer is preferably a compound described in JP-A No. 11-65021, Paragraph 0117, JP-A Nos. 2000-5137, 2004-219794, 2004-219802, and 2004-334077, the disclosures of which are incorporated herein by reference.

5) Dye and Pigment

Various kinds of dyes and pigments such as C.I. Pigment Blues 60, 64, and 15:6 may be used in the image-forming layer for the purpose of improving the color tone, preventing generation of interference fringe upon laser exposure, and preventing irradiation. The dyes and pigments are described in detail, for example, in WO 98/36322, JP-A Nos. 10-268465 and 11-338098, the disclosures of which are incorporated by reference herein.

6) Ulltra-High Contrast Agent

It is preferable to incorporate an ultra-high contrast agent into the image-forming layer when a ultra-high contrast image suitable for printing is needed. Examples of the ultra-high contrast agents, examples of the methods for adding them, and examples of the amount thereof are described in JP-A No. 11-65021, Paragraph 0118; JP-A No. 11-223898, Paragraph 0136 to 0193; JP-A No. 2000-284399 (the compounds each represented by any one of the formulae (H), (1) to (3), (A), and (B)); JP-A No. 2000-347345 (the compounds represented by the formulae (III) to (V) and the example compounds of Chemical Formula 21 to 24); etc. Further, examples of ultra-high contrast agents are described in JP-A No. 11-65021, Paragraph 0102, and JP-A No. 11-223898, Paragraph 0194 and 0195.

Formic acid or a formate salt may be used as a strong fogging agent. The amount of the formic acid or the formate salt per 1 mol of silver is preferably 5 mmol or smaller, more preferably 1 mmol or smaller, on the the image-forming layer side.

In the photothermographic material of the invention, the ultra-high contrast agent is preferably used in combination with an acid generated by hydration of diphosphorus pentaoxide or a salt thereof. Examples of the acid and the salt include metaphosphoric acid, pyrophosphoric acid, orthophosphoric acid, triphosphoric acid, tetraphosphoric acid, hexametaphosphoric acid, and salts thereof. Particularly preferred are orthophosphoric acid, hexametaphosphoric acid, and salts thereof. Specific examples of the salts include sodium orthophosphate, sodium dihydrogen orthophospate, sodium hexametaphosphate, and ammonium hexametaphosphate.

The amount of the acid generated by the hydration of diphosphorus pentaoxide or the salt thereof may be selected depending on the sensitivity, the fogging properties, etc. The amount of the acid or the salt to be applied per 1 m² of the photosensitive material is preferably 0.1 to 500 mg/m², more preferably 0.5 to 100 mg/m².

(Preparation and Application of Coating Liquid)

The coating liquid for the image-forming layer is prepared preferably at a preparation temperature of 30 to 65° C., more preferably 35 to 60° C., furthermore preferably 35 to 55° C. The temperature of the coating liquid immediately after addition of polymer latex is preferably 30 to 65° C.

(6) Other Layers and Components

1) Antihalation Layer

In the photothermographic material of the invention, an antihalation layer may be disposed such that the antihalation layer is farther from the exposure light source than the image-forming layer is.

The antihalation layer is described, for example, in JP-A No. 11-65021, Paragraph 0123 to 0124, JP-A Nos. 11-223898, 9-230531, 10-36695, 10-104779, 11-231457, 11-352625, and 11-352626, the disclosures of which are incorporated herein by reference.

The antihalation layer includes an antihalation dye having absorption in the exposure wavelength range. When the exposure wavelength is within the infrared range, an infrared-absorbing dye may be used as the antihalation dye, and the infrared-absorbing dye is preferably a dye which does not absorb visible light.

When a dye having absorption in the visible light range is used to prevent the halation, in a preferable embodiment, the color of the dye does not substantially remain after image formation. It is preferable to achromatize the dye by heat at the heat development. In a more preferable embodiment, a base precursor and a thermally-achromatizable dye are added to a non-photosensitive layer so as to impart the antihalation function to the non-photosensitive layer. These techniques are described, for example in JP-A No. 11-231457, the disclosure of which is incorporated by reference herein.

The amount of the achromatizable dye to be applied may be determined depending on the purpose. Generally, the amount of the achromatizable dye is selected such that the optical density (the absorbance) exceeds 0.1 at the desired wavelength. The optical density is preferably 0.15 to 2, more preferably 0.2 to 1. The amount of the dye required for obtaining such an optical density is generally 0.001 to 1 g/m².

When the dye is achromatized in this manner, the optical density after the heat development can be lowered to 0.1 or lower. In an embodiment, two or more achromatizable dyes are used in combination in a thermally achromatizable recording material or a photothermographic material. Similarly, two or more base precursors may be used in combination.

In the thermal achromatization, it is preferable to use an achromatizable dye, a base precursor, and a substance which can lower the melting point of the base precursor by 3° C. or more when mixed with the base precursor, in view of the thermal achromatizability, as described in JP-A No. 11-352626, the disclosure of which is incorporated by reference herein. Examples of the substance include diphenylsulfone, 4-chlorophenyl(phenyl)sulfone, and 2-naphtyl benzoate.

2) Back Layer

Examples of the back layer usable in the invention are described in JP-A No. 11-65021, Paragraph 0128 to 0130, the disclosure of which is incorporated herein by reference.

In the invention, a coloring agent having an absorption peak within the wavelength range of 300 to 450 nm may be added to the photosensitive material so as to improve the color tone of silver and to suppress the image deterioration with time. Examples of the coloring agent are described in JP-A Nos. 62-210458, 63-104046, 63-103235, 63-208846, 63-306436, 63-314535, 01-61745, and 2001-100363, the disclosures of which are incorporated by refernce herein.

The photothermographic material of the invention is preferably a so-called single-sided photosensitive material, which comprises at least one image-forming layer including the silver halide emulsion on one side of the support, and a back layer on the other side of the support.

3) Surface pH

The photothermographic material of the invention before heat development preferably has a surface pH of 7.0 or lower. The surface pH is more preferably 6.6 or lower. The lower limit of the surface pH may be approximately 3, though it is not particularly restricted. The surface pH is still more preferably 4 to 6.2. It is preferable to adjust the surface pH using an organic acid such as a phthalic acid derivative, a nonvolatile acid such as sulfuric acid, or a volatile base such as ammonia, from the viewpoint of lowering the surface pH. In order to achieve a low surface pH, it is preferable to use ammonia since ammonia is high in volatility and can be removed during coating or before heat development. It is also preferable to use ammonia in combination with a nonvolatile base such as sodium hydroxide, potassium hydroxide, or lithium hydroxide. Methods for measuring the surface pH are described in JP-A No. 2000-284399, Paragraph 0123, the disclosure of which is incorporated herein by reference.

4) Film Hardener

A film hardener may be included in layers such as the image-forming layer, the protective layer, and the back layer. Examples of the film hardeners are described in T. H. James, The Theory of the Photographic Process, Fourth Edition, Page 77 to 87 (Macmillan Publishing Co., Inc., 1977), the disclosure of which is incorporated by reference herein. Preferred examples of the film hardeners include: chromium alums; 2,4-dichloro-6-hydroxy-s-triazine sodium salt; N,N-ethylenebis(vinylsulfonacetamide); N,N-propylenebis(vinylsulfonacetamide); polyvalent metal ions described in Page 78 of the above reference; polyisocyanates described in U.S. Pat. No. 4,281,060, JP-A No. 6-208193, etc.; epoxy compounds described in U.S. Pat. No. 4,791,042, etc.; and vinylsulfone compounds described in JP-A No. 62-89048, etc. The disclosures of the above patent documents are incorporated herein by reference.

The film hardener is added in the form of a solution, and the solution is added to the coating liquid for the protective layer preferably in the period of 180 minutes before coating to immediately before coating, more preferably in the period of 60 minutes before coating to 10 seconds before coating. The method and conditions of mixing the film hardener into the coating liquid are not particularly limited as long as the advantageous effects of the invention can be sufficiently obtained. In an embodiment, the film hardner is mixed with the coating liquid in a tank while controlling the addition flow rate and the feeding amount to the coater, such that the average retention time calculated from the addition flow rate and the feeding amount to the coater is the desired time. In another embodiment, the film hardner is mixed with the coating liquid by a method using a static mixer described, for example, in N. Harnby, M. F. Edwards, and A. W. Nienow, translated by Koji Takahashi, Ekitai Kongo Gijutsu, Chapter 8 (Nikkan Kogyo Shimbun, Ltd., 1989), the disclosure of which is incorporated herein by reference.

5) Antistatic Agent

The photothermographic material of the invention preferably comprises an electrically conducting layer including an electrically conductive material such as a metal oxide or an electrically conductive polymer. The electrically conducting layer (antistatic layer) may be the same layer as a layer selected from the undercoat layer, the back layer, the surface protective layer, and the like, or may be provided as a separate layer which is different from those layers.

Examples of the electrically conductive polymers include polyvinylbenzenesulfonate salts; polyvinylbenzyltrimethylammonium chlorides; quaternary salt polymers described in U.S. Pat. Nos. 4,108,802, 4,118,231, 4,126,467, and 4,137,217; and polymer latexes described in U.S. Pat. No. 4,070,189, OLS 2,830,767, JP-A Nos. 61-296352 and 61-62033, etc. The disclosures of the above patent documents are incorporated herein by reference.

In a preferable embodiment, the electrically conducting layer includes a conductive metal oxide, which can sufficiently reduce the lateral resistance of the photosensitive material.

The metal oxide is preferably ZnO, TiO₂, or SnO₂. It is preferable to add Al, In, or the like to ZnO. It is preferable to add Sb, Nb, P, a halogen atom, or the like to SnO₂. It is preferable to add Nb, Ta, or the like to TiO₂. SnO₂ to which Sb has been added is particularly preferable conductive substance for the electrically conducting layer. The amount of the hetero atom is preferably 0.01 to 30 mol %, more preferably 0.1 to 10 mol %. The particles of the metal oxide may be in a spherical shape, in a needle shape, or in a plate shape. The metal oxide particles are preferably needle-shaped particles with the ratio of the major axis to the minor axis of 2.0 or higher in view of the conductivity, and the ratio is more preferably 3.0 to 50. The amount of the metal oxide is preferably 1 to 1,000 mg/m², more preferably 10 to 500 mg/m², furthermore preferably 20 to 200 mg/m². The antistatic layer may be provided on the emulsion side or on the back side. In a preferable embodiment, the antistatic layer is provided between the support and the back layer. Specific examples of the antistatic layer are described in JP-A No. 11-65021, Paragraph 0135; JP-A Nos. 56-143430, 56-143431, 58-62646, and 56-120519; JP-A No. 1184573, Paragraph 0040 to 0051; U.S. Pat. No. 5,575,957; and JP-A No. 11-223898, Paragraph 0078 to 0084; the disclosures of which are incorporated herein by reference.

6) Support

The support comprises preferably a heat-treated polyester, particularly a polyethylene terephthalate, which is subjected to a heat treatment at 130 to 185° C. so as to relax the internal strains of the film generated during biaxial stretching, thereby eliminating the heat shrinkage strains during heat development. In the case of a photothermographic material for medical use, the support may be colored with a blue dye (e.g., Dye-1 described in Examples of JP-A No. 8-240877, the disclosure of which is incorporated herein by reference) or uncolored. The support is preferably undercoated, for example, with a water-soluble polyester described in JP-A No. 11-84574, a styrene-butadiene copolymer described in JP-A No. 10-186565, a vinylidene chloride copolymer described in JP-A No. 2000-39684 or Japanese Patent Application No. 11-106881, Paragraph 0063 to 0080, the disclosures of which are incorporated herein by reference. When the support is coated with the image-forming layer or the back layer, the support preferably has a moisture content of 0.5% by mass or lower.

7) Other Additives

The photothermographic material of the invention may further include additives such as antioxidants, stabilizing agents, plasticizers, UV absorbers, and coating aids. The additives may be added to any one of the image-forming layer and the non-photosensitive layers. The additives may be used with reference to WO 98/36322, EP 803764A1, JP-A Nos. 10-186567 and 10-18568, the disclosures of which are incorporated herein by reference.

8) Coating Method

The photothermographic material of the invention may be formed by any coating method. Specific examples of the coating method include extrusion coating methods, slide coating methods, curtain coating methods, dip coating methods, knife coating methods, flow coating methods, extrusion coating methods using a hopper described in U.S. Pat. No. 2,681,294, the disclosure of which is incorporated herein by reference. The coating method is preferably an extrusion coating method described in Stephen F. Kistler and Petert M. Schweizer, Liquid Film Coating, Page 399 to 536 (CHAPMAN & HALL, 1997) (the disclosure of which is incorporated herein by reference), or a slide coating method, more preferably a slide coating method. Examples of slide coaters for the slide coating methods are described in the above reference, Page 427, FIG. 11b.1. Two or more layers may be simultaneously formed by any of methods described in the above reference, Page 399 to 536, and methods described in U.S. Pat. No. 2,761,791 and British Patent No. 837,095, the disclosures of which are incorporated herein by reference. Particularly preferred coating methods used in the invention include those described in JP-A Nos. 2001-194748, 2002-153808, 2002-153803, and 2002-182333, the disclosures of which are incorporated herein by reference.

In the invention, the coating liquid for the image-forming layer is preferably a so-called thixotropy fluid. The thixotropy fluid may be used with reference to JP-A No. 11-52509, the disclosure of which is incorporated herein by reference. The viscosity of the coating liquid for the image-forming layer is preferably 400 to 100,000 mPa·s at a shear rate of 0.1 S⁻¹, more preferably 500 to 20,000 mPa·s at a shear rate of 0.1 S⁻¹. Further, the viscosity of the coating liquid is preferably 1 to 200 mPa·s at a shear rate of 1,000 S⁻¹, more preferably 5 to 80 mPa·s at the shear rate of 1,000 S⁻¹.

In the preparation of the coating liquid, it is preferable to use a known in-line mixing apparatus or a known in-plant mixing apparatus when two or more liquids are mixed. An in-line mixing apparatus described in JP-A No. 2002-85948 and an in-plant mixing apparatus described in JP-A No. 2002-90940 can be preferably used in the invention. The disclosures of the above patent documents are incorporated by reference herein.

The coating liquid is preferably subjected to a defoaming treatment to obtain an excellent coating surface. Preferred methods for the defoaming treatment are described in JP-A No. 2002-66431, the disclosure of which is incorporated herein by reference.

In or before the application of the coating liquid, the support is preferably subjected to electrical neutralization so as to prevent adhesion of dusts, dirts, etc. caused by the electrification of the support. Preferred examples of the neutralizing methods are described in JP-A No. 2002-143747, the disclosure of which is incorporated herein by reference.

When a non-setting type coating liquid for the image-forming layer is dried, it is important to precisely control drying air and drying temperature. Preferred drying methods are described in detail in JP-A Nos. 2001-194749 and 2002-139814, the disclosures of which are incorporated herein by reference.

The photothermographic material of the invention is preferably heat-treated immediately after coating and drying, so as to increase the film properties. In a preferable embodiment, the heating temperature of the heat treatment is controlled such that the film surface temperature is 60 to 100° C. The heating time is preferably 1 to 60 seconds. The film surface temperature in the heat treatment is more preferably 70 to 90° C., and the heating time is more preferably 2 to 10 seconds. Preferred examples of the heat treatments are described in JP-A No. 2002-107872, the disclosure of which is incorporated herein by reference.

Further, the production methods described in JP-A Nos. 2002-156728 and 2002-182333 (the disclosures of which are incorporated herein by reference) can be preferably used to stably produce the photothermographic material of the invention continuously.

The photothermographic material of the invention is preferably a monosheet type material, which can form an image on the material without using another sheet such as an image-receiving material.

9) Packaging Material

It is preferable to seal the photosensitive material of the invention by a packaging material having a low oxygen permeability and/or a low water permeability so as to prevent deterioration of the photographic properties during storage or to prevent curling. The oxygen permeability is preferably 50 ml/atm·m²·day or lower at 25° C., more preferably 10 ml/atm·m²·day or lower at 25° C., furthermore preferably 1.0 ml/atm·m²·day or lower at 25° C. The water permeability is preferably 10 g/atm·m²·day or lower, more preferably 5 g/atm·m²·day or lower, furthermore preferably 1 g/atm·m²·day or lower.

Specific examples of the packaging material having a low oxygen permeability and/or a low water permeability include materials described in JP-A Nos. 8-254793 and 2000-206653, the disclosures of which are incorporated herein by reference.

In a preferable embodiment, when the photothermographic material is cut into a predetermined size and packaged in the packaging material, the cleanliness of the atmosphere is a cleanness of Federal Standard 209D Class 10,000 or less. It is preferable to clean the packaging material before packaging.

When the photothermographic material is cut into a predetermined size, the cleanliness according to Federal Standard 209d is preferably Class 7,000 or less, more preferably Class 4,000 or less, furthermore preferably Class 1,000 or less, particularly preferably Class 500 or less. When the photothermographic material cut into a predetermined size is packaged, the cleanliness according to Federal Standard 209d is preferably Class 7,000 or less, more preferably Class 4,000 or less, furthermore preferably Class 1,000 or less, particularly preferably Class 500 or less.

By cutting and/or packaging the photothermographic material under an atmosphere with a cleanliness of Federal Standard 209D Class 10,000 or less, the risk of occurrence of defects in the formed image can be largely reduced. Specifically, development of white spots and scratches in the image can be mostly prevented.

The packaging material for the photothermographic material of the invention is preferably a packaging material which hardly produces dusts. Particularly, it is preferable not to use a packaging material if the packaging material produces dusts so that the cleanliness of Federal Standard 209d Class 10,000 or less cannot be maintained.

10) Other Technologies

Other technologies usable for the photothermographic material of the invention include those described in EP 803764A1, EP 883022A1, WO 98/36322, and JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, and 2000-187298, the disclosures of which are incorporated herein by reference.

In the case a multi-color photothermographic material, the image-forming layers are generally separated from each other by providing functional or non-functional barrier layers between them as described in U.S. Pat. No. 4,460,681, the disclosure of which is incorporated herein by reference.

The multicolor photothermographic material may comprise an arbitrary combination of two or more layers for each color or a single layer including all the components as described in U.S. Pat. No. 4,708,928, the disclosure of which is incorporated herein by reference.

3. Image Forming Method

1) Exposure

The exposure light source may be a red to infrared emission laser such as an He—Ne laser and a red semiconductor laser, or a blue to greed emission laser such as an Ar⁺ laser, an He—Ne laser, an He—Cd laser, and a blue semiconductor laser. The laser is preferably a red to infrared emission semiconductor laser, and the peak wavelength of the laser is 600 to 900 nm, preferably 620 to 850 nm.

In recent years, a blue semiconductor laser and a module comprising an SHG (Second Harmonic Generator) and a semiconductor laser have been developed, and thus laser output units with short wavelength ranges have attracted much attention. The blue semiconductor lasers can form a highly fine image, can increase recording density, is long-lived, and has stable output, whereby the demand therefor is expected to be increased. The peak wavelength of the blue laser is preferably 300 to 500 nm, more preferably 400 to 500 nm.

In a preferable embodiment, the laser light is emitted in vertical multimode by high frequency superposition, etc.

2) Heat Development

The photothermographic material of the invention may be developed by any method, but is generally exposed imagewise and then heat-developed. The development temperature is preferably 80 to 250° C., more preferably 100 to 140° C., further preferably 110 to 130° C. The development time is preferably 1 to 60 seconds, more preferably 3 to 30 seconds, furthermore preferably 5 to 25 seconds, particularly preferably 7 to 16 seconds.

The photothermographic material of the invention can be developed even when the material is conveyed at a high conveying speed of 23 mm/sec or higher at heat development. The photothermographic material having the layer structure according to the invention is excellent in the storability even when the material has a composition suitable for rapid development. Further, the photothermographic material can be developed at a conveying speed of 27 mm/sec or higher.

The heater used in heat development may be a drum heater or a plate heater, preferably a plate heater. A heat development method using a heat development apparatus comprising a plate heater described in JP-A No. 11-133572 (the disclosure of which is incorporated herein by reference) can be preferably used in the invention. The heat development apparatus comprises a heat developing section, and a visible image is formed by: forming a latent image on a photothermographic material, and bringing the material into contact with a heating unit in the heat developing section. In the heat development apparatus, the heating unit comprises the plate heater, a plurality of press rollers facing each other are arranged along one surface of the plate heater, and the photothermographic material is passed between the press rollers and the plate heater to be heat-developed. In a preferable embodiment, the plate heater is divided into two to six stages and the temperature of the end part is lowered by approximately 1 to 10° C. For example, four plate heaters may be independently controlled at 112° C., 119° C., 121° C., and 120° C. Such a method is described also in JP-A No. 54-30032, the disclosure of which is incorporated by reference herein. In the method, water and organic solvents included in the photothermographic material can be removed, and deformation of the support caused by rapid heating can be prevented.

To reduce the size of the heat development apparatus and the heat development time, more stable control of the heater is preferred. In an embodiment, the heat development of the leading end of the photothermographic material is started before the rear end is exposed. Rapid processing type imagers preferred for the invention are described in JP-A No. 2003-285455, the disclosure of which is incorporated herein by reference. When such an imager is used, for example, the photothermographic material can be heat-developed in 14 seconds by a plate heater having three stages controlled at 107° C., 121° C., and 121° C. respectively, and the first sheet of the material can be outputted in about 60 seconds. In such rapid development, it is preferable to use the photothermographic material of the invention, which is high in the sensitivity and hardly affected by ambient temperature.

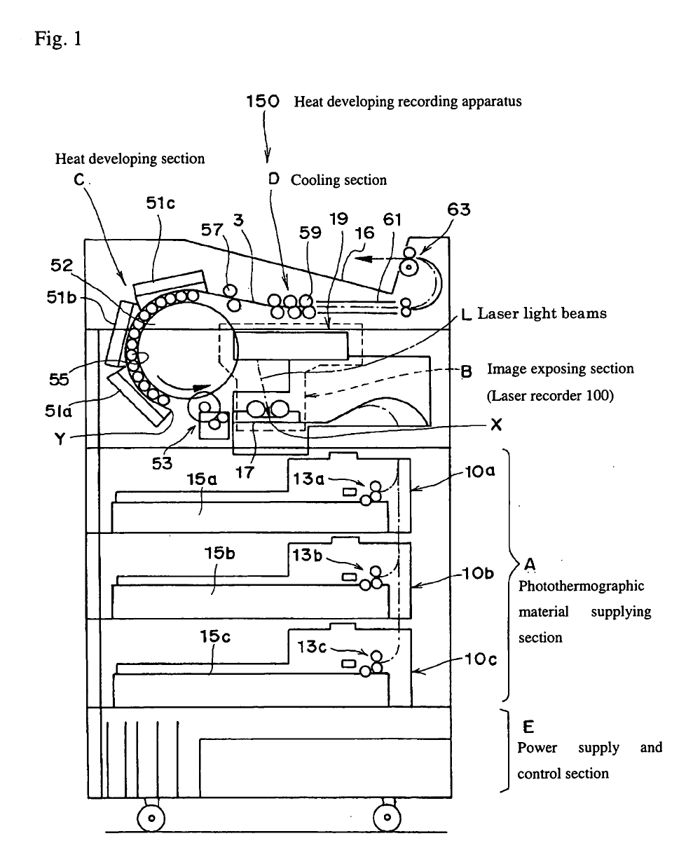

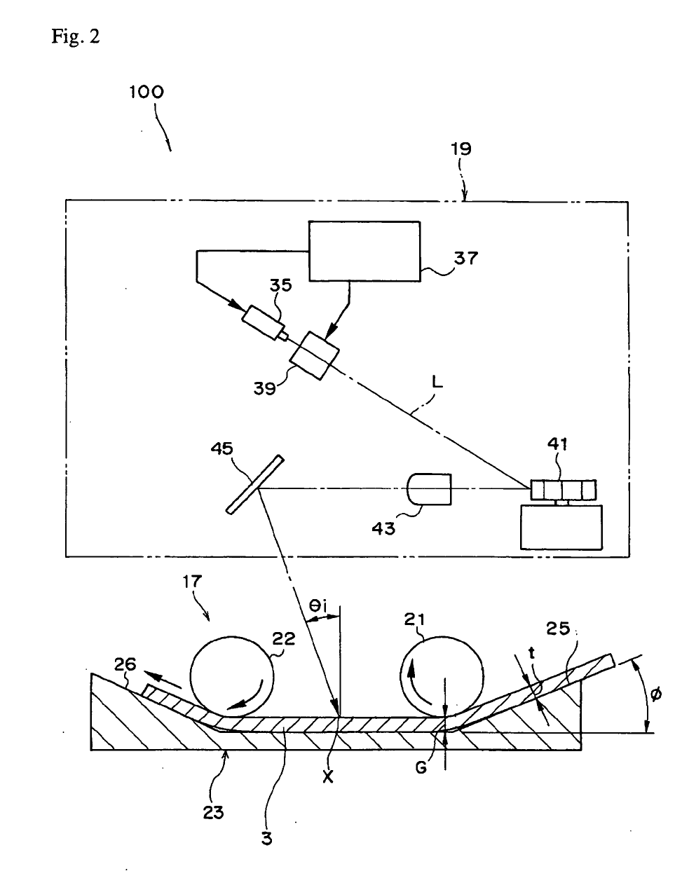

An example of such a rapid processing type imager is shown in FIG. 1. FIG. 1 illustrates a heat developing recording apparatus 150. The heat developing recording apparatus 150 is comprised of a photothermographic material supplying section A, an image exposing section B, a heat developing section C, a cooling section D, and. In the photothermographic material supplying section A, photothermographic materials 15a, 15b, 15c are stored in photothermographic material trays 10a, 10b, and 10c, respectively. The photothermographic materials 15a, 15b, 15c can be transferred to the image exposing section B respectively by sheet transfer rollers 13a, 13b, and 13c. The image exposing section B comprises a scan exposing device 19 which is a laser irradiation device, and a sub-scanning transfer device 17 which moves the photothermographic material in the sub-scanning direction. The photothermographic material is exposed to laser beams L at a position X which corresponds to the exposing region to be described later. The image exposing section B is a laser recorder 100 whose details are shown in FIG. 2.

The exposed photothermographic material is subsequently transferred to the heat developing section C. The heat developing section C comprises a driving roller 52 which is rotated by a reduction gear 53, heat developing plates 51a, 51b, and 51c which heat the exposed photothermographic material to conduct heat development, and transfer rollers 55 which transfer the photothermographic material along the periphery of the driving roller 52. The position Y corresponds to the developing region to be described later. A developed photothermographic material 3 is transferred into the cooling section D by cooling roters 57 and 59, then cooled by cooling plates 61, then discharged by a discharging roller 63. Top light shielding cover 16 prevents light from entering the interior of the photothermographic recording apparatus 150.

The power supply and control section E supplies electric power to the other sections and controls operations of the heat developing recording apparatus 150.

Details of the image exposing section B are illustrated in FIG. 2. In the scan exposing device 19, a semiconductor laser 35 emits the laser beams L which are modified by an intensity modifier 39. The semiconducter laser 35 and the intensity modifier 39 are controlled by a driving circuit 37. The laser beams L are reflected by a polygon mirror 41, and then enter a focusing lens 43, and then are reflected by a mirror 45, and are focused on position X at an incident angle θi. In the sub-scanning transfer device 17, the photothermographic material is transferred by driving rolls 21 and 22 along a guide 23 which has slopes 25 and 26. The gradient of the slope 25 is represented by φ and the thickness of the photothermographic material is represented by t and G. While transferred, the photothermographic material is exposed to the laser beams L at position X.

The time required for the exposure and development can be remarkably reduced by shortening the distance between the exposing region and the developing region. The distance is preferably small from the viewpoint of downsizing the heat development apparatus. Even when the distance between the exposing region and the developing region is 0 to 50 cm, the photothermographic material of the invention can form a uniform image with excellent storability. Further, the advantageous effects of the invention can be achieved even if the distance is 3 to 40 cm.

The exposing region refers to a position where the photothermographic material is irradiated with a light from an exposure light source. The developing region refers to a position where the photothermographic material is first heated for heat development. X in FIG. 2 represents the exposing region, and Y in FIG. 1 represents the developing region at which a photothermographic material transported from a part 53 contact with a plate 51a first.

Particularly, even when an exposed part of the photothermographic material sheet is developed while exposing another part of the sheet, the exposing region is not contaminated with volatile substances, by using the photothermographic material of the invention. This method can further reduce the processing time.

When the heat development apparatus is turned off and left overnight, the temperature of the heat developing region is equal to the room temperature. Therefore, it is difficult to obtain a stable image immediately after the apparatus is turned on because of the insufficient temperature of the heat developing region, the large temperature hunting width, etc. Thus, a time for increasing and stabilizing the temperature of the heat developing region is required to achieve the above preferred developing conditions.

Since the photothermographic material of the invention is hardly affected by outside environment and can form an image stably, it is possible to form an image on the photothermographic material of the invention stably even when development is started immediately after the apparatus is turned on.

For example, even when the leading end of the photothermographic material reaches the heat developing region within 15 minutes after turning on the heat development apparatus, the formed image is excellent in the storage stability. The leading end refers to a part of the photothermographic material after exposure which part reaches the heating unit of the heat development apparatus first. The heat developing region refers to the heating unit.

3) System

Fuji Medical Dry Laser Imager FM-DPL and DRYPIX 7000 are known as laser imagers for medical use comprising an exposure region and a heat developing region. FM-DPL is described in Fuji Medical Review, No. 8, Page 39 to 55 (the disclosure of which is incorporated herein by reference), and the technologies disclosed therein can be applied to the invention. The photothermographic material of the invention can be used for the laser imager in AD Network, proposed by Fuji Film Medical Co., Ltd. as a network system according to DICOM Standards.

4. Use of Photothermographic Material

The photothermographic material according to the invention is preferably used for forming a black and white image of silver, and is preferably used for medical diagnoses, industrial photographs, printings, or COM.

### EXAMPLES

The present invention will be described below with reference to Examples without intention of restricting the scope of the invention.

### Example 1

(Preparation of PET Support)

1) Film Formation

A PET having an intrinsic viscosity IV of 0.66, which was measured in a 6/4 mixture (weight ratio) of phenol/tetrachloroethane at 25° C., was prepared from terephthalic acid and ethylene glycol by a common procedure. The PET was converted to a pellet, dried at 130° C. for 4 hours, melted at 300° C., extruded from a T-die, and rapidly cooled to prepare an unstretched film.

The film was stretched 3.3 times in the longitudinal direction at 110° C. by rollers with different peripheral speeds, and then stretched 4.5 times in the horizontal direction at 130° C. by a tenter. The stretched film was subjected to thermal fixation at 240° C. for 20 seconds, and relaxed by 4% in the horizontal direction at this temperature. Then, the chuck of the tenter was slit, the both ends of the film were knurled, and the film was rolled up into 4 kg/cm², to obtain a roll having a thickness of 175 μm.

2) Surface Corona Treatment

Both surfaces of the support were treated at the room temperature at 20 m/minute using a solid state corona treatment machine Model 6 KVA manufactured by Piller Inc. The electric current and voltage were read in the treatment, whereby it was found that the support was treated under the condition of 0.375 kV·A·minute/m². The discharging frequency of the treatment was 9.6 kHz, and the gap clearance between the electrode and the dielectric roll was 1.6 mm.

3) Undercoating

Prescription (1) for an Undercoat Layer on the Image-Forming Layer Side

46.8 g of PESRESIN A-520 (30% by mass solution) available from Takamatsu Oil & Fat Co., Ltd.
10.4 g of VYLONAL MD-1200 available from Toyobo Co., Ltd.
11.0 g of a 1% by mass solution of polyethylene glycol monononyl phenyl ether (average ethylene oxide number 8.5)
0.91 g of MP-1000 (fine PMMA polymer grains, average grain diameter 0.4 μm) available from Soken Chemical & Engineering Co., Ltd.
931 ml of distilled water
   Prescription (2) for a First Back Undercoat Layer
130.8 g of a styrene-butadiene copolymer latex (solid content 40% by mass, styrene/butadiene weight ratio 68/32)
5.2 g of an 8% by mass aqueous solution of 2,4-Dichloro-6-hydroxy-S-triazine sodium salt
10 ml of a 1% by mass aqueous solution of sodium laurylbenzenesulfonate
0.5 g of a polystyrene grain dispersion (average grain diameter 2 μm, 20% by mass)
854 ml of distilled water
   Prescription (3) for a Second Back Undercoat Layer
84 g of a 17% by mass dispersion of SnO₂/SbO (9/1 mass ratio, average grain diameter 0.5 μm)
7.9 g of gelatin
10 g of METOLOSE TC-5 (2% by mass aqueous solution) available from Shin-Etsu Chemical Co., Ltd.
10 ml of a 1% by mass aqueous solution of sodium dodecylbenzenesulfonate
7 g of a 1% by mass NaOH
0.5 g of PROXEL available from Avecia Ltd.
881 ml of distilled water

After subjecting the both surfaces of the biaxially stretched polyethylene terephthalate support having a thickness of 175 μm to the corona treatment, the undercoating liquid of Prescription (1) was applied to one surface (the image-forming side) of the support by a wire bar in a wet amount of 6.6 ml/m², and dried at 180° C. for 5 minutes. Then, the undercoating liquid of Prescription (2) was applied to the other surface (back surface) by a wire bar in a wet amount of 5.7 ml/m², and dried at 180° C. for 5 minutes. Further, the undercoating liquid of Prescription (3) was applied to the back surface by a wire bar in a wet amount of 8.4 ml/m², and dried at 180° C. for 6 minutes, to prepare an undercoated support.

(Back Layer)

1) Preparation of Coating Liquid for Back Layer

(Preparation of Base Precursor Solid Particle Dispersion Liquid (a))

2.5 kg of the base precursor 1 to be hereinafter illustrated, 300 g of a surfactant DEMOL N (trade name, available from Kao Corporation), 800 g of diphenyl sulfone, and 1.0 g of benzoisothiazolinone sodium salt were mixed with distilled water into the total amount of 8.0 kg. The mixture liquid was fed by a diaphragm pump to a horizontal-type sand mill UVM-2 manufactured by Imex Co., which was packed with zirconia beads having the average diameter of 0.5 mm, and bead-dispersed in the mill under an inner pressure of 50 hPa or higher until the desired average particle diameter was obtained.

The dispersion process was carried out while conducting an optical absorption measurement until the ratio of the absorbencies at 450 nm and 650 nm (D450/D650) became 3.0. The obtained dispersion was diluted with distilled water until the base precursor concentration became 25% by weight, and filtrated by a polypropylene filter having an average pore diameter of 3 μm to remove extraneous substances.

2) Preparation of Dye Solid Particle Dispersion Liquid

6.0 kg of the cyanine dye 1 to be hereinafter illustrated, 3.0 kg of sodium p-dodecylbenzenesulfonate, 0.6 kg of a surfactant DEMOL SNB available from Kao Corporation, and 0.15 kg of an antifoaming agent SURFYNOL 104E (trade name, available from Nissin Chemical Industry Co., Ltd.) were mixed with distilled water into the total amount of 60 kg. The mixture liquid was dispersed in the presence of 0.5 mm zirconia beads by using a horizontal-type sand mill UVM-2 manufactured by Imex Co.

The dispersion process was carried out while conducting an optical absorption measurement until the ratio of the absorbencies at 650 nm and 750 nm (D650/D750) became 5.0 or more. The obtained dispersion was diluted with distilled water until the cyanine dye concentration became 6% by mass, and filtrated by a filter having an average pore diameter of 1 μm to remove extraneous substances.

3) Preparation of Coating Liquid for Antihalation Layer

40 g of gelatin, 0.1 g of benzoisothiazolinone, and 490 ml of water were added to a vessel to dissolve the gelatin while keeping the temperature of the vessel at 40° C. Further, to this were added 2.3 ml of a 1 mol/l aqueous sodium hydroxide solution, 40 g of the above dye solid particle dispersion liquid, 90 g of the above base precursor solid particle dispersion liquid (a), 12 ml of a 3% by mass aqueous solution of sodium polystyrene sulfonate, and 180 g an 10% by mass SBR latex. 80 ml of a 4% by mass aqueous solution of N,N-ethylenebis(vinylsulfoneacetamide) was added to the resultant mixture immediately before coating, to give an antihalation layer coating liquid.

4) Preparation of Coating Liquid for Back Protective Layer

<<Preparation of Back Protective Layer Coating Liquid 1>>

40 g of gelatin, 35 mg of benzoisothiazolinone, and 840 ml of water were added to a vessel to dissolve the gelatin while keeping the temperature of the vessel at 40° C. Further, to this were added 5.8 ml of a 1 moil aqueous sodium hydroxide solution, 5 g of a 10% by mass emulsion of a liquid paraffin, 5 g of a 10% by mass emulsion of triisostearic acid trimethylolpropane, 10 ml of a 5% by mass aqueous solution of sodium di(2-ethylhexyl)sulfosuccinate, 20 ml of a 3% by mass aqueous solution of sodium polystyrenesulfonate, 2.4 ml of a 2% by mass solution of a fluorochemical surfactant (FF-1), 2.4 ml of a 2% by mass solution of a fluorochemical surfactant (FF-2), and 32 g of a 19% by mass latex liquid of a methyl methacrylate/styrene/butyl acrylate/hydroxyethyl methacrylate/acrylic acid copolymer (copolymerization weight ratio 57/8/28/5/2). 25 ml of a 4% by mass aqueous solution of N,N-ethylenebis(vinylsulfoneacetamide) was added to the resultant mixture immediately before coating, to give a back protective layer coating liquid.

5) Application of Back Layer

The back surface of the undercoated support was subjected to simultaneous multilayer coating with the antihalation layer coating liquid and the back protective layer coating liquid, and the applied liquids were dried to form a back layer. The antihalation layer coating liquid was applied such that the application amount of the gelatin was 0.52 g/m², and the back protective layer coating liquid was applied such that the application amount of the gelatin was 1.7 g/m².

(Image-Forming Layer, Intermediate Layers, and Surface Protective Layer)

1. Preparation of Coating Materials

1) Silver Halide Emulsion

<<Preparation of Silver Halide Emulsion 1>>

3.1 ml of a 1% by mass potassium bromide solution was added to 1421 ml of distilled water, and 3.5 ml of a 0.5 mol/ sulfuric acid solution and 31.7 g of phthalated gelatin were further added thereto. While stirring the resulting liquid in a stainless reaction pot at 30° C., a solution A prepared by diluting 22.22 g of silver nitrate with distilled water into 95.4 ml and a solution B prepared by diluting 15.3 g of potassium bromide and 0.8 g of potassium iodide with distilled water into 97.4 ml were added to the liquid at the constant flow rate over 45 seconds. Then, 10 ml of a 3.5% by mass aqueous hydrogen peroxide solution was added to the resultant mixture, and 10.8 ml of 10% by mass aqueous benzoimidazole solution was further added. Further, a solution C prepared by diluting 51.86 g of silver nitrate with distilled water to 317.5 ml and a solution D prepared by diluting 44.2 g of potassium bromide and 2.2 g of potassium iodide with distilled water to 400 ml were added to the mixture. The solution C was added over 20 minutes at a constant flow rate, and the solution D was added by a controlled double jet method while adjusting the pAg value to 8.1. 10 minutes after starting the addition of the solutions C and D, potassium hexachloroiridate (II) was added to the mixture in an amount of 1×10⁻⁴ mol per 1 mol of silver. Further, 5 seconds after completing the addition of the solution C, an aqueous solution of potassium iron (II) hexacyanide was added to the mixture in an amount of 3×10⁻⁴ mol per 1 mol of silver. The pH value of the resulting mixture was adjusted to 3.8 using a 0.5 mol/l sulfuric acid, then the stirring was stopped, and the mixture was subjected to precipitation, desalination, and water-washing. The pH value of the mixture was adjusted to 5.9 using a 1 mol/l sodium hydroxide to prepare a silver halide dispersion 1 with pAg of 8.0.

5 ml of a 0.34% by mass methanol solution of 1,2-benzoisothiazoline-3-one was added to the silver halide dispersion 1 while stirring the dispersion at 38° C., and 40 minutes after the addition, the resulting mixture was heated to 47° C. 20 minutes after the heating, a methanol solution of sodium benzenethiosulfonate was added to the mixture in an amount of 7.6×10⁻⁵ mol per 1 mol of silver. Further, 5 minutes after the addition, a methanol solution of the tellurium sensitizer C hereinafter illustrated was added to the mixture in an amount of 2.9×10⁻⁴ mol per 1 mol of silver, and the mixture was ripened for 91 minutes. A methanol solution of a 3/1 mole ratio mixture of the spectrally sensitizing dyes A and B was added to the mixture such that the total amount of the dyes A and B was 1.2×10⁻³ mol per 1 mol of silver. 1 minute after the addition, 1.3 ml of a 0.8% by mass methanol solution of N,N′-dihydroxy-N″-diethylmelamine was added to the mixture, and 4 minutes after the addition, a methanol solution of 5-methyl-2-mercaptobenzoimidazole, a methanol solution of 1-phenyl-2-heptyl-5-mercapto-1,3,4-triazole, and an aqueous solution of 1-(3-methylureidophenyl)-5-mercaptotetrazole were added thereto to prepare a silver halide emulsion 1. The amounts of 5-methyl-2-mercaptobenzoimidazole, 1-phenyl-2-heptyl-5-mercapto-1,3,4-triazole, and 1-(3-methylureidophenyl)-5-mercaptotetrazole were 4.8×10⁻³ mol, 5.4×10⁻³ mol, and 8.5×10⁻³ mol, per 1 mol of silver, respectively.

The prepared silver halide emulsion comprised silver iodobromide grains, which had an average equivalent sphere diameter of 0.042 μm and an equivalent sphere diameter variation coefficient of 20%, and included 3.5 mol % of iodo uniformly. The grain diameter, etc. was an average value of 1,000 grains obtained using an electron microscope. The grains had a {100} face proportion of 80%, obtained by the Kubelka-Munk method.

<<Preparation of Silver Halide Emulsion 2>>

A silver halide dispersion 2 was prepared in the same manner as the silver halide dispersion 1 except that the liquid temperature was changed from 30° C. to 47° C. in the grain formation, the solution B was prepared by diluting 15.9 g of potassium bromide with distilled water to 97.4 ml, the solution D was prepared by diluting 45.8 g of potassium bromide with distilled water to 400 ml, the solution C was added over 30 minutes, and potassium iron (II) hexacyanide was not used. The precipitation, desalination, water-washing, and dispersion were carried out in the same manner as the preparation of the silver halide dispersion 1. Further, the silver halide dispersion 2 was subjected to the steps of the spectral sensitization, the chemical sensitization, and the addition of 5-methyl-2-mercaptobenzoimidazole and 1-phenyl-2-heptyl-5-mercapto-1,3,4-triazole in the same manner as the preparation of the silver halide emulsion 1 except that the amount of the tellurium sensitizer C was 1.1×10⁻⁴ mol, methanol solution of a 3/1 mol ratio mixture of the spectrally sensitizing dyes A and B was added such that the total amount of the sensitizing dyes A and B was 7.0×10⁻⁴ mol, the amount of 1-phenyl-2-heptyl-5-mercapto-1,3,4-triazole was 3.3×10⁻³ mol, and the amount of 1-(3-methylureidophenyl)-5-mercaptotetrazole was 4.7×10⁻³ mol, per 1 mol of silver, to prepare a silver halide emulsion 2. The silver halide emulsion 2 comprised cuboidal pure silver bromide grains having an average equivalent sphere diameter of 0.080 μm and an equivalent sphere diameter variation coefficient of 20%.

<<Preparation of Silver Halide Emulsion 3>>

A silver halide dispersion 3 was prepared in the same manner as the silver halide dispersion 1 except that the liquid temperature was changed from 30° C. to 27° C. in the grain formation. The precipitation, desalination, water-washing, and dispersion were carried out in the same manner as the preparation of the silver halide dispersion 1. Then, a silver halide emulsion 3 was prepared from the silver halide dispersion 3 in the same manner as the preparation of the silver halide emulsion 1 except that a solid dispersion (an aqueous gelatin solution) of a 1/1 mole ratio mixture of the spectrally sensitizing dyes A and B was added such that the total amount of the dyes A and B was 6×10⁻³ mol per 1 mol of silver, the amount of the tellurium sensitizer C was 5.2×10⁻⁴ mol per 1 mol of silver, and 3 minutes after the addition of the tellurium sensitizer, 5×10⁻⁴ mol of bromoauric acid and 2×10⁻³ mol of potassium thiocyanate were added per 1 mol of silver. The prepared silver halide emulsion 3 comprised silver iodobromide grains, which had an average equivalent sphere diameter of 0.034 μm and an equivalent sphere diameter variation coefficient of 20%, and included 3.5 mol % of iodo uniformly.

<<Preparation of Mixed Emulsion A for Coating Liquid>>

70% by mass of the silver halide emulsion 1, 15% by mass of the silver halide emulsion 2, and 15% by mass of the silver halide emulsion 3 were mixed, and a 1% by mass aqueous solution of benzothiazolium iodide was added to the mixed emulsion such that the amount of benzothiazolium iodide was 7×10⁻³ mol per 1 mol of silver. The above “% by mass” is based on the mass of the resultant mixed emulstion.

Further, to the mixed emulsion was added the compounds 1, 2, and 3, whoes one-electron oxidized form can release 1 or more electron(s). The amount of each of the compounds 1, 2, and 3 was 2×10⁻³ mol per 1 mol of silver in the silver halide.

Then the adsorbent redox compounds 1 and 2 having an adsorbent group and a reducing group were added to the mixed emulsion. The amount of each of adsorbent redox compounds 1 and 2 was 5×10⁻³ mol per 1 mol of the silver halide.

Water was added to the mixed emulsion for the coating liquid such that the silver amount of the silver halide was 38.2 g per 1 kg of the mixed emulsion. Further, 1-(3-methylureidophenyl)-5-mercaptotetrazole was added such that the amount thereof was 0.34 g per 1 kg of the mixed emulsion.

2) Preparation of Organic Silver Salt Dispersion

<Preparation of Recrystallized Behenic Acid A>

100 kg of behenic acid EDENOR C22-85R (trade name, available from Henkel) was mixed with 1,200 kg of isopropyl alcohol, dissolved therein at 50° C., filtrated using a 10 μm filter, and cooled to 30° C. to recrystallize the behenic acid. The cooling rate for the recrystallization was controlled at 3° C./hour. The prepared crystal was subjected to centrifugal filtration and washed by pouring 100 kg of isopropyl alcohol, and the above recrystallization was repeated twice. Precipitates generated in the initial stage of the recrystallization were filtrated to remove lignoceric acid, and the resultant crystal was dried. Then, the crystal was esterified and subjected to a GC-FID measurement. As a result, the crystal included 99.99 mol % of behenic acid and 0.000001 mol % or less of erucic acid.

<Preparation of Recrystallized Stearic Acid>

100 kg of stearic acid available from Tokyo Kasei Kogyo Co., Ltd. was mixed with 1,200 kg of isopropyl alcohol, dissolved therein at 50° C., filtrated using a 10 μm filter, and cooled to 20° C. to recrystallize the stearic acid. The cooling rate for the recrystallization was controlled at 3° C./hour. The prepared crystal was subjected to centrifugal filtration and washed by pouring 100 kg of isopropyl alcohol, and the above recrystallization was repeated twice. Precipitates generated in the initial stage of the recrystallization were filtrated to remove carboxylic acids longer than stearic acid, and the resultant crystal was dried. Then, the crystal was esterified and subjected to a GC-FID measurement. As a result, the crystal included 99.99 mol % of stearic acid and 0.000001 mol % or less of erucic acid.

(Preparation of Organic Silver Salt Dispersion A)

40 g of the recrystallized behenic acid A, 7.3 g of the recrystallized stearic acid, and 500 ml of water were mixed and stirred at 90° C. for 15 minutes, and to this was added 187 ml of a 1 N NaOH solution over 15 minutes. Further, 61 ml of a 1 N aqueous nitric acid solution was added to the mixture, and the resultant mixture was cooled to 50° C. Then, 124 ml of a 1 N aqueous silver nitrate solution was added to the mixture over 2 minutes, and stirred for 30 minutes. The solid contents were isolated from the mixture by vacuum filtration, and water-washed until the washing water had a conductivity of 30 μS/cm. The obtained solid contents were stored in the form of a wet cake without drying.

The obtained crystals included 82 mol % of behenic acid and 18 mol % of stearic acid.

To the wet cake with a dry solid content of 34.8 g were added 12 g of polyvinyl alcohol and 150 ml of water, and the resultant was well mixed to obtain a slurry. The slurry was placed in a vessel together with 840 g of zirconia beads having an average diameter of 0.5 mm, and dispersed for 5 hours by a dispersion apparatus ¼G sand grinder mill manufactured by Imex Co., to prepare an organic silver salt dispersion A. The organic silver salt dispersion A comprised needle-shaped grains having an average shorter axis length of 0.04 μm, an average longer axis length of 0.8 μm, and a projected area variation coefficient of 30%, which were obtained by an electron microscope observation.

3) Preparation of Reducing Agent Dispersion

<<Preparation of Reducing Agent 1 Dispersion>>

10 kg of water was sufficiently mixed with 10 kg of the reducing agent 1 (6,6′-di-t-butyl-4,4′-dimethyl-2,2′-butylidenediphenol) and 16 kg of a 10% by mass aqueous solution of a modified polyvinyl alcohol POVAL MP203 available from Kuraray Co., Ltd., to obtain a slurry. The slurry was transported by a diaphragm pump to a horizontal-type sand mill UVM-2 manufactured by Imex Co., which was packed with zirconia beads having the average diameter of 0.5 mm, and dispersed therein for 3.5 hours. Then, 0.2 g of benzoisothiazolinone sodium salt and water were added to the dispersed slurry such that the content of the reducing agent was 25% by mass. Thus-obtained dispersion liquid was maintained at 40° C. for 1 hour, and maintained at 80° C. for 1 hour to obtain a reducing agent 1 dispersion. The reducing agent 1 dispersion included reducing agent particles having a median size of 0.50 μm and a maximum particle size of 1.6 μm or less. The reducing agent 1 dispersion was filtrated by a polypropylene filter having a pore diameter of 3.0 μm to remove extraneous substances such as dust, and then stored.

4) Preparation of Hydrogen-Bonding Compound 1 Dispersion

10 kg of water was sufficiently mixed with 10 kg of the hydrogen-bonding compound 1 (tri(4-t-butylphenyl)phosphine oxide) and 16 kg of a 10% by mass aqueous solution of a modified polyvinyl alcohol POVAL MP203 available from Kuraray Co., Ltd., to obtain a slurry. The slurry was transported by a diaphragm pump to a horizontal-type sand mill UVM-2 manufactured by Imex Co., which was packed with zirconia beads having an average diameter of 0.5 mm, and dispersed therein for 4 hours. Then, 0.2 g of benzoisothiazolinone sodium salt and water were added to the dispersed slurry such that the content of the hydrogen-bonding compound was 25% by mass. Thus-obtained dispersion liquid was maintained at 40° C. for 1 hour, and further maintained at 80° C. for 1 hour to obtain a hydrogen-bonding compound 1 dispersion. The hydrogen-bonding compound 1 dispersion included hydrogen-bonding compound particles having a median size of 0.45 μm and a maximum particle size of 1.3 μm or smaller. The hydrogen-bonding compound 1 dispersion was filtrated by a polypropylene filter having a pore diameter of 3.0 μm to remove extraneous substances such as dust, and then stored.

5) Preparation of Development Accelerator 1 Dispersion

10 kg of water was sufficiently mixed with 10 kg of the development accelerator 1 and 20 kg of a 10% by mass aqueous solution of a modified polyvinyl alcohol POVAL MP203 available from Kuraray Co., Ltd., to obtain a slurry. The slurry was transported by a diaphragm pump to a horizontal-type sand mill UVM-2 manufactured by Imex Co., which was packed with zirconia beads having an average diameter of 0.5 mm, and dispersed therein for 3.5 hours. Then, 0.2 g of benzoisothiazolinone sodium salt and water were added to the dispersed slurry such that the content of the development accelerator was 20% by mass, to obtain a development accelerator 1 dispersion. The development accelerator 1 dispersion included development accelerator particles having a median size of 0.48 μm and a maximum particle size of 1.4 μm or less. The development accelerator 1 dispersion was filtrated by a polypropylene filter having a pore diameter of 3.0 μm to remove extraneous substances such as dust, and then stored.

6) Preparation of Development Accelerator 2 Dispersion and Color Tone Controlling Agent 1 Dispersion

A 20% by mass solid dispersion of the development accelerator 2 and a 15% by mass solid dispersion of the color tone controlling agent 1 were prepared in the same manner as the development accelerator 1 dispersion, respectively.

7) Preparation of Polyhalogen Compounds

<<Preparation of Organic Polyhalogen Compound 1 Dispersion>>

10 kg of the organic polyhalogen compound 1 (tribromomethanesulfonylbenzene), 10 kg of a 20% by mass aqueous solution of a modified polyvinyl alcohol POVAL MP203 available from Kuraray Co., Ltd., 0.4 kg of a 20% by mass aqueous solution of sodium triisopropylnaphthalenesulfonate, and 14 kg of water were sufficiently mixed to obtain a slurry. The slurry was transported by a diaphragm pump to a horizontal-type sand mill UVM-2 manufactured by Imex Co. which was packed with zirconia beads having an average diameter of 0.5 mm, and dispersed therein for 5 hours. Then, 0.2 g of benzoisothiazolinone sodium salt and water were added to the dispersed slurry such that the content of the organic polyhalogen compound was 26% by mass, to obtain an organic polyhalogen compound 1 dispersion. The organic polyhalogen compound 1 dispersion included organic polyhalogen compound particles having a median size of 0.41 μm and a maximum particle size of 2.0 μm or less. The organic polyhalogen compound 1 dispersion was filtrated by a polypropylene filter having a pore diameter of 10.0 μm to remove extraneous substances such as dust, and then stored.

<<Preparation of Organic Polyhalogen Compound 2 Dispersion>>

10 kg of the organic polyhalogen compound 2 (N-butyl-3-tribromomethanesulfonylbenzoamide), 20 kg of a 10% by mass aqueous solution of a modified polyvinyl alcohol POVAL MP203 available from Kuraray Co., Ltd., and 0.4 kg of a 20% by mass aqueous solution of sodium triisopropylnaphthalenesulfonate were sufficiently mixed to obtain a slurry. The slurry was transported by a diaphragm pump to a horizontal-type sand mill UVM-2 manufactured by Imex Co. which was packed with zirconia beads having an average diameter of 0.5 mm, and dispersed therein for 5 hours. Then, 0.2 g of benzoisothiazolinone sodium salt and water were added to the dispersed slurry such that the content of the organic polyhalogen compound was 30% by mass, and the liquid was maintained at 40° C. for 5 hours to obtain an organic polyhalogen compound 2 dispersion. The organic polyhalogen compound 2 dispersion included organic polyhalogen compound particles having a median size of 0.40 μm and a maximum particle size of 1.3 μm or smaller. The organic polyhalogen compound 2 dispersion was filtrated by a polypropylene filter having a pore diameter of 3.0 μm to remove extraneous substances such as dust, and then stored.

8) Preparation of Phthalazine Compound 1 Solution

8 kg of a modified polyvinyl alcohol MP203 available from Kuraray Co., Ltd. was dissolved in 174.57 kg of water. To the solution were added 3.15 kg of a 20% by mass aqueous solution of sodium triisopropylnaphthalenesulfonate and 14.28 kg of a 70% by mass aqueous solution of the phthalazine compound 1 (6-isopropylphthalazine), to prepare a 5% by mass phthalazine compound 1 solution.

9) Preparation of Mercapto Compounds

<<Preparation of Aqueous Mercapto Compound 1 Solution>>

7 g of the mercapto compound 1 (1-(3-sulfophenyl)-5-mercaptotetrazole sodium salt) was dissolved in 993 g of water to obtain a 0.7% by mass aqueous solution of the mercapto compound 1.

<<Preparation of Aqueous Mercapto Compound 2 Solution>>

20 g of the mercapto compound 2 (1-(3-methylureidophenyl)-5-mercaptotetrazole) was dissolved in 980 g of water to obtain a 2.0% by mass aqueous solution of the mercapto compound 2.

10) Preparation of Pigment 1 Dispersion

250 g of water was sufficiently mixed with 64 g of C. I. Pigment Blue 60 and 6.4 g of DEMOL N available from Kao Corporation, to obtain a slurry. The slurry was placed in a vessel together with 800 g of zirconia beads having an average diameter of 0.5 mm, and dispersed for 25 hours by a dispersion apparatus ¼G sand grinder mill manufactured by Imex Co. The pigment content of the dispersed slurry was adjusted to 5% by mass by addition of water, to prepare a pigment 1 dispersion. The pigment 1 dispersion comprised pigment particles having an average particle diameter of 0.21 μm.

11) Preparation of Latex Liquid

<<Preparation of Binder 1 Liquid>>

An SBR latex was prepared as follows.

287 g of distilled water, 7.73 g of a surfactant PIONINE A43-S available from Takemoto Oil & Fat Co., Ltd. (solid content 48.5% by mass), 14.06 ml of a 1 mol/l NaOH solution, 0.15 g of tetrasodium ethylenediaminetetraacetate, 255 g of styrene, 11.25 g of acrylic acid, and 3.0 g of tert-dodecylmercaptan were placed in a polymerization kettle of a gas monomer reactor TAS-2J manufactured by Taiatsu Techno Corporation. The polymerization kettle was closed and the contents were stirred at a stirring rate of 200 rpm. The resultant mixture was degassed by a vacuum pump, the inner atmosphere of the kettle was replaced with nitrogen gas several times, 108.75 g of 1,3-butadiene was added to the mixture, and the inner temperature was raised to 60° C. Then, a solution prepared by dissolving 1.875 g of ammonium persulfate in 50 ml of water was added to the mixture and stirred for 5 hours. The mixture was heated to 90° C. and further stirred for 3 hours, and the inner temperature was reduced to the room temperature after the reaction. To the resultant mixture were added 1 mol/l solution of NaOH and 1 mol/l solution of NH₄OH such that the mole ratio of Na⁺ ion/NH₄⁺ ion was 1/5.3, whereby the pH value of the mixture was adjusted to 8.4. Then, the mixture was filtrated by a polypropylene filter having a pore diameter of 1.0 μm to remove extraneous substances such as dust, whereby 774.7 g of an SBR latex was obtained. As a result of measuring the halogen ion content of the SBR latex by an ion chromatography, the chloride ion content was found to be 3 ppm. As a result of measuring the chelating agent content of the SBR latex by a high performance liquid chromatography, the chelating agent content was found to be 145 ppm.

The latex had an average particle diameter of 90 nm, Tg of 17° C., a solid content of 44% by mass, an equilibrium moisture content of 0.6% by mass under the conditions of 25° C. and 60% RH, and an ionic conductivity of 4.80 mS/cm. The ionic conductivity was obtained by measuring the ionic conductivity of the undiluted latex liquid (44% by mass) at 25° C. by a conductivity meter CM-30S available from DKK-TOA Co.

2. Preparation of Coating Liquids

1) Preparation of Image-Forming Layer Coating Liquid 1

1,000 g of the fatty acid silver salt dispersion A, 135 ml of water, 36 g of the pigment 1 dispersion, 25 g of the organic polyhalogen compound 1 dispersion, 39 g of the organic polyhalogen compound 2 dispersion, 171 g of the phthalazine compound 1 solution, 1,060 g of the latex liquid (Tg 17° C.), 153 g of the reducing agent 1 dispersion, 55 g of the hydrogen-bonding compound 1 dispersion, 4.8 g of the development accelerator 1 dispersion, 5.2 g of the development accelerator 2 dispersion, 2.1 g of the color tone controlling agent 1 dispersion, and 8 ml of the aqueous mercapto compound 2 solution were successively mixed, and 140 g of the silver halide mixed emulsion A was added to the mixture and well mixed immediately before the application. Thus obtained image-forming layer coating liquid 1 was directly transported to a coating die and applied.

The image-forming layer coating liquid 1 had a viscosity of 40 mPa·s, measured by a B-type viscometer available from Tokyo Keiki Co,. Ltd. at 40° C. (No. 1 rotor, 60 rpm).

The viscosity of the image-forming layer coating liquid 1, obtained by RheoStress RS150 manufactured by Haake at 38° C., was 30, 43, 41, 28, and 20 [mPa·s] at a shear rate of 0.1, 1, 10, 100, and 1000 [1/second], respectively.

The zirconium content of the image-forming layer coating liquid 1 was 0.30 mg per 1 g of silver.

<<Preparation of Image-Forming Layer Coating Liquids 2 to 18>>

Image-forming layer coating liquids 2 to 18 were prepared in the same manner as the image-forming layer coating liquid 1 except that the latex was changed to the latex shown in Table 2. The amount of each latex was controlled so as to obtain the same binder solid content as that of the image-forming layer coating liquid 1.

2) Preparation of Intermediate Layer A Coating Liquids

<<Preparation of Intermediate Layer A Coating Liquid 1>>

To a mixture of 1,000 g of polyvinyl alcohol PVA-205 available from Kuraray Co., Ltd., 163 g of the pigment 1 dispersion, 33 g of a 18.5% by mass aqueous solution of the blue dye 1 (KAYAFECT TURQUOISE RN LIQUID 150 available from Nippon Kayaku Co., Ltd.), 27 ml of a 5% by mass aqueous solution of sodium di(2-ethylhexyl)sulfosuccinate, and 4,200 ml of a 19% by mass latex liquid of a methyl methacrylate/styrene/butyl acrylate/hydroxyethyl methacrylate/acrylic acid copolymer (copolymerization weight ratio 57/8/28/5/2) were added 27 ml of a 5% by mass aqueous solution of AEROSOL OT available from American Cyanamid Co., 135 ml of a 20% by mass aqueous solution of diammonium phthalate, and water such that the total amount was 10,000 g. The pH value of the resultant mixture was adjusted to 7.5 with NaOH to obtain an intermediate layer A coating liquid 1. The intermediate layer A coating liquid 1 was transported to a coating die such that the amount of the liquid is 8.9 ml/m².

The intermediate layer A coating liquid 1 had a viscosity of 58 mPa·s, measured by a B-type viscometer at 40° C. (No. 1 rotor, 60 rpm).

<<Preparation of Intermediate Layer A Coating Liquids 2 to 18>>

Intermediate layer A coating liquids 2 to 18 were prepared in the same manner as the intermediate layer coating liquid 1 except for using the binders shown in Table 2 instead of the polyvinyl alcohol PVA-205 and the methyl methacrylate/styrene/butyl acrylate/hydroxyethyl methacrylate/acrylic acid copolymer, such that the amount of the solid of the binder was the same as in the intermediate layer A coating liquid 1.

3) Preparation of Intermediate Layer B Coating Liquids

<<Preparation of Intermediate Layer B Coating Liquid 1>>

100 g of an inert gelatin and 10 mg of benzoisothiazolinone were dissolved in 840 ml of water, and to this were added 180 g of a 19% by mass latex liquid of a methyl methacrylate/styrene/butyl acrylate/hydroxyethyl methacrylate/acrylic acid copolymer (copolymerization weight ratio 57/8/28/5/2), 46 ml of a 15% by mass methanol solution of phthalic acid, and 5.4 ml of a 5% by mass aqueous solution of sodium di(2-ethylhexyl)sulfosuccinate. Immediately before the application, the mixture was mixed with 40 ml of a 4% by mass chromium alum by a static mixer to prepare an intermediate layer B coating liquid 1. The intermediate layer B coating liquid 1 was transported to a coating die such that the amount of the liquid is 26.1 ml/m².

The intermediate layer B coating liquid 1 had a viscosity of 20 mPa·s, measured by a B-type viscometer at 40° C. (No. 1 rotor, 60 rpm).

4) Preparation of Outermost Layer Coating Liquid

<<Preparation of Outermost Layer Coating Liquids 1 to 9>>

100 g of inert gelatin and 10 mg of benzoisothiazolinone were dissolved in 800 ml of water, and to this were added 40 g of a 10% by mass emulsion of a liquid paraffin, 40 g of a 10% by mass emulsion of dipentaerythrityl hexaisostearate, 180 g of a 19% by mass latex liquid of a methyl methacrylate/styrene/butyl acrylate/hydroxyethyl methacrylate/acrylic acid copolymer (copolymerization weight ratio 57/8/28/5/2), 40 ml of a 15% by mass methanol solution of phthalic acid, 5.5 ml of a 1% by mass solution of the fluorochemical surfactant (FF-1), 5.5 ml of a 1% by mass aqueous solution of the fluorochemical surfactant (FF-2), 28 ml of a 5% by mass aqueous solution of sodium di(2-ethylhexyl)sulfosuccinate, 4 g of fine polymethyl methacrylate particles (average particle diameter 0.7 μm, the average particle diameter corresponding to 30% point on the cumulative volume-weighted diameter distribution), and 21 g of fine polymethyl methacrylate particles (average particle diameter 3.6 μm, the average particle diameter corresponding to 60% point on the cumulative volume-weighted diameter distribution) to prepare a surface protective layer coating liquid. The coating liquid was transported to a coating die such that the amount of the liquid is 8.3 ml/m².

The coating liquid had a viscosity of 19 mPa·s, measured by a B-type viscometer at 40° C. (No. 1 rotor, 60 rpm).

<<Preparation of Outermost Layer Coating Liquids 10 to 18>>

Outermost layer coating liquids 10 to 18 were prepared in the same manner as the outermost layer coating liquid 1 except for using a latex LP-18 shown in Table 2 instead of the inert gelatin and the latex of the methyl methacrylate/styrene/butyl acrylate/hydroxyethyl methacrylate/acrylic acid copolymer (copolymerization weight ratio 57/8/28/5/2) in the same weight.

3. Production of Photothermographic Materials

1) Production of Photothermographic Material 1

The image-forming layer coating liquid 1, the intermediate layer A coating liquid 1, the intermediate layer B coating liquid 1, and the outermost layer coating liquid 1 were applied in this order onto the surface opposite to the back surface of the support by simultaneous multilayer coating using a slide-bead application method, to produce a photothermographic material 1. The image-forming layer coating liquid 1 and the intermediate layer A coating liquid 1 were controlled at 31° C., the intermediate layer B coating liquid 1 was controlled at 36° C., and the outermost layer coating liquid was controlled at 37° C.

The application amounts (g/m²) of the components of the image-forming layer were as follows.

| | |
|---|---|
| Organic silver salt | 4.878 |
| Pigment (C. I. Pigment Blue 60) | 0.0324 |
| Polyhalogen compound 1 | 0.108 |
| Polyhalogen compound 2 | 0.225 |
| Phthalazine compound 1 | 0.161 |
| SBR latex | 8.73 |
| Reducing agent 1 | 0.36 |
| Reducing agent 2 | 0.36 |
| Hydrogen-bonding compound 1 | 0.522 |
| Development accelerator 2 | 0.018 |
| Mercapto compound 1 | 0.0018 |
| Mercapto compound 2 | 0.0108 |
| Silver halide (Ag content) | 0.09 |

In the photothermographic material 1, the total amount of applied silver was 1.18 g/m².

The conditions for the application and drying were as follows.

The application was carried out at the rate of 160 m/min. The distance between the support and the tip of the coating die was 0.10 to 0.30 mm. The inner pressure of the decompression chamber was 196 to 882 Pa-lower than the atmospheric pressure. The support was subjected to electrical neutralization by an ionic wind before the application.

The coating liquid was cooled by a wind having a dry-bulb temperature of 10 to 20° C. in the chilling zone. Then the coating liquid was contactless-transported and dried by a helical type contactless drying apparatus using a drying wind having the dry-bulb temperature of 23 to 45° C. and the wet-bulb temperature of 15 to 21° C.

After the drying, the moisture content was controlled by leaving the photothermographic material in a condition of 25° C., 40 to 60% RH. Then, the dried layer was heated to 70 to 90° C. and cooled to 25° C.

2) Production of Photothermographic Materials 2 to 18

Photothermographic materials 2 to 18 were produced in the same manner as the photothermographic material 1 except for using the combination shown in Table 2 of an image-forming layer coating liquid, an intermediate layer A coating liquid, an intermediate layer B coating liquid, and an outermost layer coating liquid, in each photothermographic material. The applied silver amounts (g/m²) of the materials were the same as that of the photothermographic material 1.

The chemical structures of the compounds used in Example 1 are shown below. 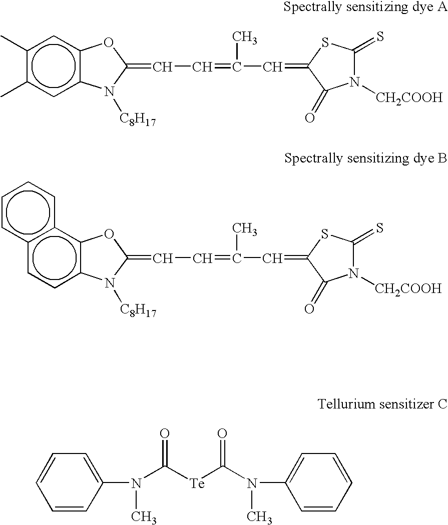
Compound 1 whose one-electron oxidant can release 1 or more electrons) 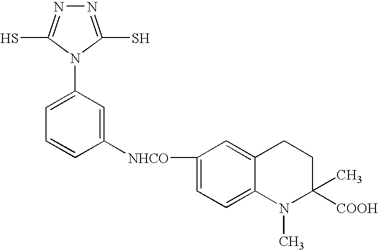
Compound 1 whose one-electron oxidant can release 1 or more electron(s) 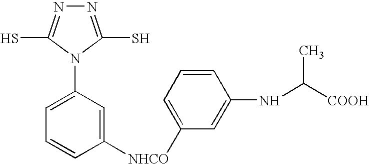
Compound 3 whose one-electron oxidant can release 1 or more electron(s) 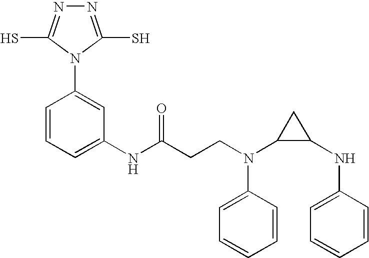
Adsorbent redox compound 1 having adsorbent group and reducing group 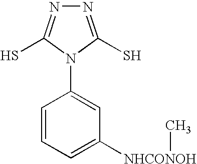
Adsorbent redox compound 2 having adsorbent group and reducing group 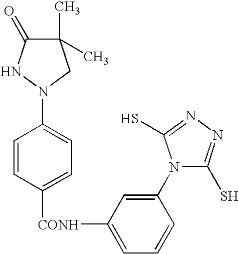 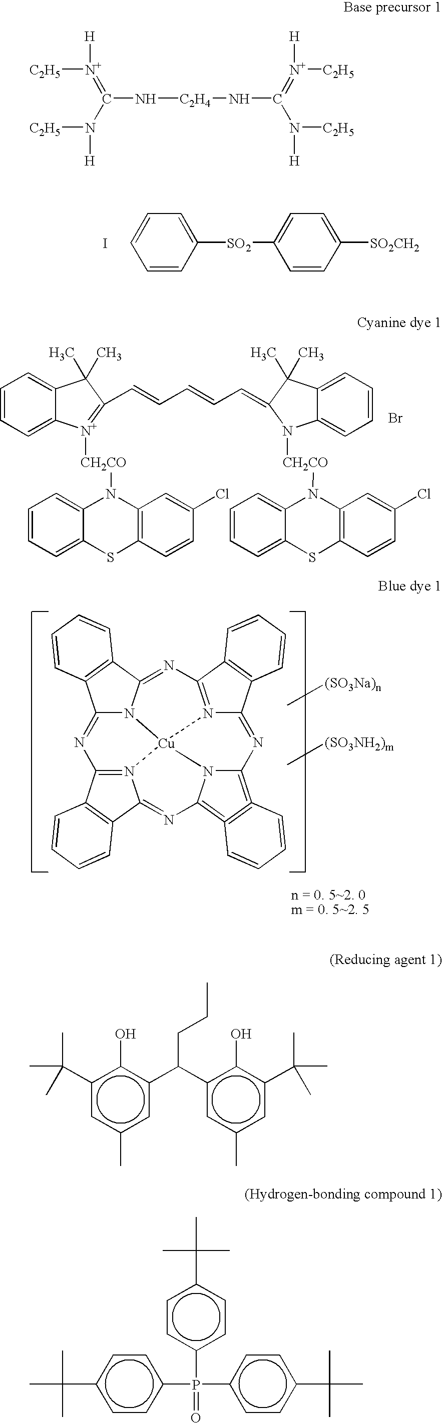 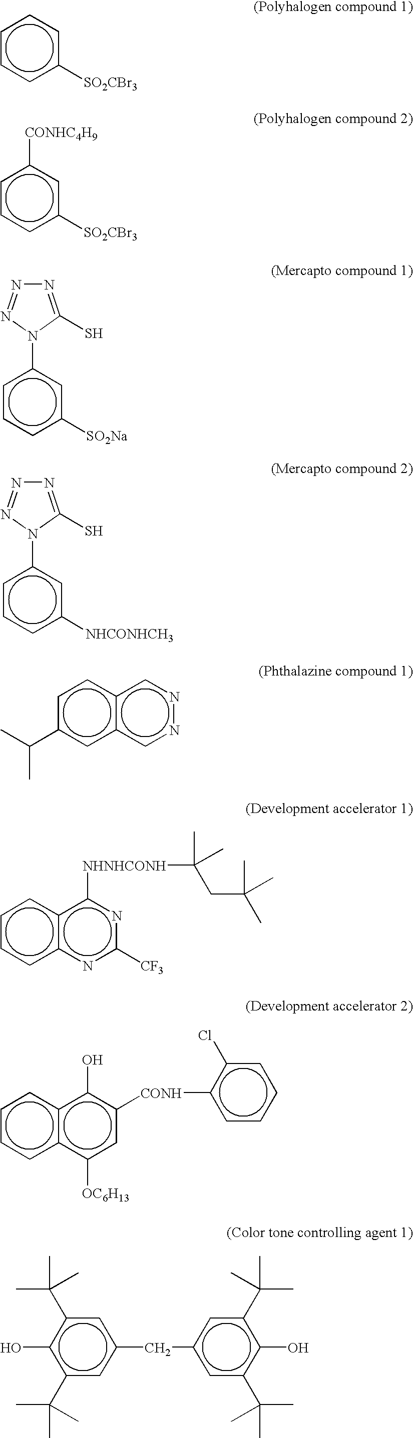 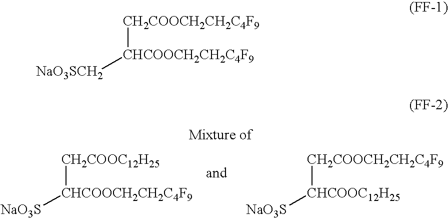
4. Evaluation of Photographic Properties
1) Preparation

The obtained samples were cut into a half size (length of 43 cm and a width of 35 cm), enclosed in the following packaging material under conditions of 25° C. and 50% RH, stored at the ordinary temperature for 2 weeks, and subjected to the following evaluation, respectively.

2) Packaging Material

Structure: (10-μm PET)-12-μm PE)-(9-μm aluminum foil)(15-μm Ny)-50-μm polyethylene including 3% by mass of carbon)
Oxygen permeability: 0.02 ml/atm·m²·25° C.·day
Water permeability: 0.10 g/atm·m²·25° C.·day
   3) Exposure and Development

Each of the photothermographic materials 1 to 18 was exposed and heat-developed by Fuji Medical Dry Laser Imager DRYPIX 7000 equipped with a 660 nm semiconductor laser having the maximum output of 50 mW (IIB). The material was heat-developed for 14 seconds using three panel heaters controlled at 107° C., 121° C., and 121° C. respectively. Thus-obtained image was evaluated by a densitometer. Each material was transported at a conveying speed of 28 mm/sec in the heat development.

4) Evaluation of Photographic Properties

<Dark Heat Image Storability>

Each of the heat-developed photothermographic materials 1 to 18 was stored in darkness for 72 hours under conditions of a temperature of 60° C. and a relative humidity of 80%, to evaluate the dark heat image storability in a short time (accelerated test). A photothermographic material poor in the dark heat image storability showed image density reduction in the storage. A portion with an initial density of 2.6 was evaluated with respect to the image density reduction, to obtain the dark heat image storability. The dark heat image storabilities were shown in Table 2 as relative values to that of the photothermographic material 1. The smaller the value is, the better the dark heat image storability of the material is.

The results of the evaluation are shown in Table 2.

TABLE 2

| | Binder | | | | | |
|---|---|---|---|---|---|---|
| Photo- | | | | Image- | Dark heat | |
| thermographic | Outermost | Intermediate | Intermediate | forming | image | |
| material | layer | layer B | layer A | layer | storability | Note |
| 1 | Gelatin/Latex = | Gelatin/Latex = | PVA/Latex = | SBR | 100 | Comp. Ex. |
| | 100/34.2 | 100/34.2 | 10/8 | | | |
| 2 | Gelatin/Latex = | Gelatin/Latex = | SBR | SBR | 89 | Comp. Ex. |
| | 100/34.2 | 100/34.2 | | | | |
| 3 | Gelatin/Latex = | Gelatin/Latex = | PVA/Latex = | P-1 | 98 | Comp. Ex. |
| | 100/34.2 | 100/34.2 | 10/8 | | | |
| 4 | Gelatin/Latex = | Gelatin/Latex = | SBR | P-1 | 35 | Present |
| | 100/34.2 | 100/34.2 | | | | invention |
| 5 | Gelatin/Latex = | Gelatin/Latex = | SBR | P-2 | 42 | Present |
| | 100/34.2 | 100/34.2 | | | | invention |
| 6 | Gelatin/Latex = | Gelatin/Latex = | SBR | P-5 | 39 | Present |
| | 100/34.2 | 100/34.2 | | | | invention |
| 7 | Gelatin/Latex = | Gelatin/Latex = | P-1 | P-1 | 33 | Present |
| | 100/34.2 | 100/34.2 | | | | invention |
| 8 | Gelatin/Latex = | Gelatin/Latex = | SBR | LP-18 | 109 | Comp. Ex. |
| | 100/34.2 | 100/34.2 | | | | |
| 9 | Gelatin/Latex = | Gelatin/Latex = | SBR | LP-36 | 122 | Comp. Ex. |
| | 100/34.2 | 100/34.2 | | | | |
| 10 | LP-18 | Gelatin/Latex = | PVA/Latex = | SBR | 99 | Comp. Ex. |
| | | 100/34.2 | 10/8 | | | |
| 11 | LP-18 | Gelatin/Latex = | SBR | SBR | 86 | Comp. Ex. |
| | | 100/34.2 | | | | |
| 12 | LP-18 | Gelatin/Latex = | PVA/Latex = | P-1 | 95 | Comp. Ex. |
| | | 100/34.2 | 10/8 | | | |
| 13 | LP-18 | Gelatin/Latex = | SBR | P-1 | 31 | Present |
| | | 100/34.2 | | | | invention |
| 14 | LP-18 | Gelatin/Latex = | SBR | P-2 | 32 | Present |
| | | 100/34.2 | | | | invention |
| 15 | LP-18 | Gelatin/Latex = | SBR | P-5 | 34 | Present |
| | | 100/34.2 | | | | invention |
| 16 | LP-18 | Gelatin/Latex = | P-1 | P-1 | 27 | Present |
| | | 100/34.2 | | | | invention |
| 17 | LP-18 | Gelatin/Latex = | SBR | LP-18 | 105 | Comp. Ex. |
| | | 100/34.2 | | | | |
| 18 | LP-18 | Gelatin/Latex = | SBR | LP-36 | 118 | Comp. Ex. |
| | | 100/34.2 | | | | |

As shown in Table 2, photothermographic materials having the following structure were excellent in dark heat image storability: the photothermographc materials each comprise the non-photosensitive intermediate layer A adjacent to the image forming layer; the proportion of the hydrophobic polymer to the entire binder in the non-photosensitive intermediate layer A was 50% by mass or higher; and the image-forming layer comprises a polymer latex prepared by copolymerization of monomers including the monomer represented by the formula (M-1). Particularly, when such a photothermographic material had the outermost layer including the latex, the photothermographic material was excellent in storage stability against tackiness and contamination by fingerprints.

Although the composition of each photothermographic material was made suitable for rapid processing under conditions of the heat development time of 14 seconds and the conveying speed of 28 mm/sec in Example 1, the photothermographic materials of the invention having the above particular structures were remarkably excellent in the dark heat image storability.

### Example 2

1) Preparation of Intermediate Layer C Coating Liquid

<<Preparation of Intermediate Layer C Coating Liquid 1>>

The intermediate layer A coating liquid 1 used in Example 1 was used as an intermediate layer C coating liquid 1 in Example 2.

2) Production of Photothermographic Material 21

The image-forming layer coating liquid 4, the intermediate layer A coating liquid 4, the intermediate layer C coating liquid 1, the intermediate layer B coating liquid 4, and the outermost layer coating liquid 3 were applied in this order onto the surface opposite to the back surface of the support by simultaneous multilayer coating using a slide-bead application method, to produce a photothermographic material 21. At the coating, the image-forming layer coating liquid 4, the intermediate layer A coating liquid 4, and the intermediate layer C coating liquid 1 were controlled at 31° C., the intermediate layer B coating liquid 4 was controlled at 36° C., and the outermost layer coating liquid 3 was controlled at 37° C.

The amounts (g/m²) of the applied components of the image-forming layer were the same as those of the photothermographic material 4.

3) Production of Photothermographic Materials 22 to 28

The photothermographic materials 22 to 28 were produced in the same manner as the photothermographic material 21 except for using binders shown in Table 3 in the intermediate layer A and the image-forming layer, respectively.

The obtained photothermographic materials 21 to 28, 4, and 7 were evaluated with respect to the image storability in the same manner as Example 1.

Further, the application speed was changed to 200 n/minute, and the coating surface states of the obtained materials were evaluated.

(Evaluation of Coating Surface States)

Each sample coated at the application speed of 200 m/minute was heat-developed into a density of 1.5, and the number of extraneous substances observed on the coating surface was obtained. The number of extraneous substances per 1 m² was shown in Table 3.

TABLE 3

| Photo- | Binder | | | | | | Coating surface state | |
|---|---|---|---|---|---|---|---|---|
| thermo- | | | | | Image- | Dark heat | (Number of | |
| graphic | | Inter-mediate layer | Inter-mediate | Inter-mediate | forming | image | extraneous | |
| material | Outer-most layer | B | layer C | layer A | layer | storability | substances/m²) | Note |
| 4 | Gelatin/Latex = | Gelatin/Latex = | — | SBR | P-1 | 35 | 15 | Present invention |
| | 100/34.2 | 100/34.2 | | | | | | |
| 21 | Gelatin/Latex = | Gelatin/Latex = | PVA/Latex = | SBR | P-1 | 32 | 3 | Present invention |
| | 100/34.2 | 100/34.2 | 10/8 | | | | | |
| 22 | Gelatin/Latex = | Gelatin/Latex = | PVA/Latex = | SBR | P-2 | 33 | 2 | Present invention |
| | 100/34.2 | 100/34.2 | 10/8 | | | | | |
| 23 | Gelatin/Latex = | Gelatin/Latex = | PVA/Latex = | SBR | P-5 | 30 | 5 | Present invention |
| | 100/34.2 | 100/34.2 | 10/8 | | | | | |
| 7 | Gelatin/Latex = | Gelatin/Latex = | — | P-1 | P-1 | 33 | 12 | Present invention |
| | 100/34.2 | 100/34.2 | | | | | | |
| 24 | Gelatin/Latex = | Gelatin/Latex = | PVA/Latex = | P-1 | P-1 | 37 | 5 | Present invention |
| | 100/34.2 | 100/34.2 | 10/8 | | | | | |
| 25 | Gelatin/Latex = | Gelatin/Latex = | PVA/Latex = | P-1 | P-2 | 35 | 4 | Present invention |
| | 100/34.2 | 100/34.2 | 10/8 | | | | | |
| 26 | Gelatin/Latex = | Gelatin/Latex = | PVA/Latex = | P-1 | P-5 | 35 | 3 | Present invention |
| | 100/34.2 | 100/34.2 | 10/8 | | | | | |
| 27 | Gelatin/Latex = | Gelatin/Latex = | PVA/Latex = | P-1 | P-11 | 33 | 5 | Present invention |
| | 100/34.2 | 100/34.2 | 10/8 | | | | | |
| 28 | Gelatin/Latex = | Gelatin/Latex = | PVA/Latex = | P-1 | P-25 | 32 | 3 | Present invention |
| | 100/34.2 | 100/34.2 | 10/8 | | | | | |

It was found that the coating surface states of the photothermographic materials are improved without degradation of the dark heat image storability when the intermediate layer C is provided between the intermediate layers A and B.

### Example 3

(Preparation of Organic Silver Salt Dispersions B and C)

Organic silver salt dispersions B and C having different silver behenate contents were prepared in the same manner as the organic silver salt dispersion A used in Example 1 except for changing the ratio between the recrystallized behenic acid A and the recrystallized stearic acid. The organic silver salt dispersion B had a silver behenate content of 92 mol %, and the organic silver salt dispersion C had a silver behenate content of 96 mol %.

<<Preparation of Reducing Agent 2 Dispersion>>

10 kg of water was mixed sufficiently with 10 kg of the following reducing agent 2 and 16 kg of a 10% by mass aqueous solution of a modified polyvinyl alcohol POVAL MP203 available from Kuraray Co., Ltd., and well mixed to prepare a slurry. The slurry was transported by a diaphragm pump to a horizontal-type sand mill UVM-2 manufactured by Imex Co., which was packed with zirconia beads having an average diameter of 0.5 mm, and dispersed therein for 3.5 hours. Then, 0.2 g of benzoisothiazolinone sodium salt and water were added to the dispersed slurry such that the content of the reducing agent was 25% by mass, and the liquid was maintained at 40° C. for 1 hour and at 60° C. for 15 hours, to obtain a reducing agent 2 dispersion. The reducing agent 2 dispersion included reducing agent particles having a median size of 0.49 μm and a maximum particle size of 1.4 μm or smaller. The reducing agent 2 dispersion was filtrated by a polypropylene filter having a pore diameter of 1.0 μm to remove extraneous substances such as dust, and then stored. 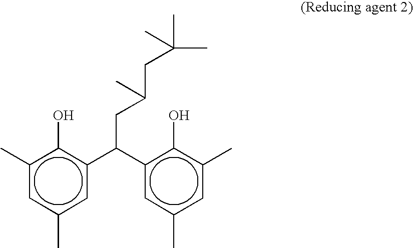
<Preparation of Hydrogen-Bonding Compound 2 Dispersion>>

A hydrogen-bonding compound 2 dispersion was prepared in the same manner as the preparation of the hydrogen-bonding compound 1 dispersion in Example 1 except for using the compound D-1 instead of the hydrogen-bonding compound 1.

<<Preparation of Image-Forming Layer Coating Liquids 31 to 38>>

Image-forming layer coating liquids 31 to 38 were prepared in the same manner as the preparation of the image-forming layer coating liquid 1 in Example 1 except for using the organic silver salt dispersion, the reducing agent, the organic polyhalogen compound, the hydrogen-bonding compound, the color tone controlling agent, and the development accelerator, shown in Table 4, in each image-forming layer coating liquid.

In each image-forming layer coating liquid: the silver amount of the organic silver salt dispersion was equimolar with the silver amount of the organic silver salt in the image-forming layer coating liquid 1; the amount of the reducing agent was equimolar with the amount of the reducing agent in the image-forming layer coating liquid 1; the amount of the organic polyhalogen compound(s) was equimolar with the total amount of the organic polyhalogen compounds 1 and 2 in the image-forming layer coating liquid 1; and the amount of the development accelerator(s) was equimolar with the total amount of the development accelerators 1 and 2 in the image-forming layer coating liquid 1.

(Production of Photothermographic Materials 201 to 208)

Photothermographic materials 201 to 208 were produced in the same manner as the photothermographic material 21 of Example 2 except for using the image-forming layer coating liquids 31 to 38 for making respective materials instead of using the image-forming layer coating liquid 4. The amounts (g/m²) of the applied components of the image-forming layer were the same as those of the photothermographic material 21.

The photothermographic materials 201 to 208 were exposed, developed, and evaluated in the same manner as Example 1, respectively. The results are shown in Table 4.

TABLE 4

| | Image-forming layer | | | | | | | | |
|---|---|---|---|---|---|---|---|---|---|
| | | Organic silver salt | | | | | | | |
| | | dispersion | | Hydrogen- | | | | | |
| | | (Type/Silver | Reducing | bonding | | | | Dark heat | |
| Photo-thermo- | | behenate content, | agent | compound | Poly-halogen | Development | | image | |
| graphic material | Binder | mol %) | (Type) | (Type) | compound | accelerator | Toning agent | storability | Note |
| 21 | P-1 | A/82 | 1 | 1 | 1 + 2 | 1 + 2 | 6-Isopropyl- | 32 | Present |
| | | | | | | | phthalazine | | invention |
| 201 | P-1 | B/92 | 1 | 1 | 1 + 2 | 1 + 2 | 6-Isopropyl- | 29 | Present |
| | | | | | | | phthalazine | | invention |
| 202 | P-1 | C/96 | 1 | 1 | 1 + 2 | 1 + 2 | 6-Isopropyl- | 25 | Present |
| | | | | | | | phthalazine | | invention |
| 203 | P-1 | C/96 | 2 | 1 | 1 + 2 | 1 + 2 | 6-Isopropyl- | 30 | Present |
| | | | | | | | phthalazine | | invention |
| 204 | P-1 | C/96 | 1 | 2 | 1 + 2 | 1 + 2 | 6-Isopropyl- | 28 | Present |
| | | | | | | | phthalazine | | invention |
| 205 | P-1 | C/96 | 1 | 1 | 2 | 1 + 2 | 6-Isopropyl- | 26 | Present |
| | | | | | | | phthalazine | | invention |
| 206 | P-1 | C/96 | 1 | 1 | 1 + 2 | 2 | 6-lsopropyl- | 25 | Present |
| | | | | | | | phthalazine | | invention |
| 207 | P-1 | C/96 | 1 | 1 | 1 + 2 | 1 + 2 | Phthalazine | 35 | Present |
| | | | | | | | | | invention |
| 208 | P-1 | C/96 | 1 | 1 | 1 + 2 | 2 | 6-Isopropyl- | 22 | Present |
| | | | | | | | phthalazine | | invention |

As shown in Table 4, photothermographic materials having the following structure were excellent in dark heat image storability: the photothermographic materials each comprise the organis silver salt of the invention and the reducing agent of the invention; the photothermographc materials each comprise the non-photosensitive intermediate layer A adjacent to the image forming layer; the proportion of the hydrophobic polymer to the entire binder in the non-photosensitive intermediate layer A was 50% by mass or higher; and the image-forming layer comprises a polymer latex prepared by copolymerization of monomers including the monomer represented by the formula (M-1).

### Example 4

Photothermographic materials 301 to 304 were produced in the same manner as the photothermographic material 202 of Example 3 according to the invention, except that the crosslinking agent shown in Table 5 was further added to the intermediate layer A coating liquid in an amount of 20% by mass based on the amount of the binder in the coating liquid in the preparation of each photothermographic material. The photothermographic materials 301 to 304 were evaluated in the same manner as Example 1. The results are shown in Table 5.

TABLE 5

| Photo- | Intermediate | | | | |
|---|---|---|---|---|---|
| thermographic | layer A | Image-forming layer | | Dark heat image | |
| material | Binder | Crosslinking agent | Binder | storability | Note |
| 202 | SBR | None | P-1 | 25 | Present |
| | | | | | invention |
| 301 | SBR | DIC FINE EM-60 | P-1 | 22 | Present |
| | | (Dainippon Ink and | | | invention |
| | | Chemicals, Inc.) | | | |
| 302 | SBR | DURANATE WB40-100 | P-1 | 23 | Present |
| | | (Asahi Kasei Corporation) | | | invention |
| 303 | SBR | CARBODILITE E-01 | P-1 | 22 | Present |
| | | (Nisshinbo Industries, Inc.) | | | invention |
| 304 | SBR | EPOCROS K-2020E | P-1 | 23 | Present |
| | | (Nippon Shokubai Co., | | | invention |
| | | Ltd.) | | | |

By adding the crosslinking agent, the dark heat image storability was further improved.

As described in detail above, according to the present invention, there is provided a photothermographic material excellent in dark heat image storability.

1. A photothermographic material comprising a support, an image-forming layer, a non-photosensitive intermediate layer A, and an outermost layer,
wherein the image forming layer, the non-photosensitive intermediate layer A, and the outermost layer are disposed on the support in this order;
the image-forming layer comprises a photosensitive silver halide, a non-photosensitive organic silver salt, a reducing agent, a polyhalogen compound, and a first binder;
the non-photosensitive intermediate layer A comprises a second binder in which a hydrophobic polymer constitutes 50% by mass or more of the second binder; and
the first binder in the image-forming layer comprises a copolymer including a monomer represented by formula (M-1) as a copolymerization component:
CH₂═CR⁰¹—CR⁰²═CH₂ Formula (M-1)
wherein in formula (M-1), R⁰¹ represents a hydrogen atom, an alkyl group having 1 to 6 carbon atoms, a halogen atom, or a cyano group; and R⁰² represents an alkyl group having 1 to 6 carbon atoms, a halogen atom, or a cyano group.

2. The photothermographic material according to claim 1, wherein the non-photosensitive intermediate layer A is adjacent to the image-forming layer.

3. The photothermographic material according to claim 1, wherein the photothermographic material further comprises a non-photosensitive intermediate layer B between the non-photosensitive intermediate layer A and the outermost layer, and at least one of the outermost layer and the non-photosensitive intermediate layer B comprises a binder in which a hydrophilic polymer derived from an animal protein consitutes 50% by mass or more of the binder.

4. The photothermographic material according to claim 1, wherein the monomer represented by formula (M-1) constitutes 10 to 70% by mass of the copolymer, and a proportion of the copolymer including a monomer represented by formula (M-1) as a copolymerization component to the entire binder in the image-forming layer is 50% by mass or higher.

5. The photothermographic material according to claim 1, wherein the binder in the non-photosensitive intermediate layer A comprises a copolymer in which a monomer represented by formula (M) constitutes 10% by mass to 70% by mass of the copolymer:
CH₂═CR⁰¹—CR⁰²═CH₂ Formula (M)
wherein in formula (M), R⁰¹ and R⁰² each independently represent a hydrogen atom, an alkyl group having 1 to 6 carbon atoms, a halogen atom, or a cyano group.

6. The photothermographic material according to claim 3, wherein the non-photosensitive intermediate layer B comprises a third binder in which a hydrophilic polymer derived from an animal protein consitutes 50% by mass or more of the third binder, and the outermost layer comprises a fourth binder including a hydrophobic polymer.

7. The photothermographic material according to claim 1, wherein the photothermographic material further comprises two or more non-photosensitive intermediate layers B between the non-photosensitive intermediate layer A and the outermost layer; the non-photosensitive intermediate layers B include a first layer and a second layer; the first layer is nearer to the non-photosensitive intermediate layer A than the second layer is; the first layer includes a third binder in which a hydrophilic polymer that is not derived from an animal protein constitutes 50% by mass or more of the third binder, and the second layer includes a fourth binder in which a hydrophilic polymer derived from an animal protein constitutes 50% by mass or more of the fourth binder.

8. The photothermographic material according to claim 7, wherein the outermost layer comprises a binder including a hydrophilic polymer derived from an animal protein.

9. The photothermographic material according to claim 7, wherein the outermost layer comprises a binder including a hydrophobic polymer.

10. The photothermographic material according to claim 7, wherein the outermost layer comprises a binder including a hydrophilic polymer derived from an animal protein and a hydrophobic polymer.

11. The photothermographic material according to claim 1, wherein the reducing agent is a compound represented by formula (R1): 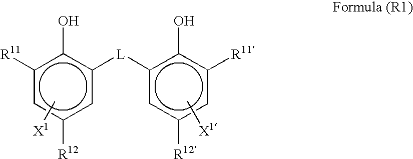
wherein in formula (R1), R¹¹ and R^{11′} each independently represent a secondary or tertiary alkyl group having 1 to 15 carbon atoms; R¹² and R^{12′} each independently represent a hydrogen atom or a substituent which can be bonded to the benzene ring; L represents an —S— group or a —CHR¹³— group; R¹³ represents a hydrogen atom or an alkyl group having 1 to 20 carbon atoms; and X¹ and X^{1′} each independently represent a hydrogen atom or a substituent which can be bonded to the benzene ring.

12. The photothermographic material according to claim 1, wherein the image-forming layer further comprises a development accelerator.

13. The photothermographic material according to claim 1, wherein the image-forming layer further comprises a compound represented by formula (D): 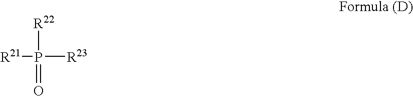
wherein in formula (D), R²¹ to R²³ each independently represent an alkyl group, an aryl group, an alkoxy group, an aryloxy group, an amino group, or a heterocyclic group.

14. The photothermographic material according to claim 1, wherein the image-forming layer further comprises a compound represented by formula (H):
Q-(Y)ₙ—C(Z1)(Z2)X Formula (H)
wherein in formula (H), Q represents an alkyl group, an aryl group, or a heterocyclic group; Y represents a divalent linking group; n represents 0 or 1; Z1 and Z2 each independently represent a halogen atom; and X represents a hydrogen atom or an electron-withdrawing group.

15. The photothermographic material according to claim 14, wherein the image-forming layer comprises two or more types of the compounds represented by formula (H).

16. The photothermographic material according to claim 1, wherein the image-forming layer further comprises a compound represented by formula (I): 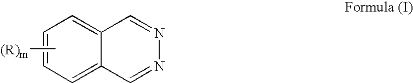
wherein in formula (I), R represents a substituent; and m represents an integer of 1 to 6.

17. The photothermographic material according to claim 16, wherein the image-forming layer further comprises a color tone controlling agent.

18. The photothermographic material according to claim 1, wherein the non-photosensitive organic silver salt has a silver behenate content of 90 mol % or higher.

19. The photothermographic material according to claim 1, wherein the photothermographic material has an applied silver content of 1.3 g/m² or less.

20. The photothermographic material according to claim 1, wherein at least one layer disposed on the image-forming layer side of the support comprises a crosslinking agent.

21. A method for forming an image on a photothermographic material comprising:
imagewise exposing a photothermographic of claim 1; and
heat-developing the exposed photothermographic material with a heating time of 16 seconds or less.

22. A method for forming an image on a photothermographic material comprising:
imagewise exposing a photothermographic of claim 1; and
heat-developing the exposed photothermographic material while conveying the photothermographic material at 23 mm/sec or faster.

23. The method for forming an image according to claim 21, wherein the photothermographic material is conveyed at 23 mm/sec or faster in the heat development.
